(19) United States
(12) Patent Application Publication
(10) Pub. No.: US 2022/0311081 A1
(43) Pub. Date: Sep. 29, 2022

(54) BATTERY PACK AND RELATED COMPONENTS AND METHODS

(71) Applicant: Sion Power Corporation, Tucson, AZ (US)

(72) Inventors: Mark Niedzwiecki, Tucson, AZ (US); Jared M. Jennings, Tucson, AZ (US); Ryan Michael Niccum, Tucson, AZ (US); David Warren Ribblett, Vail, AZ (US)

(73) Assignee: Sion Power Corporation, Tucson, AZ (US)

(21) Appl. No.: 17/702,971

(22) Filed: Mar. 24, 2022

Related U.S. Application Data
(60) Provisional application No. 63/223,663, filed on Jul. 20, 2021.
(60) Provisional application No. 63/166,549, filed on Mar. 26, 2021.

(51) Int. Cl. H01M 50/242; H01M 50/293; H01M 10/653; H01M 50/543; H01M 4/38; H01M 50/249; H01M 4/40

(52) U.S. Cl. CPC H01M 50/242; H01M 50/293; H01M 10/653; H01M 50/543; H01M 4/382; H01M 50/249; H01M 4/405; H01M 2220/20

(57) ABSTRACT

Battery packs including electrochemical cells, associated components, and arrangements thereof are generally described. In some aspects, battery packs with housings that undergo relatively little expansion and contraction even in cases where electrochemical cells in the battery pack undergo a relatively high degree of expansion and contraction during charging and discharging are provided. Battery packs configured to apply relatively high magnitudes and uniform force to electrochemical cells in the battery pack, while in some cases having high energy densities and a relatively low pack burden, are also provided. In certain aspects, arrangements of electrochemical cells and associated components are generally described. In some aspects, thermally conductive solid articles that can be used for aligning components of the battery pack are described. In some aspects, thermally insulating and compressible components for battery packs are generally described. In some instances, the battery pack includes multiple battery modules at least partially enclosed by a same housing.

### RELATED APPLICATIONS

This application claims priority under 35 U.S.C. § 119(e) to U.S. Provisional Patent Application No. 63/223,663, filed Jul. 20, 2021, and entitled, “Battery Pack and Related Components and Methods,” and to U.S. Provisional Patent Application No. 63/166,549, filed Mar. 26, 2021, and entitled, “Battery Pack and Related Components and Methods,” each of which is incorporated herein by reference in its entirety for all purposes.

### TECHNICAL FIELD

Battery packs including electrochemical cells, associated components, and arrangements thereof are generally described.

### BACKGROUND

Batteries typically include cells that undergo electrochemical reactions to produce electric current. Heat may be produced during cycling of the cell, which may affect the performance of the battery. Applying a force to at least a portion of an electrochemical cell (e.g., during cycling of the cell) can improve the performance of the electrochemical cell. Certain embodiments of the present disclosure are directed to inventive articles, systems, and methods relating to the handling of compressive force and heat transfer in batteries.

### SUMMARY

Battery packs including electrochemical cells, associated components, and arrangements thereof are generally described. In some aspects, battery packs with housings that undergo relatively little expansion and contraction even in cases where electrochemical cells in the battery pack undergo a relatively high degree of expansion and contraction during charging and discharging are provided. Battery packs configured to apply relatively high magnitudes and uniform force to electrochemical cells in the battery pack, while in some cases having high energy densities and a relatively low pack burden, are also provided. In certain aspects, arrangements of electrochemical cells and associated components are generally described. In some aspects, thermally conductive solid articles that can be used for aligning components of the battery pack are described. In some aspects, thermally insulating and compressible components for battery packs are generally described. In some instances, the battery pack includes multiple battery modules at least partially enclosed by the same housing. The subject matter of the present invention involves, in some cases, interrelated products, alternative solutions to a particular problem, and/or a plurality of different uses of one or more systems and/or articles.

In one aspect, battery packs are provided. In some embodiments, a battery pack comprises a first battery comprising a first electrochemical cell and a first pair of terminals electronically coupled to the first electrochemical cell; a second battery comprising a second electrochemical cell and a second pair of terminals electronically coupled to the second electrochemical cell; and a housing at least partially enclosing the first battery and the second battery; wherein the housing is configured to apply, during at least one period of time during charge and/or discharge of the first electrochemical cell and/or the second electrochemical cell, an anisotropic force with a component normal to a first electrode surface of the first electrochemical cell and/or a second electrode surface of the second electrochemical cell defining a pressure of at least 3 kgf/cm². In some embodiments, the first electrode surface of the first electrochemical cell is a first electrode active surface and/or the second electrode surface of the second electrochemical cell is a second electrode active surface.

In some embodiments, a battery pack comprises a stack comprising a first electrochemical cell and a second electrochemical cell; and a housing at least partially enclosing the stack, the housing comprising a solid plate covering at least a portion of an end of the stack; wherein: the housing is configured to apply, via the solid plate and tension in a solid housing component coupled to the solid plate, during at least one period of time during charge and/or discharge of the first electrochemical cell and/or the second electrochemical cell, an anisotropic force with a component normal to a first electrode surface of the first electrochemical cell and/or a second electrode surface of the second electrochemical cell defining a pressure of at least 3 kg_{f}/cm², and the solid housing component is coupled to the solid plate at least partially via coupling of an insert to a housing stop portion adjacent to an exterior surface of the solid plate, the insert comprising: a body that passes through the solid housing component and enters a complementary recess of the housing stop portion adjacent to a first side of the solid housing component, and a head adjacent to a second side of the solid housing component opposite the first side. In some embodiments, the first electrode surface of the first electrochemical cell is a first electrode active surface and/or the second electrode surface of the second electrochemical cell is a second electrode active surface.

In some embodiments, a battery pack comprises a stack of electrochemical cells comprising a first electrochemical cell and a second electrochemical cell; a first battery comprising a first battery module comprising: a first subset of the electrochemical cells, the first subset including the first electrochemical cell, and a first pair of terminals electronically coupled to the first electrochemical cell; a second battery comprising a second battery module comprising: a second, different, subset of the electrochemical cells, the second subset including the second electrochemical cell, and a second pair of terminals electronically coupled to the second electrochemical cell; a housing at least partially enclosing the stack, the housing comprising a solid plate comprising carbon fiber covering at least a portion of an end of the stack; a substrate to which a tab of the first electrochemical cell and/or the second electrochemical cell can be connected; and an electrically conductive interconnect on the substrate connected to at least one tab of the first electrochemical cell and/or the second electrochemical cell; wherein: the first battery and the second battery can be charged and/or discharged independently; the first battery is configured to be part of a circuit having a first voltage, and the second battery is configured to be part of a circuit having a second, different voltage; the housing is configured to apply, via the solid plate and tension in a solid housing component coupled to the solid plate, during at least one period of time during charge and/or discharge of the first electrochemical cell and/or the second electrochemical cell, an anisotropic force with a component normal to a first electrode surface of the first electrochemical cell and/or a second electrode surface of the second electrochemical cell defining a pressure of at least 3 kg_{f}/cm²; the solid housing component comprises carbon fiber and is coupled to the solid plate at least partially via coupling of an insert to a housing stop portion adjacent to an exterior surface of the solid plate, the insert comprising: a body that passes through the solid housing component and enters a complementary recess of the housing stop portion adjacent to a first side of the solid housing component, and a head adjacent to a second side of the solid housing component opposite the first side; and at least one electrochemical cell of the battery pack comprises lithium metal and/or a lithium alloy as an electrode active material during at least a portion of a charging and/or discharging process of the at least one electrochemical cell. In some embodiments, the first electrode surface of the first electrochemical cell is a first electrode active surface and/or the second electrode surface of the second electrochemical cell is a second electrode active surface. In some embodiments, the electronically conductive interconnect comprises: a first material portion connected to a first tab of the first electrochemical cell, and a second material portion connected to a second tab of the second electrochemical cell. In some embodiments, the first material portion and the second material portion are made of different metals and/or metal alloys.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B show cross-sectional schematic diagrams of exemplary battery packs comprising electrochemical cells and an optional housing, according to some embodiments;

FIG. 2 shows a cross-sectional schematic diagram of an exemplary electrochemical cell, according to some embodiments;

FIG. 3A shows a cross-sectional schematic diagram of an exemplary battery pack comprising electrochemical cells and solid plates, according to some embodiments;

FIGS. 3B-3D show exploded view schematic diagrams of solid plates comprising layers of carbon fiber, according to some embodiments;

FIG. 3E shows an angle between the orientation of carbon fibers within layers of carbon fiber, according to some embodiments;

FIG. 3F shows an exploded view schematic diagram of a solid plate comprising layers of carbon fiber, according to some embodiments;

FIG. 3G shows angles between the orientation of carbon fibers within layers of carbon fiber, according to some embodiments;

FIG. 3H shows a perspective view schematic illustration of a solid plate, according to some embodiments;

FIG. 4A shows a cross-sectional schematic diagram of an exemplary battery pack comprising a stack comprising electrochemical cells, and a housing that comprises a solid plate and a solid housing component, according to some embodiments;

FIG. 4B shows a perspective view schematic illustration of a solid housing component as part of a solid frame, according to some embodiments;

FIG. 4C shows a perspective view schematic illustration of a solid housing component as part of a solid frame comprising fastener sites, according to some embodiments;

FIG. 5A shows an exploded perspective view schematic diagram of an exemplary battery pack comprising a stack comprising electrochemical cells, and a housing that comprises a solid plate and a solid housing component, according to some embodiments;

FIG. 5B shows a perspective view schematic diagram of an exemplary battery pack comprising a stack comprising electrochemical cells, and a housing that comprises a solid plate and a solid housing component, according to some embodiments;

FIG. 5C shows a perspective view schematic diagram of an exemplary battery pack comprising a stack comprising electrochemical cells, and a housing that comprises a solid plate, a solid housing component, and an electronics component, according to some embodiments;

FIG. 6A shows a side-view schematic diagram of an exemplary battery pack comprising a stack comprising electrochemical cells, and a housing that comprises a solid plate comprising a recess and a solid housing component comprising a projection, according to some embodiments;

FIG. 6B shows an exploded perspective view schematic diagram of an exemplary battery pack comprising a stack comprising electrochemical cells, and a housing that comprises a solid plate comprising a recess and a solid housing component comprising a projection, according to some embodiments;

FIG. 6C shows a perspective view schematic diagram of an exemplary battery pack comprising a stack comprising electrochemical cells, and a housing that comprises a solid plate comprising a recess and a solid housing component comprising a projection, according to some embodiments;

FIG. 7A shows perspective view schematic illustrations of stop portions, according to some embodiments;

FIG. 7B shows perspective view schematic illustrations of inserts, according to some embodiments;

FIG. 7C shows a cross-sectional schematic diagram of an exemplary battery pack comprising a stack comprising electrochemical cells, and a housing that comprises a solid plate, a solid housing component, and a housing stop portion, according to some embodiments;

FIG. 7D shows an exploded perspective view schematic diagram of an exemplary battery pack comprising a stack comprising electrochemical cells, and a housing that comprises a solid plate, a solid housing component, and a housing stop portion, according to some embodiments;

FIG. 7E shows a perspective view schematic diagram of an exemplary battery pack comprising a stack comprising electrochemical cells, and a housing that comprises a solid plate, a solid housing component, and a housing stop portion, according to some embodiments;

FIG. 7F shows an exploded perspective view schematic diagram of an exemplary battery pack comprising a stack comprising electrochemical cells, and a housing that comprises a solid plate, a solid housing component, and a housing stop portion, according to some embodiments;

FIG. 7G shows a perspective view schematic diagram of an exemplary battery pack comprising a stack comprising electrochemical cells, and a housing that comprises a solid plate, a solid housing component, and a housing stop portion, according to some embodiments;

FIG. 7H show perspective view schematic illustrations of an insert and a fastener, according to some embodiments;

FIG. 7I shows perspective view schematic illustrations of housing stop portions with rounded edges, according to some embodiments;

FIG. 7J shows a perspective view schematic illustration of a housing stop portion adjacent to multiple surfaces of a solid plate, according to some embodiments;

FIG. 8A shows a side-view schematic diagram of an exemplary battery pack comprising a stack comprising electrochemical cells, and a housing that comprises a solid plate and a solid housing component comprising a lateral portion, according to some embodiments;

FIG. 8B shows an exploded perspective view schematic diagram of an exemplary battery pack comprising a stack comprising electrochemical cells, and a housing that comprises a solid plate and a solid housing component comprising a lateral portion, according to some embodiments;

FIG. 8C shows a perspective view schematic diagram of an exemplary battery pack comprising a stack comprising electrochemical cells, and a housing that comprises a solid plate and a solid housing component comprising a lateral portion, according to some embodiments;

FIGS. 9A-9C show cross-sectional schematic diagrams of exemplary battery packs comprising multiple batteries or battery modules, according to some embodiments;

FIGS. 10A-10B show cross-sectional schematic diagrams of exemplary stacks comprising electrochemical cells, thermally conductive solid article portions, and a thermally insulating compressible solid article portion, according to some embodiments;

FIG. 10C shows a cross-sectional schematic diagram of an exemplary stack comprising electrochemical cells, thermally conductive solid article portions, and thermally insulating compressible solid article portions, according to some embodiments;

FIGS. 11A-11B show cross-sectional schematic diagrams of exemplary stacks comprising electrochemical cells, a thermally conductive solid article portion, and a thermally insulating compressible solid article portion, according to some embodiments;

FIGS. 12A-12B show cross-sectional schematic diagrams of exemplary stacks comprising electrochemical cells, thermally conductive solid article portions, a thermally insulating compressible solid article portion, and a solid plate in the absence and presence of an anisotropic force, respectively, according to some embodiments;

FIG. 13 shows a cross-sectional schematic diagram of an exemplary stack comprising an electrochemical cell, thermally conductive solid article portion, and a thermally insulating compressible solid article portion, according to some embodiments;

FIG. 14 shows a cross-sectional schematic diagram of an exemplary battery pack comprising electrochemical cells and thermally conductive solid article portions comprising alignment features, according to some embodiments;

FIG. 15 shows a cross-sectional schematic diagram of an exemplary electrochemical cell, according to some embodiments;

FIG. 16 shows a perspective view schematic diagram of an exemplary thermally conductive solid article portion comprising an alignment feature and a non-planarity, according to some embodiments;

FIG. 17 shows a cross-sectional schematic diagram of an exemplary battery pack comprising electrochemical cells and thermally conductive solid article portions comprising alignment features, according to some embodiments;

FIG. 18 shows a cross-sectional schematic diagram of an exemplary battery pack comprising electrochemical cells, thermally conductive solid article portions comprising alignment features, and a thermally insulating compressible solid article portion, according to some embodiments;

FIG. 19 shows a cross-sectional schematic diagram of an exemplary battery pack comprising electrochemical cells and a thermally insulating compressible solid article portion, according to some embodiments;

FIGS. 20A-20B show cross-sectional schematic diagrams of exemplary battery packs comprising electrochemical cells and a thermally insulating compressible solid article portion, according to some embodiments;

FIGS. 21A-21B show cross-sectional schematic diagrams of an exemplary battery pack comprising electrochemical cells and a thermally insulating compressible solid article portion in the absence and presence of an anisotropic force, respectively, according to some embodiments;

FIG. 22 shows a plot of a region of compressive stress versus percent compression responses for a thermally insulating compressible solid article portion, according to some embodiments;

FIG. 23 shows a cross-sectional schematic diagram of an exemplary battery pack comprising electrochemical cells and thermally insulating compressible solid article portions, according to some embodiments;

FIG. 24A is a block diagram illustrating a representative battery pack, according to some embodiments.

FIG. 24B is a wiring diagram illustrating a representative battery management system, according to some embodiments;

FIG. 25A is a top view of a representative substrate and battery, according to some embodiments;

FIG. 25B is a side view of a representative substrate and battery, according to some embodiments;

FIG. 25C is a perspective view of a representative substrate and battery, according to some embodiments;

FIG. 25D is a top view of a representative battery pack, according to some embodiments;

FIG. 26A is a perspective view schematic illustration of a substrate for a battery pack, according to some embodiments;

FIG. 26B is a top view schematic diagram of a substrate and an electronically conductive interconnect comprising a first material portion and a second material portion, according to some embodiments;

FIGS. 26C-26D are perspective view (FIG. 26C) and top view (FIG. 26D) schematic illustrations of a substrate and an electronically conductive interconnect connected to tabs of electrochemical cells, according to some embodiments;

FIG. 26E is a perspective view schematic illustration of a substrate for a battery pack, according to some embodiments;

FIGS. 26F-26G are perspective view (FIG. 26F) and top view (FIG. 26G) schematic illustrations of a substrate and an electronically conductive interconnect connected to tabs of electrochemical cells, according to some embodiments;

FIG. 27A is a block diagram illustrating a representative electrochemical cell management system, according to some embodiments;

FIG. 27B is a block diagram illustrating a representative battery management system, according to some embodiments;

FIGS. 28A-28B show perspective view schematic illustrations of a battery pack comprising a housing comprising a frame, a solid plate, stop portions, and inserts, as well as a substrate, electronically conductive interconnects, electrochemical cells, thermally conductive solid article portions, thermally insulating compressible solid article portions, and terminals, shown with a cover (FIG. 28A) and without a cover (FIG. 28B);

FIG. 28C shows an exploded schematic illustration of the components of the battery pack of FIG. 28A, according to some embodiments;

FIG. 28D shows a perspective view schematic illustration of a cover for a battery pack, according to some embodiments;

FIG. 28E shows a perspective view schematic illustration of an electrochemical cell for a battery pack, according to some embodiments;

FIG. 28F shows a perspective view schematic illustration of thermally conductive solid article portion for a battery pack, according to some embodiments;

FIG. 28G shows a perspective view schematic illustration of thermally insulating compressible solid article portion for a battery pack, according to some embodiments;

FIGS. 29A-29B show perspective view schematic illustrations of a battery pack comprising a housing comprising a frame, a solid plate, stop portions, and inserts, as well as a substrate, electronically conductive interconnects, electrochemical cells, thermally conductive solid article portions, thermally insulating compressible solid article portions, and terminals, shown with a cover (FIG. 29A) and without a cover (FIG. 29B);

FIG. 29C shows an exploded schematic illustration of the components of the battery pack of FIG. 29A, according to some embodiments;

FIG. 29D shows a perspective view schematic illustration of a cover for a battery pack, according to some embodiments; and

FIG. 30 shows a cross sectional schematic diagram of an exemplary electric vehicle comprising a battery, according to some embodiments.

### DETAILED DESCRIPTION

Battery packs including electrochemical cells, associated components, and arrangements thereof are generally described. In some aspects, battery packs with housings that undergo relatively little expansion and contraction even in cases where electrochemical cells in the battery pack undergo a relatively high degree of expansion and contraction during charging and discharging are provided. Battery packs configured to apply relatively high magnitudes and uniform force to electrochemical cells in the battery pack, while in some cases having high energy densities and a relatively low pack burden, are also provided. In certain aspects, arrangements of electrochemical cells and associated components are generally described. In some aspects, thermally conductive solid articles that can be used for aligning components of the battery pack are described. In some aspects, thermally insulating and compressible components for battery packs are generally described. In some instances, the battery pack includes multiple battery modules at least partially enclosed by the same housing. The present disclosure describes multiple inventive aspects relating to battery pack components and arrangements thereof, application of force to multiple electrochemical cells in battery packs, and thermal management. These inventive aspects can, alone or in combination, lead to the manufacture of battery packs with unexpected properties such as unexpectedly high energy densities and durability.

In some cases, it may be beneficial to apply force to electrochemical cells in a battery pack. For example, in some cases applying an anisotropic force with a component normal to at least one electrode surface of the electrochemical cells can improve performance during charging and/or discharging by reducing problems such as dendrite formation and surface roughening of the electrode while improving current density. One such example is the case where at least one of the electrochemical cells of the battery pack comprises lithium metal or a lithium metal alloy as an electrode active material. Lithium metal may undergo dendrite growth, for example, which can in certain cases lead to failure of the electrochemical cell and safety hazards. Application of relatively high magnitudes of anisotropic force to electrodes comprising lithium metal may mitigate lithium dendrite formation and other deleterious phenomena. However, it has been realized in the context of the present disclosure that numerous challenges may emerge when applying force within battery packs comprising multiple electrochemical cells (e.g., comprising lithium and/or lithium alloy as an electrode active material). For example, application of a relatively uniform force such that each of the electrochemical cells experiences a relatively similar pressure distribution can be important for performance and durability, and managing pressure on multiple cells must be accomplished simultaneously. Further, certain types of electrochemical cells may undergo relatively large dimensional changes during cycling. As one example, an electrode comprising lithium and/or lithium metal alloy may expand significantly due to lithium deposition during charging and contract significantly upon lithium ion release during discharging. Such dimensional changes of the electrochemical cells may lead to uneven pressure distributions and problematic battery pack dimensional changes.

The present disclosure provides methods, articles, and devices that can, in some cases, be used to mitigate such dimensional changes of the overall battery pack (e.g., the housing) even in situations where electrochemical cells may expand and contract. For example, relatively high magnitudes of force (e.g., defining a pressure of greater than or equal to 3 kg_{f}/cm² and up to 25 kg_{f}/cm²) may be applied. For example, it has been realized that relatively high magnitudes of force may be applied relatively uniformly using certain housing components (e.g., solid plates) having relatively high stiffness while being lightweight (e.g., certain types of carbon fiber having certain weaves, fiber orientation, and/or thicknesses). Further, certain articles in the battery pack may compensate for dimensional changes of the electrochemical cells (e.g., thermally insulating compressible solid article portions such as microcellular elastomeric foams). It has been discovered that certain types of components can have suitable mechanical properties for use in battery packs under compressive force (e.g., relatively low compression set, relatively high resilience) while being thermally insulating. Some such thermally insulating compressible solid article portions may then be capable of serving multiple roles: compensating for dimensional changes in electrochemical cells and mitigating heat transfer between electrochemical cells. It has also been discovered that aligning components (e.g., electrochemical active regions of the electrochemical cells) of the battery pack can lead to improved performance and durability (e.g., by increasing the uniformity of the pressure distribution experienced by the electrochemical active regions). Certain aspects of the present disclosure are related to thermally conductive solid article portions that can be used to align electrochemical active regions of the battery pack while also performing other functions, such as facilitating heat transfer away from the electrochemical cells (e.g., laterally). The use of articles capable of alignment and thermal transfer may reduce the number of components needed for the battery pack, which may reduce complexity, pack burden, and/or costs. Certain aspects also relate to unconventional arrangements of components that can simultaneously mitigate multiple potentially deleterious phenomena associated with battery packs comprising multiple electrochemical cells, while using relatively few components, which may allow for relatively high energy densities while also allowing for good durability. For example, certain arrangements of electrochemical cells, thermally conductive solid article portions, and thermally insulating compressible solid article portions may promote unexpectedly efficient heat transfer away from the electrochemical cells while also facilitating compensation for applied forces and cell breathing and facilitating relatively uniform pressure distributions (e.g., within ±2.5 kg_{f}/cm² or within ±2 kg_{f}/cm² across an electrochemical active region).

In one aspect, battery packs are generally described. The battery pack may include, in some embodiments, one or more rechargeable electrochemical cells. In some embodiments, the battery pack comprises one or more rechargeable lithium-ion electrochemical cells. In this disclosure, a battery pack refers to any collection of multiple electrochemical cells. In some embodiments, the multiple electrochemical cells of the battery pack are each at least partially enclosed by a housing of the battery pack, as described in more detail below. The multiple electrochemical cells of the battery pack may be electronically coupled in series and/or parallel. For example, in some embodiments, the electrochemical cells of the battery pack are electronically coupled in series and/or parallel to form a single battery having a single pair of terminals (a positive terminal and a negative terminal). In some embodiments, the battery pack comprises multiple battery modules each comprising multiple electrochemical cells. The multiple electrochemical cells within each battery module of the battery pack may be electronically coupled in series and/or parallel within that battery module. In some embodiments, the multiple electronically coupled electrochemical cells of each battery module can form an electronically independent circuit. In some embodiments, the battery pack has multiple pairs of terminals. For example, in some embodiments, each battery module of the battery pack has a pair of terminals (a positive terminal and a negative terminal) electronically coupled to the electrochemical cells of that battery module. In some embodiments, the multiple battery modules of the battery pack are at least partially enclosed by a same housing.

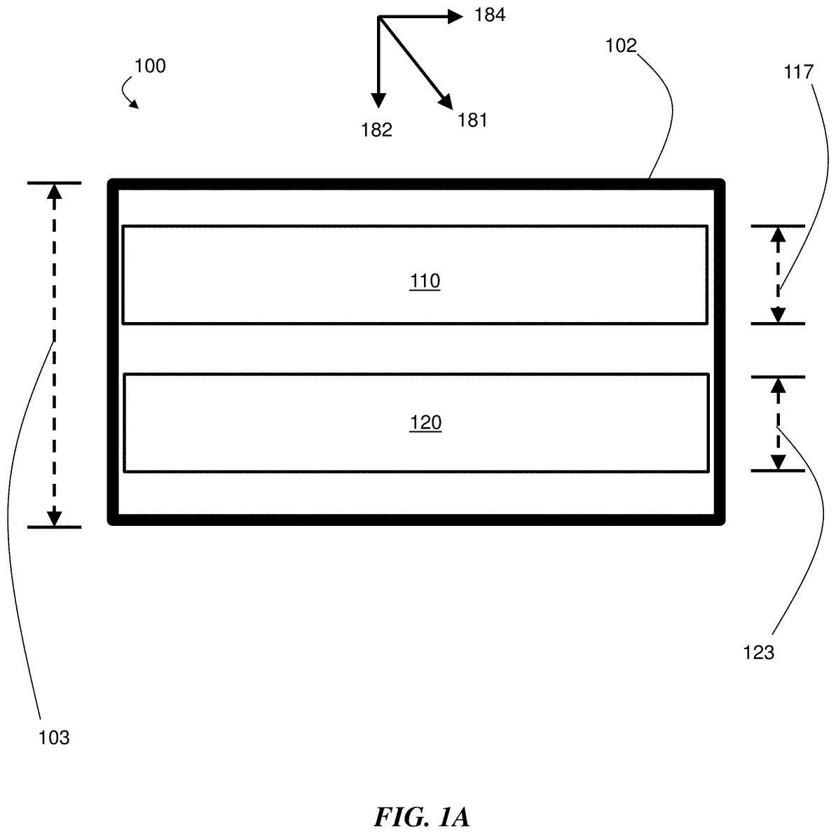

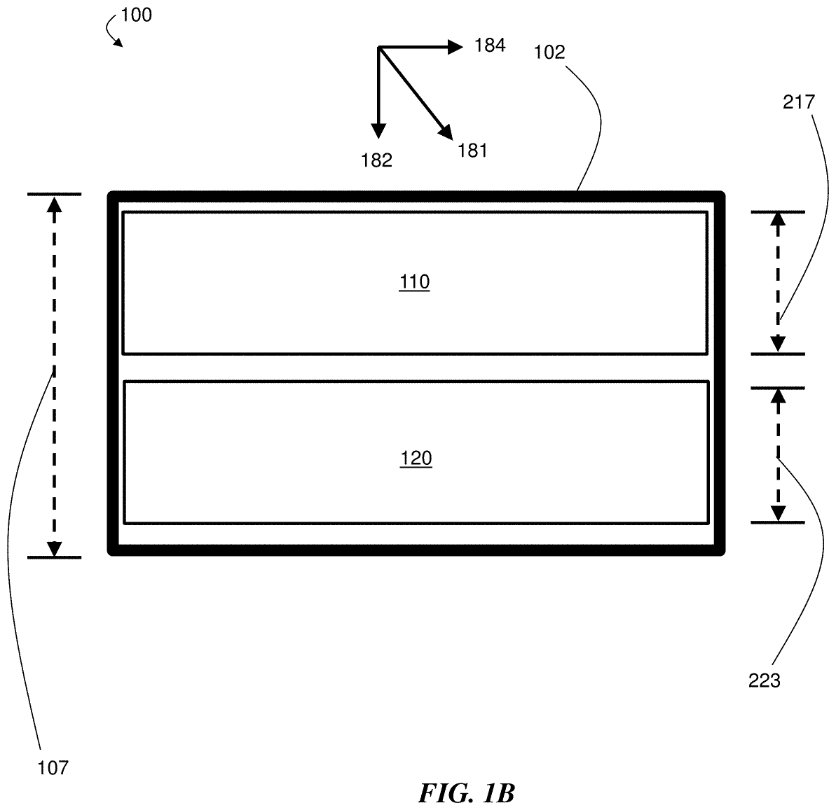

FIGS. 1A-1B are cross-sectional schematic diagrams of a non-limiting embodiment of battery pack 100. The battery pack may comprise one or more electrochemical cells as well as one or more other components (e.g., articles stacked with the electrochemical cells, housings, electrical and thermal management equipment, etc.). In some embodiments, the battery pack comprises multiple electrochemical cells, including a first electrochemical cell and a second electrochemical cell. For example, battery pack 100 in FIGS. 1A-1B comprises first electrochemical cell 110 and second electrochemical cell 120 at least partially enclosed by optional housing 102. Suitable configurations of the electrochemical cells of the battery pack include, but are not limited to, a stacked configuration, a folded configuration, or a wound configuration. In some embodiments, at least one electrochemical cell of the battery pack (e.g., first electrochemical cell, second electrochemical cell) comprises lithium and/or a lithium metal alloy as an electrode active material.

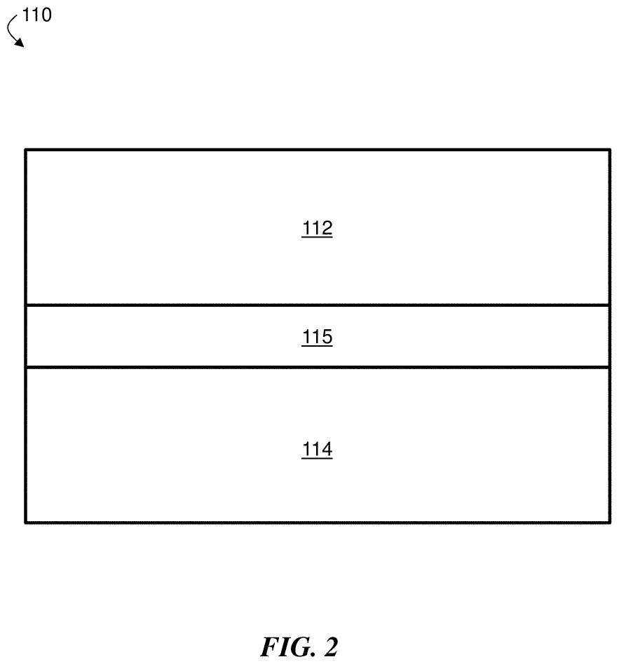

In some embodiments, electrochemical cells in the battery pack (e.g., the first electrochemical cell, the second electrochemical cell) comprise at least one anode. FIG. 2 shows a schematic diagram of one exemplary embodiment of first electrochemical cell 110 comprising anode 112. In some cases, the anode comprises an anode active material. As used herein, an “anode active material” refers to any electrochemically active species associated with an anode. In some embodiments, the anode comprises lithium metal and/or a lithium metal alloy as an anode active material. For example, referring again to FIG. 2, anode 112 comprises lithium metal and/or a lithium metal alloy as an anode active material in some embodiments. An electrode such as an anode can comprise, in accordance with certain embodiments, lithium metal and/or a lithium metal alloy as an electrode active material during at least a portion of or during all of a charging and/or discharging process of the electrochemical cell. In certain cases, the anode is or comprises vapor-deposited lithium (e.g., a vapor-deposited lithium film). Additional suitable anode active materials are described in more detail below. Certain embodiments described herein may be directed to systems, devices, and methods that may allow for improved performance (e.g., magnitude and uniformity of applied force, thermal management, alignment of electrochemical active regions to promote uniformity of lithium deposition during charging) of electrochemical devices comprising certain anodes, such as lithium metal-containing anodes.

In some embodiments, electrochemical cells in the battery pack (e.g., the first electrochemical cell, the second electrochemical cell) comprise at least one cathode. For example, referring again to FIG. 2, first electrochemical cell 110 comprises cathode 114. The cathode can comprise a cathode active material. As used herein, a “cathode active material” refers to any electrochemically active species associated with a cathode. In certain cases, the cathode active material may be or comprise a lithium intercalation compound (e.g., a metal oxide lithium intercalation compound). As one non-limiting example, in some embodiments, cathode 114 in FIG. 2 comprises a nickel-cobalt-manganese lithium intercalation compound. Suitable cathode materials are described in more detail below.

As used herein, “cathode” refers to the electrode in which an electrode active material is oxidized during charging and reduced during discharging, and “anode” refers to the electrode in which an electrode active material is reduced during charging and oxidized during discharging.

In some embodiments, electrochemical cells in the battery pack (e.g., the first electrochemical cell, the second electrochemical cell) comprise a separator between the anode and the cathode. FIG. 2 shows exemplary separator 115 between anode 112 and cathode 114, according to certain embodiments. The separator may be a solid electronically non-conductive or insulative material that separates or insulates the anode and the cathode from each other, preventing short circuiting, and that permits the transport of ions between the anode and the cathode. In some embodiments, the separator is porous and may be permeable to an electrolyte.

It should be understood that while in some embodiments the first electrochemical cell and the second electrochemical cell have the same types of components (e.g., same anode active material, same cathode active material, same type of separator), in other embodiments the first electrochemical cell has one or more different components than the second electrochemical cell (e.g., a different anode active material, a different cathode active material, a different type of separator). In some embodiments, the first electrochemical cell and the second electrochemical cell are identical in composition and/or dimensions.

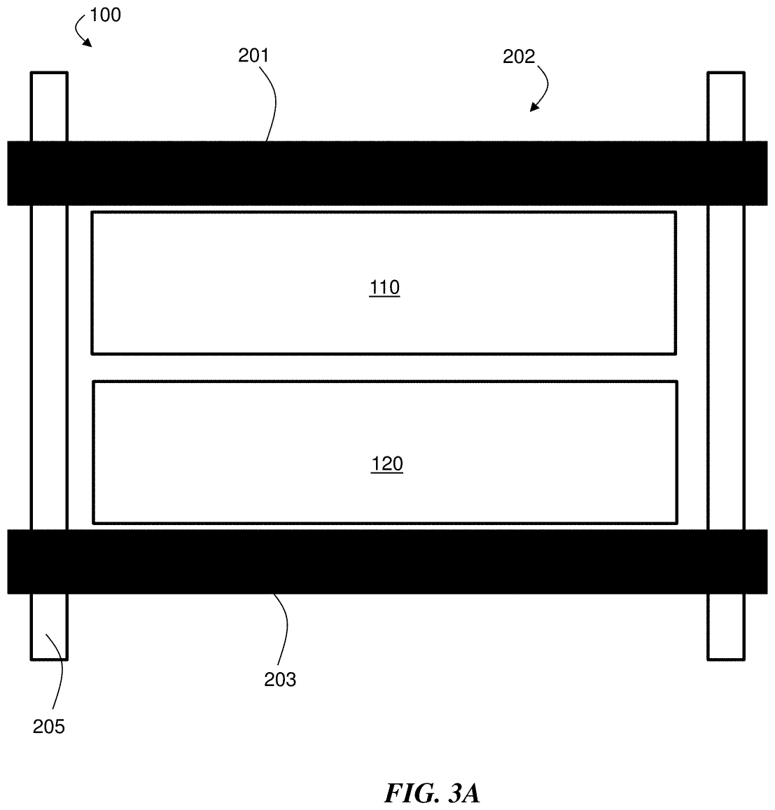

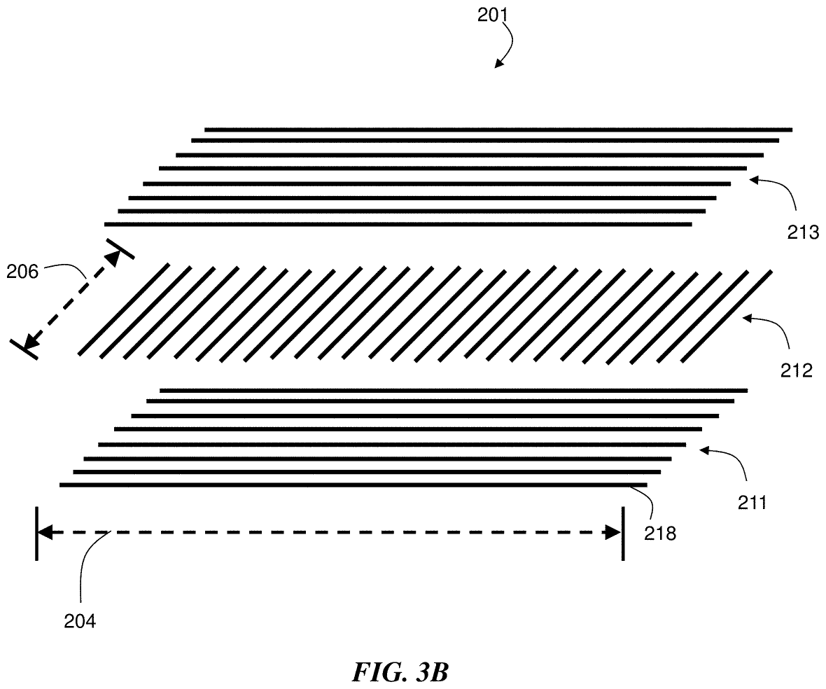

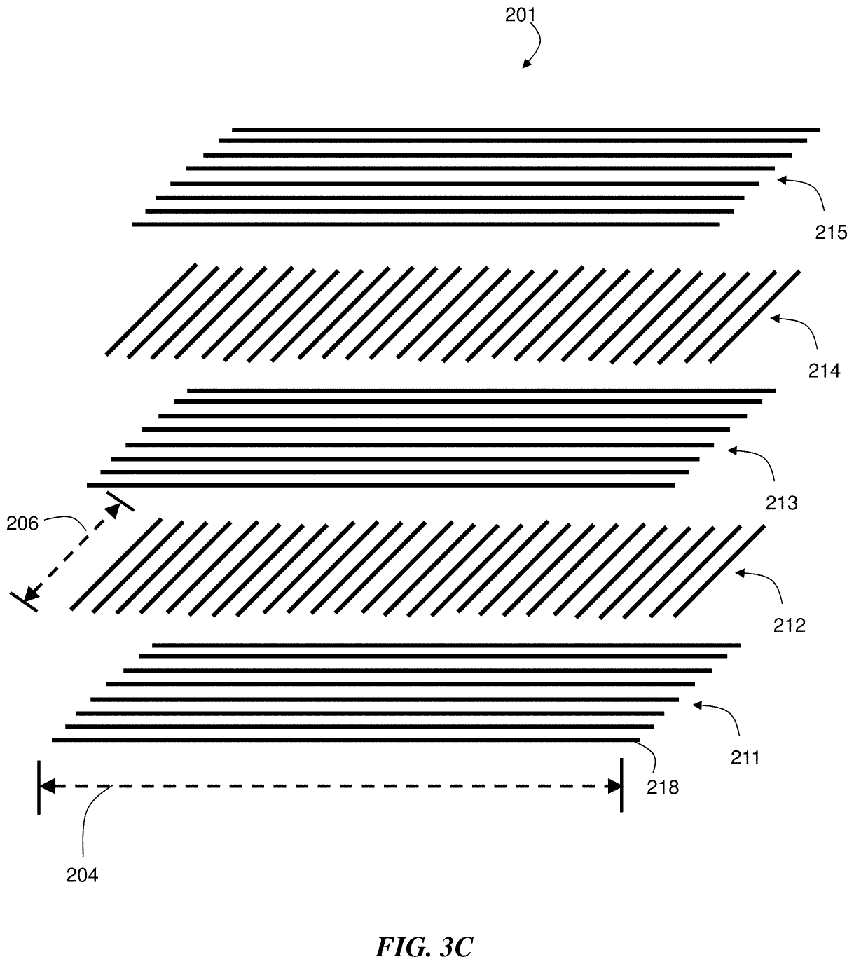

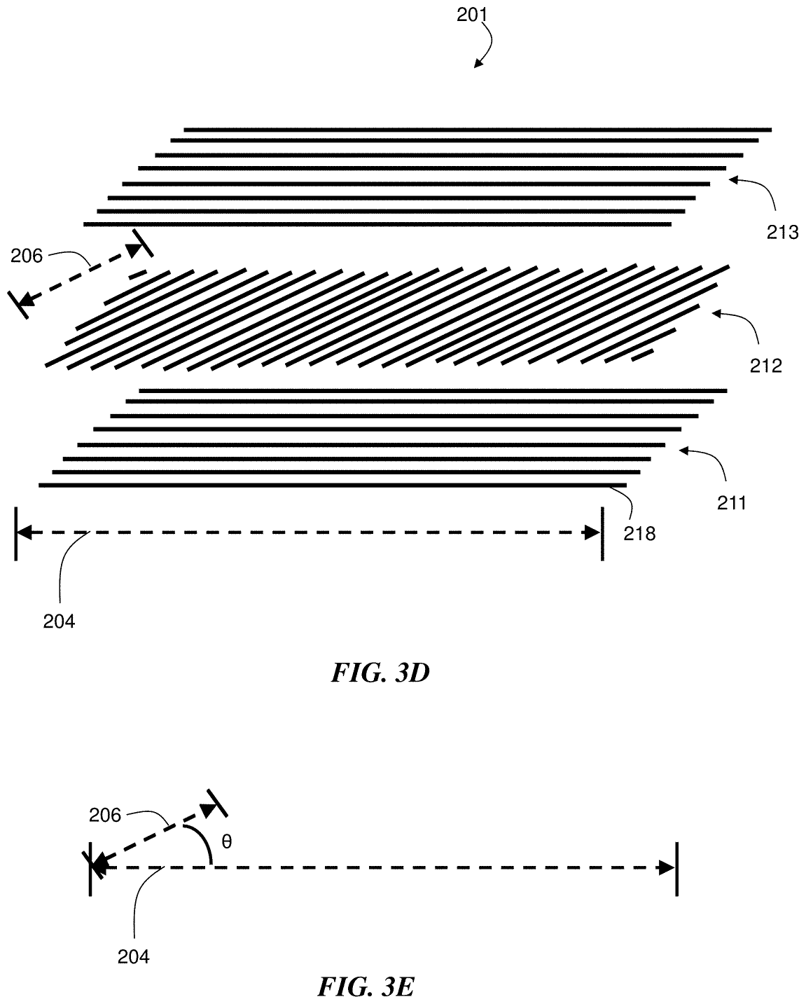

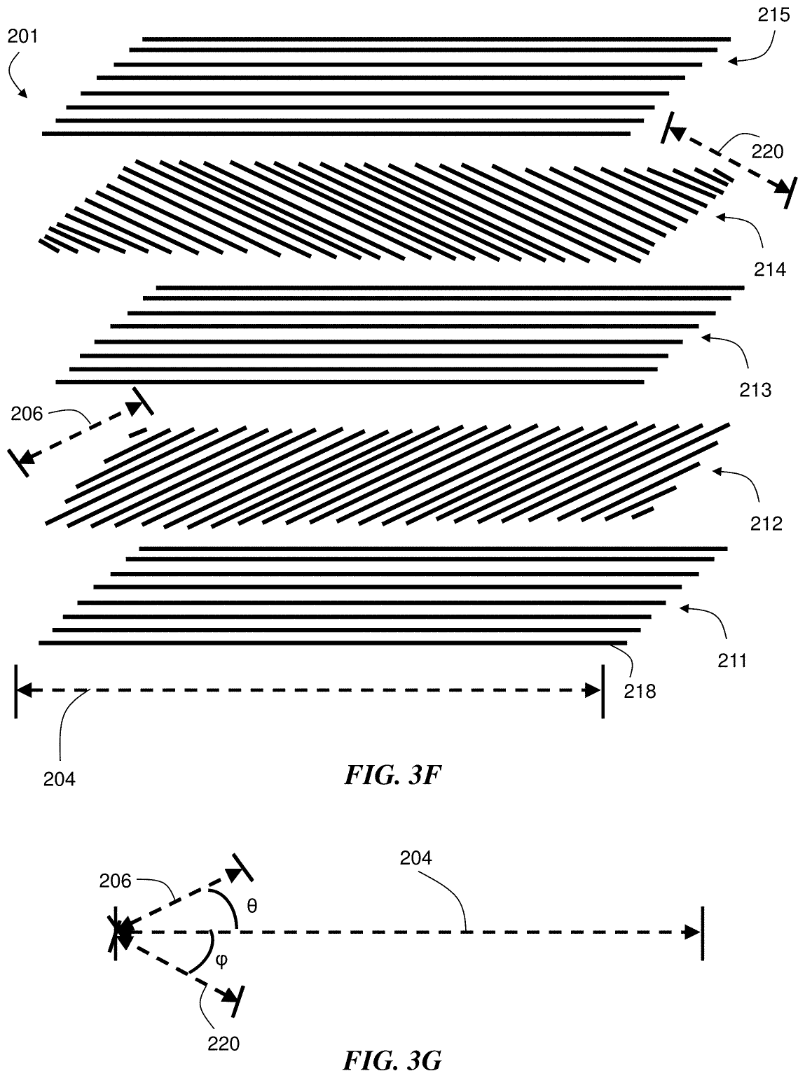

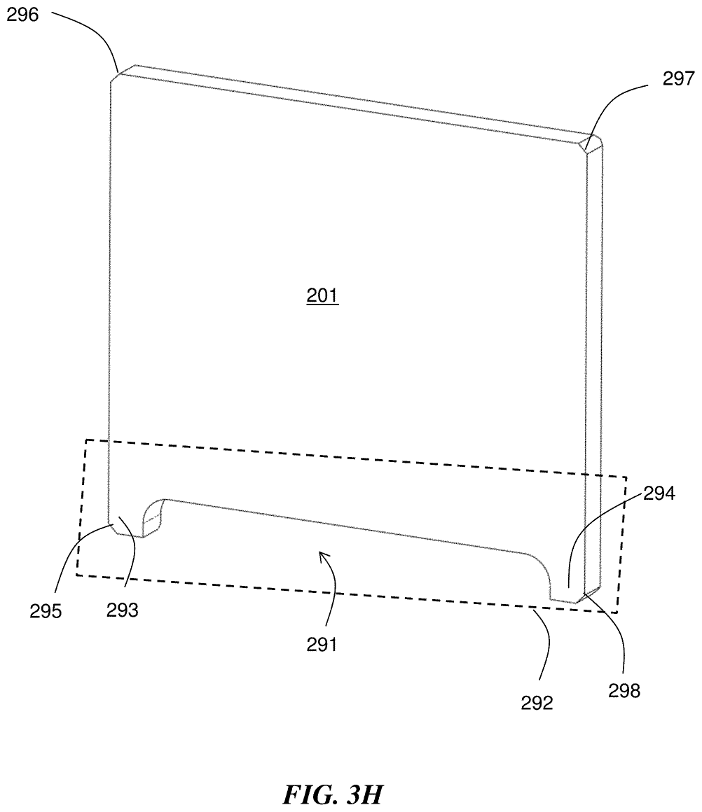

In some embodiments, the battery pack comprises a housing. The housing may at least partially enclose other components of the battery pack. For example, the housing may at least partially enclose the first electrochemical cell and the second electrochemical cell. FIG. 1A shows optional housing 102 at least partially enclosing first electrochemical cell 110 and second electrochemical cell 120, according to certain embodiments. The housing may comprise rigid components. As one example, the housing may comprise one or more solid plates. The solid plate may, for example, be an endplate. FIG. 3A shows a cross-sectional schematic diagram of exemplary battery pack 100 comprising housing 202, housing 202 comprising first solid plate 201 and second solid plate 203. Further details of certain solid plates that may be used in the battery pack are described below. In certain cases, the housing does not comprise a solid plate. For example, in some cases, the solid surface and other components of a containment structure of a housing configured to house the electrochemical device are part of a unitary structure.

Some embodiments are related to applying, during at least one period of time during charge and/or discharge of the electrochemical cells (e.g., first electrochemical cell, second electrochemical cell), an anisotropic force with a component normal to an electrode active surface of at least one electrochemical cell of the battery pack. As used herein, the term “electrode active surface” is used to describe a surface of an electrode that can be in physical contact with an electrolyte when the article is part of an electrochemical cell, and at which electrochemical reactions may take place. The electrolyte can comprise any of a variety of materials that permit transport of ions or other non-electron electrochemically active reactants between the electrode and a counter-electrode. As one example, in embodiments in which the electrode comprises a lithium metal foil, the external surface of the lithium metal foil would be an active surface of the electrode. As mentioned above, application of such a force may reduce potentially deleterious phenomena associated with certain types of electrochemical cells (e.g., cells comprising lithium metal as an electrode active material) and improve utilization. For example, in some cases, applying an anisotropic force with a component normal to an active surface of an electrode of the electrochemical device can reduce problems (such as surface roughening of the electrode and dendrite formation) while improving current density. Application of such forces to multiple electrochemical cells of a battery pack may present certain challenges, including uniformity of pressure distribution for each electrochemical cell, which can be important for both performance and durability. Certain aspects described herein may, in some cases, address and overcome such challenges.

FIG. 1A depicts a schematic cross-sectional illustration of a force that may be applied to the first electrochemical cell and the second electrochemical cell in the direction of arrow 181. Arrow 182 illustrates the component of force 181 that is normal to an active surface of first electrochemical cell 110, according to certain embodiments.

In some embodiments, the housing of the battery pack is configured to apply, during at least one period of time during charge and/or discharge of the first electrochemical cell and/or the second electrochemical cell, an anisotropic force having a relatively high magnitude component normal to electrode active surfaces of at least one (or all) of the electrochemical cells in the battery pack. For example, in some embodiments where the battery pack comprises a first electrochemical cell having a first electrode active surface and a second electrochemical cell having a second electrode active surface, the housing of the battery pack is configured to apply, during at least one period of time during charge and/or discharge of the first electrochemical cell and/or the second electrochemical cell, an anisotropic force having a relatively high magnitude component normal to the first electrode active surface and the second electrode active surface. The housing may be configured to apply such a force in a variety of ways. For example, in some embodiments, the housing comprises two solid articles (e.g., a first solid plate and a second solid plate as shown in FIG. 3A, where housing 202 comprises first solid plate 201 and second solid plate 203). An object (e.g., a machine screw, a nut, a spring, etc.) may be used to apply the force by applying pressure to the ends (or regions near the ends) of the housing. In the case of a machine screw, for example, the electrochemical cells and other components of the battery pack may be compressed between the plates (e.g., a first solid plate and a second solid plate) upon rotating the screw. As another example, in some embodiments, one or more wedges may be displaced between the housing and a fixed surface (e.g., a tabletop, etc.). The force may be applied by driving the wedge between the housing (e.g., between a solid plate of a containment structure of the housing) and the adjacent fixed surface through the application of force on the wedge (e.g., by turning a machine screw).

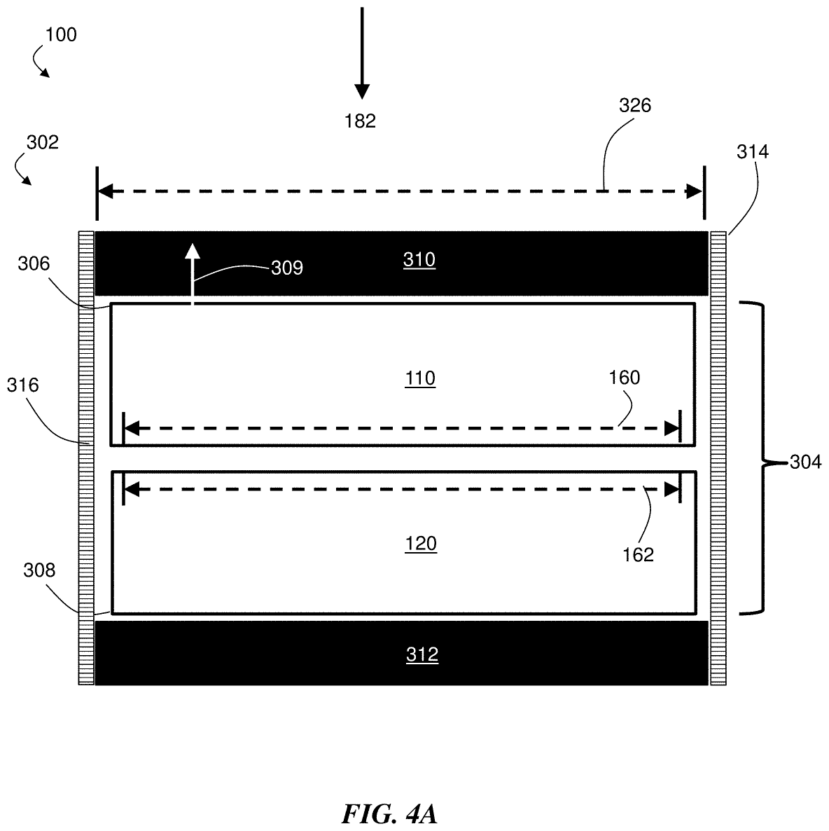

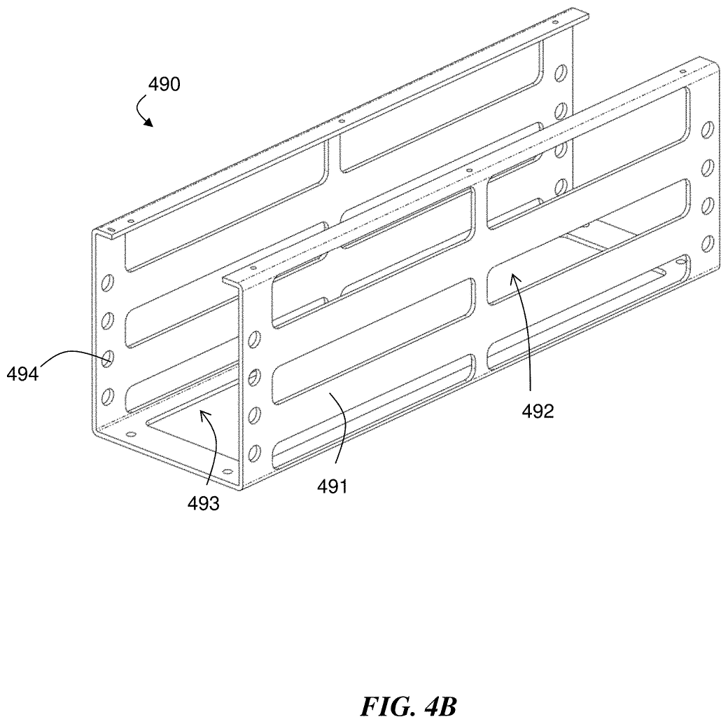

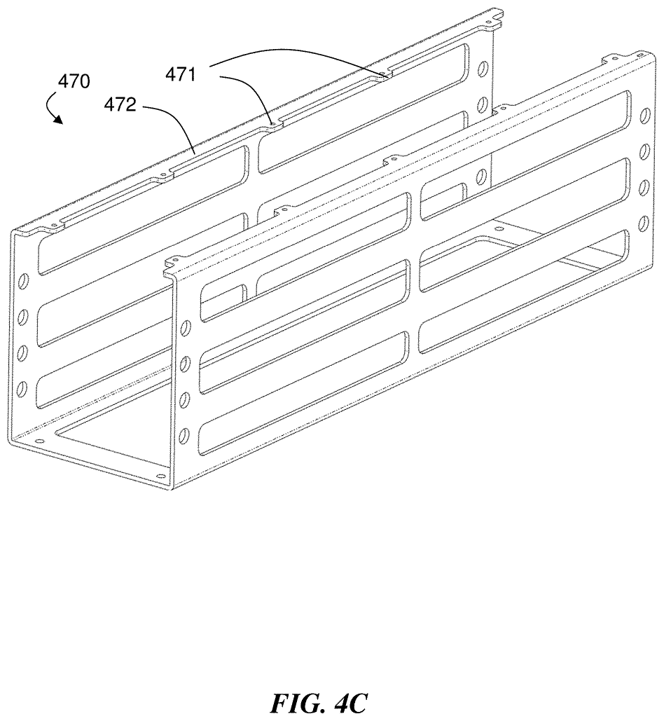

Some embodiments comprise applying an anisotropic force with a component normal to a first electrode active surface of the first electrochemical cell and/or a second electrode active surface of the second electrochemical cell defining a pressure of at least 3 kg_{f}/cm², at least 5 kg_{f}/cm², at least 8 kg_{f}/cm², at least 10 kg_{f}/cm², at least 12 kg_{f}/cm², at least 20 kg_{f}/cm², at least 25 kg_{f}/cm², or more. In some such cases, the housing is configured to apply such anisotropic forces. While high magnitudes of anisotropic force with a component normal to an electrode active surface can improve performance, too high of a magnitude of force may cause problems such as damage to certain components of the battery pack (e.g., the thermally insulating compressible solid article portion described below). It has been unexpectedly observed, however, that there are ranges of magnitudes of anisotropic force that can be applied that can, in some cases, achieve desirable performance of the battery pack while avoiding such damage. For example, some embodiments comprise applying (e.g., via the housing) during at least one period of time during charge and/or discharge of the first electrochemical cell and/or the second electrochemical cell, an anisotropic force with a component normal to a first electrode active surface of the first electrochemical cell and/or a second electrode active surface of the second electrochemical cell defining a pressure of less than or equal to 40 kg_{f}/cm², less than or equal to 35 kg_{f}/cm², less than or equal to 30 kg_{f}/cm², less than or equal to 25 kg_{f}/cm², less than or equal to 20 kg_{f}/cm², less than or equal to 15 kg_{f}/cm², less than or equal to 12 kg_{f}/cm², or less. Combinations of these ranges (e.g., at least 3 kg_{f}/cm² and less than or equal to 25 kg_{f}/cm², at least 3 kg_{f}/cm² and less than or equal to 15 kg_{f}/cm², at least 10 kg_{f}/cm² and less than or equal to 40 kg_{f}/cm², or at least 12 kg_{f}/cm² and less than or equal to 30 kg_{f}/cm²) are possible. In some embodiments, an anisotropic force with a component normal to a first electrode surface of the first electrochemical cell and/or a second electrode surface of the second electrochemical cell defining a pressure in one of the aforementioned ranges is applied. In some embodiments, an anisotropic force with a component normal to a surface of an electrode of the first electrochemical cell and/or a surface of an electrode of the second electrochemical cell defining a pressure in one of the aforementioned ranges is applied, where the surface of the electrode of the first electrochemical cell and/or the second electrochemical cell comprises metallic lithium (e.g., lithium metal and/or a metal alloy comprising lithium). In some embodiments, an anisotropic force with a component normal to a surface of an electrode of the first electrochemical cell and/or a surface of an electrode of the second electrochemical cell defining a pressure in one of the aforementioned ranges is applied, where the surface of the electrode of the first electrochemical cell and/or the second electrochemical cell is facing an electrode of the first electrochemical cell or the second electrochemical cell having an opposite polarity (e.g., the anisotropic force has a component normal to a surface of an anode facing a cathode of the cell, or the anisotropic force has a component normal to a surface of a cathode facing an anode of the cell). In some embodiments where the first electrochemical cell and the second electrochemical cell are part of a stack of cells, an anisotropic force with a component normal to a lateral surface of the stack (corresponding to an end of the stack rather than a side of the stack) defining a pressure in one of the aforementioned ranges is applied. In some embodiments where the first electrochemical cell and the second electrochemical cell are part of a stack of cells, an anisotropic force with a component parallel to the direction in which the cells are stacked defining a pressure in one of the aforementioned ranges is applied. For example, in FIG. 4A, force 182 is parallel to the direction in which stack 304 comprising first electrochemical cell 110 and second electrochemical cell 120 is stacked and can define a pressure in one of the aforementioned ranges. In this context, “parallel” can be within 20°, within 10°, within 5°, or within 2° of parallel.

Some embodiments comprise applying a first anisotropic force with a component normal to a first electrode active surface of the first electrochemical cell and/or a second electrode active surface of the second electrochemical cell defining a pressure having a first magnitude of at least 3 kg_{f}/cm² and then also during a charge and/or discharge of the battery pack, applying a second anisotropic force with a component normal to a first electrode active surface of the first electrochemical cell and/or a second electrode active surface of the second electrochemical cell defining a pressure having a second magnitude that is at least 5 kg_{f}/cm², at least 8 kg_{f}/cm², at least 10 kg_{f}/cm², at least 12 kg_{f}/cm², at least 15 kg_{f}/cm², or higher and less than or equal to 40 kg_{f}/cm², less than or equal to 30 kg_{f}/cm², less than or equal to 25 kg_{f}/cm², less than or equal to 20 kg_{f}/cm², less than or equal to 15 kg_{f}/cm², less than or equal to 12 kg_{f}/cm², or less. For example, some embodiments comprise applying a first anisotropic force with a component normal to a first electrode active surface of the first electrochemical cell and/or a second electrode active surface of the second electrochemical cell defining a pressure having a first magnitude of at least 3 kg_{f}/cm² and then also during a charge and/or discharge of the battery pack, applying a second anisotropic force with a component normal to a first electrode active surface of the first electrochemical cell and/or a second electrode active surface of the second electrochemical cell defining a pressure having a second magnitude that is greater than or equal to 12 kg_{f}/cm² and less than or equal to 25 kg_{f}/cm². In some embodiments, the second magnitude of pressure is greater than the first magnitude by a factor of at least 1.2, at least 1.5, at least 2, at least 2.5, and/or up to 3, or up to 4, or higher. The second magnitude may be higher than the first magnitude, for example, in some embodiments where the first magnitude of force is applied via the housing (e.g., a rigid housing) and during a charging and/or discharge process, expansion of one or more components of the battery pack (e.g., one or more electrochemical cells) causes the force experienced by the electrochemical cells to increase. In some embodiments, the first magnitude occurs when the electrochemical cells are at a state of charge (SOC) of less than or equal to 10%, less than or equal to 5%, less than or equal to 2%, less than or equal to 1%, or 0%. In some embodiments, the second magnitude occurs when the electrochemical cells are at a state of charge of greater than or equal to 50%, greater than or equal to 75%, greater than or equal to 90%, greater than or equal to 95%, greater than or equal to 99%, or 100%. Combinations of these ranges are possible. For example, in some embodiments, the first magnitude occurs when the electrochemical cells are at a state of charge of less than or equal to 10% and the second magnitude (e.g., that defines a pressure that is greater than that of the first magnitude by a factor of at least 1.2 and up to 4) occurs when the electrochemical cells are at a state of charge of greater than or equal to 50%. In one exemplary embodiment, the magnitude of anisotropic force defines a pressure of 3 kg_{f}/cm² at a 0% SOC and 25 kg_{f}/cm² at a 100% SOC. In another exemplary embodiment, the magnitude of anisotropic force defines a pressure of 5 kg_{f}/cm² at a 0% SOC and 15 kg_{f}/cm² at a 100% SOC. In another exemplary embodiment, the magnitude of anisotropic force defines a pressure of 12 kg_{f}/cm² at a 0% SOC and 30 kg_{f}/cm² at a 100% SOC. In some embodiments, an anisotropic force with a component normal to a first electrode surface of the first electrochemical cell and/or a second electrode surface the second electrochemical cell defining a pressure in one of the aforementioned ranges is applied. In some embodiments, an anisotropic force with a component normal to a surface of an electrode of the first electrochemical cell and/or a surface of an electrode of the second electrochemical cell defining a pressure in one of the aforementioned ranges is applied, where the surface of electrode of the first electrochemical cell and/or the second electrochemical cell comprises metallic lithium (e.g., lithium metal and/or a metal alloy comprising lithium). In some embodiments, an anisotropic force with a component normal to a surface of an electrode of the first electrochemical cell and/or a surface of an electrode of the second electrochemical cell defining a pressure in one of the aforementioned ranges is applied, where the surface of the electrode of the first electrochemical cell and/or the second electrochemical cell is facing an electrode of the first electrochemical cell or the second electrochemical cell having an opposite polarity (e.g., the anisotropic force has a component normal to a surface of an anode facing a cathode of the cell, or the anisotropic force has a component normal to a surface of a cathode facing an anode of the cell). In some embodiments where the first electrochemical cell and the second electrochemical cell are part of a stack of cells, an anisotropic force with a component normal to a lateral surface of the stack (corresponding to an end of the stack rather than a side of the stack) defining a pressure in one of the aforementioned ranges is applied. In some embodiments where the first electrochemical cell and the second electrochemical cell are part of a stack of cells, an anisotropic force with a component parallel to the direction in which the cells are stacked defining a pressure in one of the aforementioned ranges is applied.

As mentioned above, in some embodiments, the battery pack comprises one or more solid plates. In some such cases, the housing is configured to apply the anisotropic force via a solid plate. The solid plates may be, for example, endplates configured to apply an anisotropic force to the electrochemical cells (e.g., first electrochemical cell, second electrochemical cell). For example, in FIG. 3A, first solid plate 201 and second solid plate 203 are endplates. It should be understood that the surfaces of a solid plate do not necessarily need to be flat. For example, one of the sides of the solid plate may comprise a surface that is curved (e.g., contoured, convex) in the absence of an applied force. In some embodiments, the solid plate (e.g., an aluminum solid plate) is convex with respect to the electrochemical cells in the absence of an applied force, and under at least one magnitude of applied force the end plate may become less convex (e.g., become flat).

The solid plate may have any of a variety of shapes, depending on, for example, the configuration of the housing and the desired performance attributes of the battery. In some embodiments, the solid plate is shaped such that a mass of the solid plate is relatively low for a given overall set of lateral dimensions. In some embodiments, the solid plate has a lateral recess. For example, the solid plate may be shaped such that some (e.g., at least 25 vol %, at least 50 vol %, at least 75 vol %, at least 90 vol %, or more), but not all of an edge region of the solid plate is missing (e.g., lacks solid material). An edge region may be a volume of a solid plate within 20%, within 10%, within 5%, or less of an edge of the solid plate. FIG. 3H shows one such example of a solid plate having a lateral recess, where solid plate 201 has lateral recess 291 corresponding to a lack of solid material in edge region 292. Such a lateral recess may allow for the solid plate to maintain similar or the same overall dimensions (e.g., a same largest lateral cross sectional dimension, same largest width, same largest height) at a comparatively lower mass due to the lack of solid material at the recess. For example, in FIG. 3H, solid plate 201 has a reduced mass compared to a similar plate lacking lateral recess 291, but has a same overall height and width as it would without lateral recess 291 due to edge portion 293 and 294 in edge region 292. It has been realized that such a shape can allow for application of force to electrochemical cells in the battery pack via a solid plate with comparatively less mass, which can promote battery packs with greater specific energy density.

In some embodiments, the solid plate has a lateral cross-sectional shape where some (or all) corners of the shape are truncated. FIG. 3H shows one such example, where solid plate 201 has a cross-sectional shape in the plane of solid plate 201 corresponding to a rectangle with a lateral recess, but where corners 295, 296, 297, and 298 are truncated. It has been realized that a solid plate having a cross-sectional shape with truncated corners can promote facile inclusion of such a solid plate in certain types of housings (e.g., for applying anisotropic forces to active surfaces of electrochemical cells in battery packs). As one example, some embodiments involve housings with solid housing components in the form of a frame at least partially covering the sides of a stack of electrochemical cells, and where solid plates are incorporated into the housing as end plates covering first and second sides of the stack (as described in more detail below). In some instances the frame has rounded corners that might contact full corners of solid plates and cause adverse interactions between the frame and the solid plates. It has been observed that truncated corners can avoid some such rounded corners, promoting more facile incorporation of the plate within the frame. Additionally, incorporation of solid plates in such a frame of a housing may involve sliding the solid plate along at least a portion of the solid housing components. It has been observed that truncated corners may promote easier sliding than with otherwise identical solid plates having untruncated corners. In some embodiments, the solid plate has one or more chamfered edges at a face of the solid plate. The chamfered edges may be at a face of the solid plate facing an interior of the housing (e.g., frame) when the housing is assembled. Some such chamfered edges can also promote facile sliding and mating of the solid plate with an opening of the frame (e.g., during a process of applying anisotropic force via the housing).

The housing may comprise any suitable solid material. In some embodiments, a solid plate is or comprises a metal, metal alloy, composite material, or a combination thereof. In some cases, the metal that the solid plate is or comprises is a transition metal. For example, in some embodiments, the solid article is or comprises Ti, Cr, Mn, Fe, Co, Ni, Cu, or a combination thereof. In some embodiments, the solid plate is or comprises a non-transition metal. For example, in some embodiments, the solid article is or comprises Al, Zn, or combinations thereof. Exemplary metal alloys that the solid plate can be or comprise include alloys of aluminum, alloys of iron (e.g., stainless steel), or combinations thereof. Exemplary composite materials that the solid plate can be or comprise include, but are not limited to, reinforced polymeric, metallic, or ceramic materials (e.g., fiber-reinforced composite materials), carbon-containing composites, or combinations thereof.

In some embodiments, a solid plate (e.g., solid plate 201) of the housing comprises carbon fiber. Carbon fiber may be present in the solid plate in a relatively high amount (e.g., greater than or equal to 50 wt %, greater than or equal to 75 wt %, greater than or equal to 90 wt %, greater than or equal to 95 wt %, greater than or equal to 99 wt %, 100 wt %). Carbon fiber can, in some cases, afford relatively high stiffness and/or strength while having a relatively low mass (e.g., by having a relatively low mass density). It has been discovered, in the context of the present disclosure, that certain types of carbon fiber solid plates can allow for the application of relatively high magnitudes of anisotropic force to the electrochemical cells of the battery pack with relatively uniform distributions across multiple of the electrochemical cells without burdening the battery pack with too much mass. In some embodiments, the carbon fiber comprises unidirectional carbon fiber. In other words, in some embodiments, at least one layer (or all layers) of the carbon fiber material of the solid plate is unidirectional within the layer. While relatively thin and/or twill weave carbon fiber materials are known, it has been discovered herein that unidirectional carbon fiber laminates may afford relatively beneficial properties (e.g., high stiffness and/or strength, low deflection under load). In some embodiments, the housing comprises a solid plate comprising carbon fiber, the solid plate having a thickness of at least 5 mm, at least 8 mm, at least 10 mm, and/or up to 12 mm, up to 15 mm, up to 20 mm, or more.

In some embodiments, the solid plate comprises multiple layers of carbon fiber (e.g., unidirectional carbon fiber). In some such embodiments, the solid plate of the housing comprises a first layer comprising carbon fibers substantially parallel to a first direction in the plane of the first layer and a second layer comprising carbon fibers substantially parallel to a second direction in the plane of the second layer. In some embodiments, two lines in a plane can be substantially parallel if, for example, the maximum angle defined by the two lines is less than or equal to 10°, less than or equal to 5°, less than or equal to 2°, or less than or equal to 1°. The angle between the first direction and the second direction may be an angle θ. In embodiments in which such a layer orientation pattern is repeated, the pattern can be represented as “[0°/0].” In some embodiments, θ is greater than or equal to (i.e., more positive than) −90°, greater than or equal to −75°, greater than or equal to −60°, greater than or equal to −45°, greater than or equal to −30°, greater than or equal to −15°, or greater, and/or less than or equal to 90°, less than or equal to 75°, less than or equal to 60°, less than or equal to 45°, less than or equal to 30°, less than or equal to 15°, or less. Combinations of these ranges (e.g., θ greater than or equal to −90° and less than or equal to 90°) are possible. In some embodiments, θ has a non-zero value. In some embodiments, the solid plate comprises a third layer comprising carbon fibers substantially parallel to the first direction. In embodiments in which such a layer orientation pattern is repeated, the pattern can be represented as “[0°/θ/0° ].” FIG. 3D shows one such embodiment, where first solid plate 201 comprises first layer 211 comprising carbon fibers 218 substantially parallel to first direction 204, second layer 212 comprising carbon fibers 218 substantially parallel to second direction 206, and third layer 213 comprising carbon fibers 218 substantially parallel to first direction 204. FIG. 3E shows angle θ between first direction 204 and second direction 206 for the embodiment illustrated in FIG. 3D. For example, the solid plate of the housing may comprise, in order: a first layer comprising carbon fibers substantially parallel to a first direction in the plane of the first layer, a second layer comprising carbon fibers substantially parallel to a second direction in the plane of the second layer substantially perpendicular (e.g., within 10°, within 5°, within 2°, within 1° of perpendicular) to the first direction, and a third layer comprising carbon fibers substantially parallel to the first direction. Put a different way, in some embodiments θ is within 10°, within 5°, within 2°, within 1° of 90°. Each of the individual layers may have a unidirectional weave. FIG. 3B depicts one such example, where first solid plate 201 comprises first layer 211 comprising carbon fibers 218 substantially parallel to first direction 204, second layer 212 comprising carbon fibers 218 substantially parallel to second direction 206, which is substantially perpendicular to first direction 204, and third layer 213 comprising carbon fibers 218 substantially parallel to first direction 204, according to some embodiments. It has been observed that, in some cases, carbon fiber materials having such a “[0°/90°/0° ]” orientation of layers may have higher strength and/or stiffness than other types of carbon fiber materials. While FIG. 3B shows an embodiment of solid plate 201 comprising three layers, more layers are possible. In some embodiments, the solid plate further comprises, in order, a fourth layer comprising carbon fibers substantially parallel to the second direction and a fifth layer comprising carbon fibers parallel to the first direction. FIG. 3C shows one such embodiment, where first solid plate 201 comprises first layer 211 comprising carbon fibers 218 substantially parallel to first direction 204, second layer 212 comprising carbon fibers 218 substantially parallel to second direction 206, which is substantially perpendicular to first direction 204, third layer 213 comprising carbon fibers 218 substantially parallel to first direction 204, fourth layer 214 comprising carbon fibers 218 substantially parallel to second direction 206, and fifth layer 215 comprising carbon fibers 218 substantially parallel to first direction 204. In some embodiments, the solid plate of the housing comprises at least 1, at least 2, at least 3, at least 5, at least 10, at least 15, and/or up to 20, up to 25, up to 50, up to 60, up to 75, or more layers of carbon fiber (e.g., layered carbon fiber with oriented fibers) as described herein. Some or all of these layers (e.g., oriented layers) may have certain mechanical properties described below (e.g., modulus).

In some embodiments, the multiple layers of carbon fiber comprise, in order: a first layer comprising carbon fibers substantially parallel to a first direction in the plane of the first layer, a second layer comprising carbon fibers substantially parallel (e.g. within 10°, within 5°, within 2°, within 1° of parallel) to a second direction in the plane of the second layer, a third layer comprising carbon fibers substantially parallel to the first direction in the plane of the third layer, a fourth layer comprising carbon fibers substantially parallel (e.g. within 10°, within 5°, within 2°, within 1° of parallel) to a third direction in the fourth layer, and a fifth layer comprising carbon fibers substantially parallel to the first direction in the plane of the fifth layer. The angle between the first direction and the second direction may be an angle θ, and the angle between the first direction and the third direction may be an angle cp. In embodiments in which such a layer orientation pattern is repeated, the pattern can be represented as “[0°/θ/0°/φ/0° ].” It should be understood that when notation of this form is used, the direction of each layer may be within 10° (i.e., +/−10°) of the direction denoted by the angle value in the notation. For example, a layer orientation having repeating units in which the first layer is at 0°, the second layer is at θ, the third layer is at 5°, the fourth layer is at φ, and the fifth layer is at −10° would be considered to have a “[0°/θ/0°/φ/0° ]” layer orientation pattern because each layer is within 10° of the value indicated by the notation. Each of the individual layers may have a unidirectional weave. In some embodiments, θ is greater than or equal to (i.e., more positive than) −90°, greater than or equal to −75°, greater than or equal to −60°, greater than or equal to −45°, greater than or equal to −30°, greater than or equal to −15°, or greater, and/or less than or equal to 90°, less than or equal to 75°, less than or equal to 60°, less than or equal to 45°, less than or equal to 30°, less than or equal to 15°, or less. Combinations of these ranges (e.g., θ greater than or equal to −90° and less than or equal to 90°) are possible. In some embodiments, φ is greater than or equal to −90°, greater than or equal to −75°, greater than or equal to −60°, greater than or equal to −45°, greater than or equal to −30°, greater than or equal to −15°, or greater, and/or less than or equal to 90°, less than or equal to 75°, less than or equal to 60°, less than or equal to 45°, less than or equal to 30°, less than or equal to 15°, or less. Combinations of the ranges (e.g., φ greater than or equal to −90° and less than or equal to 90°) are possible. In some embodiments, φ has a nonzero value. In some embodiments, the value of φ is equal to the negative value of θ (e.g., θ equals 30° and φ equals −30°, or θ equals 60° and φ equals −60°). FIG. 3F shows one such embodiment, where first solid plate 201 comprises first layer 211 comprising carbon fibers 218 substantially parallel to first direction 204, second layer 212 comprising carbon fibers 218 substantially parallel to second direction 206, third layer 213 comprising carbon fibers 218 substantially parallel to first direction 204, fourth layer 214 comprising carbon fibers 218 substantially parallel to third direction 220, and fifth layer 215 comprising carbon fibers 218 substantially parallel to first direction 204. FIG. 3F shows angle θ between first direction 204 and second direction 206 and angle φ between first direction 204 and third direction 220 for the embodiment illustrated in FIG. 3G.

The multiple layers of carbon fiber may include repeating units of the patterns of layer orientations described above (e.g., repeating units of [0°/θ], [0°/θ/0° ], [0°/θ/0°/φ/0° ], etc.). It has been observed that some patterns of unidirectional carbon fiber layers, with certain orientations (e.g., where θ equals 30° and φ equals −30°, denoted as “[0°/30°/0°/−30/0°]”) can afford properties that are beneficial in some scenarios. For example, it has been observed that solid articles such as solid plates having some such patterns of unidirectional carbon fiber layers demonstrate less deflection under applied load than otherwise identical solid articles such as solid plates lacking such patterns (e.g., solid plates in which the carbon fibers of each layer are all substantially parallel).

In some embodiments, the solid plate comprises carbon fiber having a relatively high modulus. For example, in some embodiments the solid plate comprises layers comprising carbon fiber, and one or more of the layers has a relatively high tensile modulus and a relatively high flexural modulus. In some embodiments, the solid plate comprises layers comprising carbon fiber, one or more of the layers having a tensile modulus of at least 120 GPa, at least 150 GPa, at least 200 GPa, at least 300 GPa, at least 500 GPa or greater, and a flexural modulus of at least 120 GPa at least 150 GPa, at least 200 GPa, at least 300 GPa, at least 500 GPa or greater at room temperature (25° C.). In some embodiments, the solid plate comprises layers comprising carbon fiber, one or more of the layers having a tensile modulus of less than or equal to 650 GPa, less than or equal to 600 GPa, less than or equal to 550 GPa or less, and a flexural modulus of less than or equal to 650 GPa, less than or equal to 600 GPa, less than or equal to 550 GPa or less at room temperature (25° C.). Combinations of the ranges (e.g., a tensile modulus of at least 120 GPa and less than or equal to 650 GPa and a flexural modulus of at least 120 GPa and less than or equal to 650 GPa) are possible. The tensile modulus of a layer can be measured using ASTM D3039, and the flexural modulus can be measured using ASTM D790. In certain instances, the solid plate has a relatively large number of layers satisfying the modulus ranges above. For example, in some embodiments, the solid plate comprises at least 1, at least 2, at least 3, at least 5, at least 10, at least 15, and/or up to 20, up to 25, up to 50, up to 60, up to 75, or more layers comprising carbon fiber having a tensile modulus of at least 120 GPa, at least 150 GPa, at least 200 GPa, at least 300 GPa, at least 500 GPa or greater, and a flexural modulus of at least 120 GPa at least 150 GPa, at least 200 GPa, at least 300 GPa, at least 500 GPa or greater at room temperature (25° C.). In some embodiments, the solid plate comprises at least 1, at least 2, at least 3, at least 5, at least 10, at least 15, and/or up to 20, up to 25, up to 50, up to 60, up to 75, or more layers comprising carbon fiber having a tensile modulus of less than or equal to 650 GPa, less than or equal to 600 GPa, less than or equal to 550 GPa or less, and a flexural modulus of less than or equal to 650 GPa, less than or equal to 600 GPa, less than or equal to 550 GPa or less at room temperature (25° C.).

The housing may comprise couplings that can be used to connect components of the housing and/or apply the anisotropic force. The housing may comprise, for example, couplings proximate to the ends of the housing (e.g., proximate to the ends of the solid plates). FIG. 3A shows coupling 205 connecting first solid plate 201 and second solid plate 203, according to certain embodiments. In some embodiments, the housing of the battery pack has more than one coupling. In certain cases, the housing includes at least 2 couplings, at least 4 couplings, and/or up to 8 couplings or more. In some embodiments, the coupling comprises a fastener. The fastener may span from one end of the housing to another. As one example, coupling 205 in FIG. 3A may be a fastener spanning from first solid plate 201 to second plate 203 of housing 202. Exemplary fasteners include, but are not limited to, a rod (e.g., a threaded rod, a rod with interlocking features), a bolt, a screw (e.g., a machine screw), a nail, a rivet, a tie, a clip (e.g., a side clip, a circlip), a band, or combinations thereof. In some cases, applying a force comprises causing relative motion between one portion of the coupling (e.g., a nut) and a fastener of the coupling (e.g., by tightening a nut at an interface between the fastener and the solid plate or, in cases where the fastener comprises a machine screw, by turning the machine screw).

Some embodiments may comprise at least partially charging and/or discharging electrochemical cells in a battery pack, such that the electrochemical cells undergo a cumulative expansion during the charging and/or discharging. The cumulative expansion of the electrochemical cells refers to the sum of the changes in thicknesses of the electrochemical cells themselves, not counting any other components of the battery pack (e.g., foams, sensors, plates, etc.). For example, referring to FIGS. 1A-1B, during the process of at least partially charging and/or discharging battery pack 100, first electrochemical cell 110 and second electrochemical cell 120 may expand (e.g., in thickness). Such an expansion may occur due, for example, to the deposition of lithium metal on an anode when lithium metal is used as an anode active material. In some embodiments, the electrochemical cells undergo the cumulative expansion during charging. During the expansion, first electrochemical cell 110 may expand from thickness 117 in FIG. 1A to thickness 217 in FIG. 1B, and second electrochemical cell 120 may expand from thickness 123 in FIG. 1A to thickness 223 in FIG. 1B, according to certain embodiments. The difference between the sum of thickness 117 and thickness 123 and the sum of thickness 217 and thickness 223 would then be the cumulative expansion of first electrochemical cell 110 and second electrochemical cell 120. Meanwhile, in some, but not necessarily all embodiments, the battery pack as a whole also undergoes an expansion during the charging and/or discharging. For example, battery pack 100 may expand from thickness 103 in FIG. 1A to thickness 107 in FIG. 1B, according to certain embodiments. In some embodiments, the electrochemical cells of the battery pack may undergo a cumulative expansion that is relatively large, while an expansion of the battery pack is relatively small. It has been discovered that certain inventive aspects of the present disclosure, such as the application of relatively high magnitudes of force to multiple electrochemical cells, the use of strong and/or stiff housings (e.g., comprising certain carbon fiber plates), and the use of compressible components such as the thermally insulating compressible solid article portions described below, may afford such a small (or no) expansion of the battery pack even when the electrochemical cells expand to a relatively large extent.

It has been observed that the expansion of at least some electrochemical cells (e.g., some electrochemical cells comprising lithium metal and/or a lithium metal alloy as an anode active material) is equal to 0.055 mm/Ah multiplied by the capacity of the cell in Ah. For example, such a 20 Ah cell will expand 1.1 mm because (0.055 mm/Ah)×(20 Ah)=1.1 mm. As another example, a 6 Ah cell will expand 0.33 mm because (0.055 mm/Ah)×(6 Ah)=0.33 mm. From this expansion relationship, it can be determined that in some instances the cumulative expansion of the electrochemical cells in a battery pack will be equal to the number of cells in the stack multiplied by 0.055 mm/Ah multiplied by the capacity of the cell in Ah. For example, a battery pack having 12 electrochemical cells each having a 20 Ah capacity may have a cumulative expansion of 13.2 mm because 12×(0.055 mm/Ah)×(20 Ah)=13.2 mm. As another example, a battery pack having 48 electrochemical cells each having a 20 Ah capacity may have a cumulative expansion of 52.8 mm because 48×(0.055 mm/Ah)×(20 Ah)=52.8 mm.

In some embodiments, the electrochemical cells of the battery pack undergo a cumulative expansion during the charging and/or discharging of at least 10%, at least 15%, at least 20%, and/or up to 30% or more, while an expansion of the battery pack during the charging and/or discharging is less than or equal to 0.75%, less than or equal to 0.5%, less than or equal to 0.1%, and/or as low as 0.05%. In some embodiments, the electrochemical cells undergo a cumulative expansion during the charging and/or discharging, wherein a ratio of the cumulative expansion of the electrochemical cells to an expansion of the battery pack is greater than or equal to the total number of electrochemical cells in the battery pack. For example, a battery pack comprising 12 electrochemical cells may undergo a cumulative expansion of 13 mm, and the battery pack may undergo an expansion of 0.9 mm, and therefore the ratio of the cumulative expansion of the electrochemical cells to the expansion of the battery pack is 13 divided by 0.9=14.4, which is greater than the number of electrochemical cells in the battery pack (12). In some embodiments, the electrochemical cells undergo a cumulative expansion during the charging and/or discharging of greater than or equal to 0.3 mm, greater than or equal to 0.5 mm, greater than 1 mm, greater than or equal to 1.1, greater than or equal to 1.2 mm, greater than or equal to 1.5 mm, greater than or equal to 2 mm, greater than or equal to 5 mm, greater than or equal to 10 mm, greater than or equal to 12 mm, greater than or equal to 20 mm, greater than or equal to 30 mm, greater than or equal to 40 mm, greater than or equal to 50 mm, and/or up to 60 mm, up to 80 mm, up to 100 mm or more, and an expansion of the battery pack during the charging and/or discharging is less than or equal to 1 mm, less than or equal to 0.75 mm, less than or equal to 0.5 mm, and/or as low as 0.2 mm, as low as 0.1 mm, or less. It should be understood that in some embodiments, the cumulative expansion of the electrochemical cells may be in any of the above-mentioned ranges, while the battery pack does not expand at all. For example, in some embodiments, one or more components of the battery pack (e.g., a compressible component such as a thermally insulating compressible solid article portion) may absorb the expansion by compressing to an equal extent. In some embodiments, during the cumulative expansion of the electrochemical cells, each electrochemical cell expands by at least 1 mm. In some embodiments, the cumulative expansion of the electrochemical cells is at least 12 mm. In some embodiments, the cumulative expansion of the electrochemical cells is at least 24 mm. In some embodiments, the cumulative expansion of the electrochemical cells is at least 36 mm. In some embodiments, the cumulative expansion of the electrochemical cells is at least 52 mm.

In some embodiments, the battery pack has a relatively small volume. It has been discovered that certain aspects described herein, alone or in combination, such as the solid plates comprising carbon fiber, the thermally insulating compressible solid article portions, and the thermally conductive solid article portions, can allow for relatively high magnitudes of force and/or relatively high energy densities for the battery pack, even with a relatively small volume. In some embodiments, the battery pack has a volume of less than or equal to 15000 cm³, less than or equal to 13500 cm³, less than or equal to 12000 cm³, less than or equal to 10000 cm³, less than or equal to 8000 cm³, less than or equal to 6750 cm³, less than or equal to 6000 cm³, less than or equal to 5000 cm³, and/or as low as 4000 cm³, or lower. As described in more detail below, certain configurations of the housing may provide for an ability to enclose a relatively large amount of electrochemical cell volume and/or apply relatively high force while having a relatively small housing volume.

In some embodiments, the battery pack has a relatively high energy density, as described above. In some embodiments, the battery pack has a specific energy of greater than or equal to 250 Wh/kg. In some embodiments, the battery pack has a specific energy of greater than or equal to 280 Wh/kg, greater than or equal to 290 Wh/kg, greater than or equal to 300 Wh/kg, and/or up to 320 Wh/kg, up to 350 Wh/kg, or more. In some embodiments, the battery pack has a volumetric density of greater than or equal to 230 Wh/L, greater than or equal to 250 Wh/L, greater than or equal to 280 Wh/L, and/or up to 300 Wh/L, or higher.

The battery pack may, surprisingly, have a relatively high energy density and/or apply a relatively high magnitude of force while having a relatively low pack burden (defined as one minus the mass of the electrochemical cells of the battery pack divided by the total mass of the battery pack). Expressed as an equation, pack burden=1−(mass of the electrochemical cells/mass of the battery pack). In some embodiments, the battery pack has a pack burden of less than or equal to 50%, less than or equal to 45%, less than or equal to 40%, less than or equal to 35%, less than or equal to 30%, and/or as low as 25%, as low as 20%, or lower.

In some embodiments, the battery pack includes components configured such that the battery pack (or portions of the battery pack) has a relatively low volume for a given size of electrochemical cells, compared to other configurations. Having a relatively low housing volume while having relatively large electrochemical active regions of cells may afford relatively large volumetric energy densities. Relatively large volumetric energy densities may be advantageous in certain applications where limited space for battery packs is available, but where a large amount of stored energy may be desired, such as certain battery-powered vehicles. It has been realized that certain existing housings configured to apply anisotropic forces may have arrangements or operate under mechanisms that require relatively large spatial profiles. For example, housings configured to apply anisotropic forces to electrochemical cells via solid plates generally include fasteners spanning between solid plates. Tension in the fasteners may contribute some or all of the force applied to the cells within the housings. The battery pack in FIG. 3A is one such example. However, while such configurations may be useful for certain applications, the use of fasteners for applying tension when applying force via solid plates generally requires a relatively large lateral extension of pressure-applying components of the housing past lateral dimensions of electrochemical active regions of the electrochemical cells. Such “overhang” of housing components with respect to the cells may contribute to a large volume of the overall housing and battery pack. Certain embodiments herein are directed to application of force to electrochemical cells (e.g., the first electrochemical cell, the second electrochemical cell) with relatively low lateral extension of solid plates and/or pressure-applying components.

In some embodiments, the battery pack comprises a stack comprising electrochemical cells (e.g., the first electrochemical cell, the second electrochemical cell). It should be understood that the stack may be a multicomponent stack comprising non-cell components such as thermally insulating compressible solid article portions, thermally conductive solid article portions, and/or sensors. The stack may be at least partially enclosed by a housing comprising a solid plate. The solid plate may cover at least a portion (e.g., at least 10%, at least 25%, at least 50%, at least 75%, at least 90%, at least 95%, or all) of an end of the stack. A portion of a surface (e.g., an end of a stack) of an object is considered covered by a second object in this context if there exists a line perpendicular to and extending out of the portion of the surface and away from a bulk of the object that intersects any of the second object. Those of ordinary skill in the art will appreciate that any stack of components (e.g., cells) includes two ends: the first end corresponds to the external surface of the first component (e.g., first cell) that faces away from the bulk of the stack, and the second end corresponds to the external surface of the last component (e.g., last cell) that faces away from the bulk of the stack. In the schematic cross-sectional illustration in FIG. 4, battery pack 100 comprises housing 302 comprising solid plate 310, where housing 302 at least partially encloses stack 304 comprising first electrochemical cell 110 and second electrochemical cell 120, in accordance with some embodiments. Stack 304 has first end 306 corresponding to the external surface of first electrochemical cell 110 that faces away from the bulk of stack 304, and stack 304 also has second end 308 corresponding to the external surface of second electrochemical cell 120 that faces away from the bulk of stack 304, according to certain embodiments. In FIG. 4, solid plate 310 covers at least a portion of first end 306 of stack 304, because line 309 perpendicular to and extending out of first end 306 and away from the bulk of stack 304 intersects plate 310.

In some embodiments, the housing of the battery pack further comprises a solid housing component coupled to the solid plate. In some embodiments, the solid housing component is a discrete object separate from the solid plate rather than part of a unitary object with the solid plate (though in some embodiments the solid housing component and the solid plate are part of a unitary solid object). The solid housing component (e.g., discrete solid housing component) may contribute, at least in part, to application of anisotropic force by the housing (e.g., to an electrochemical cell in the stack). For example, in some embodiments, the housing is configured to apply, via the solid plate and tension in the solid housing component coupled to the solid plate, during at least one period of time during charge and/or discharge of the first electrochemical cell and/or the second electrochemical cell, an anisotropic force with a component normal to a first electrode active surface of the first electrochemical cell and/or a second electrode active surface of the second electrochemical cell. As noted above, the anisotropic force may define a pressure of at least 3 kg_{f}/cm², at least 5 kg_{f}/cm², at least 8 kg_{f}/cm², at least 10 kg_{f}/cm², at least 12 kg_{f}/cm², at least 20 kg_{f}/cm², and/or up to 25 kg_{f}/cm², up to 30 kg_{f}/cm², up to 35 kg_{f}/cm², up to 40 kg_{f}/cm², or more. The solid housing component (e.g., discrete solid housing component) may contribute to force application by being coupled to a first solid plate (covering at least a portion of a first end of the stack) and a second component of the housing covering at least a portion of a second end of the stack (e.g., a second solid plate or a part of a frame). For example, referring again to FIG. 4, housing 302 comprises solid housing component 314 coupled to first solid plate 310 and second solid plate 312 (which covers second end 308 of stack 304). Tension in solid housing component 314 may contribute force causing first solid plate and/or second solid plate 312 to compress stack 304, thereby applying an anisotropic force in direction of arrow 182 having component 182 normal to a first electrode active surface of first electrochemical cell 110 and/or a second electrode active surface of second electrochemical cell 120.

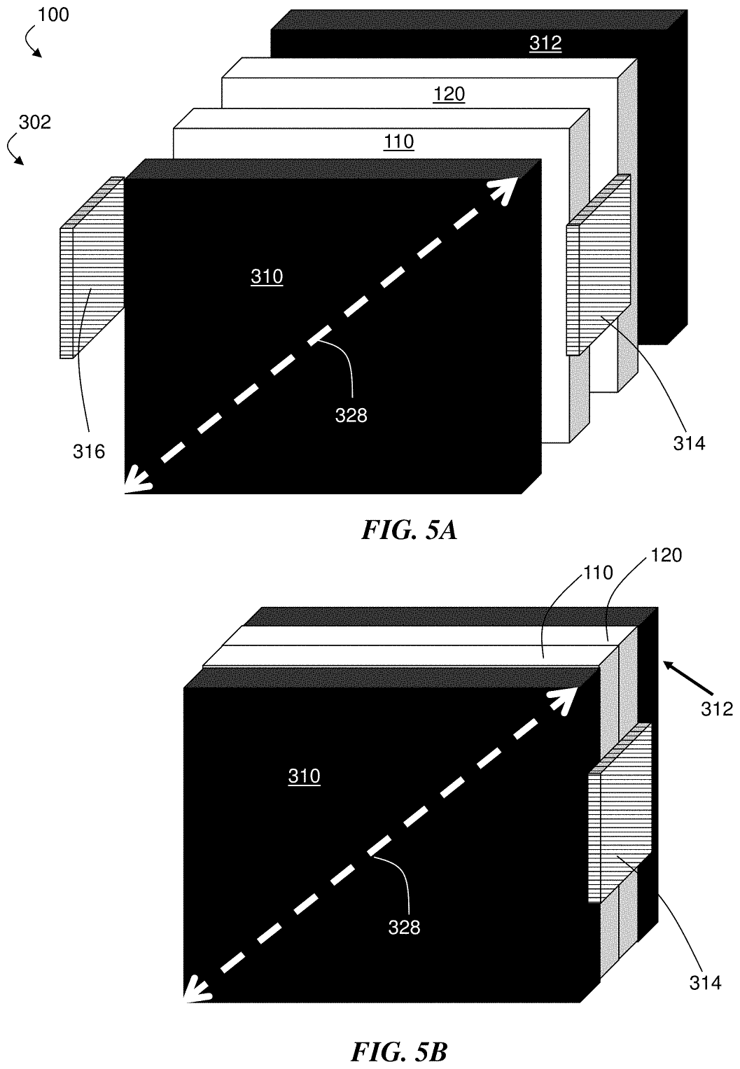

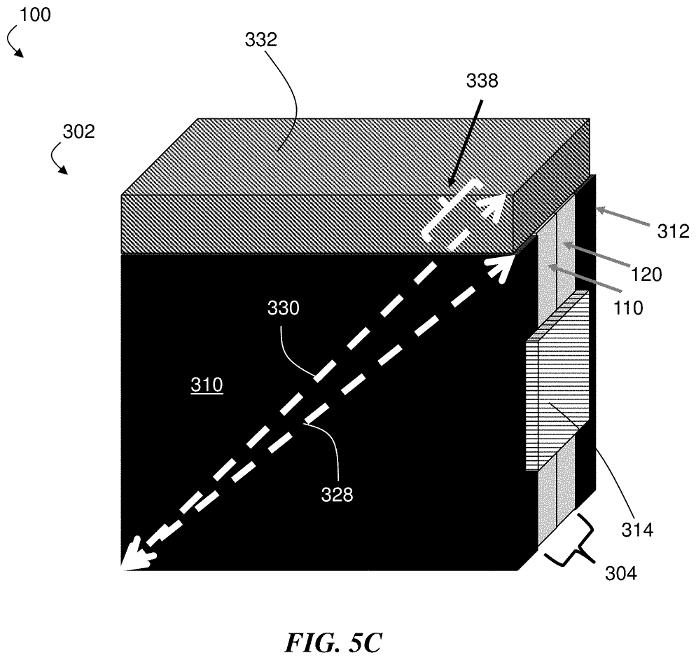

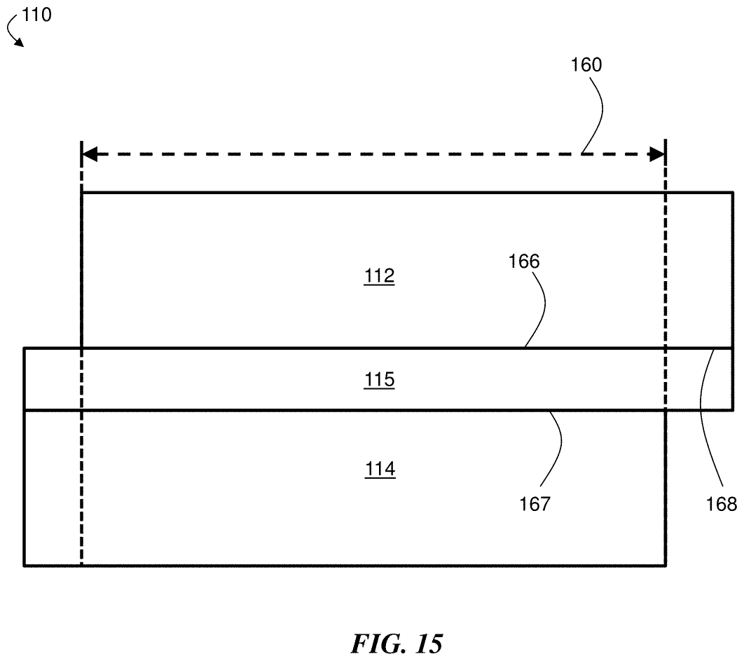

The solid plate may have a largest lateral dimension that is relatively small with respect to an electrochemical active region of one or more of the electrochemical cells in the battery pack. Electrochemical active regions of electrochemical cells are described in more detail below in connection with FIG. 15. Having a relatively small lateral profile of the solid plate may stand in contrast to solid plates in certain existing housings having larger lateral profiles (e.g., due to lateral space needed for load-applying fasteners to pass through the solid plate). Certain embodiments of this disclosure are directed to various techniques and configurations that can make inclusion of solid plates having relatively small lateral profiles practical (e.g., via certain configurations of solid housing components). Small solid plates (relative to the electrochemical cells) may afford overall battery packs having relatively small volumes, which can be advantageous in some applications. A lateral dimension of a solid plate refers to a dimension parallel to an exterior lateral surface of the solid plate (as opposed to a thickness of the solid plate). FIG. 4 shows lateral dimension 326 of solid plate 310 as an illustrative example. FIG. 4 also shows first electrochemical active region 160 of first electrochemical cell 110 and second electrochemical active region 162 of second electrochemical cell 120, according to some embodiments. FIGS. 5A-5B show exploded view (FIG. 5A) and perspective view (FIG. 5B) schematic illustrations of battery pack 100 including housing 302 at least partially enclosing first electrochemical cell 110 and second electrochemical cell 120, in accordance with some embodiments. In FIGS. 5A-5B, housing 302 comprises solid plate 310 having largest lateral dimension 328, as illustrated by the dashed line with arrows. Solid plate 310 may be a first solid plate, and housing 302 may further comprise second solid plate 312 coupled to first solid plate via solid housing component 314.

In some embodiments in which the stack comprises a first electrochemical cell comprising a first electrochemical active region and a second electrochemical cell comprising a second electrochemical active region, a ratio of the largest lateral dimension of the solid plate to the largest lateral dimension of the first electrochemical active region and/or a ratio of the largest lateral dimension of the solid plate to the largest lateral dimension of the second electrochemical active region is less than or equal to 1.5, less than or equal to 1.4, less than or equal to 1.3, less than or equal to 1.2, less than or equal to 1.1, less than or equal to 1.05, less than or equal to 1.02, less than or equal to 1.01, and/or as low as 1.005, as low as 1.001, or as low as 1.

The housing of the battery pack may have a largest lateral pressure-applying dimension. A lateral pressure-applying dimension refers to a dimension of the housing parallel with the lateral exterior surfaces of components of the stack and the solid plate that corresponds to components of the housing under tension such that they participate in the application of pressure to the electrochemical cells of the stack via the anisotropic force discussed above.

FIG. 5C illustrates the concept of a lateral pressure-applying dimension of a housing. Battery pack 100 comprises housing 302 comprising solid plate 310, solid housing component 314, and electronics component 332 coupled to solid plate 310 and positioned along a side of stack 304. Housing 302 has largest lateral pressure-applying dimension 328 between far corners of solid plate 310. (While this matches the largest lateral dimension of solid plate 310 in the pictured embodiment, such an occurrence is not necessary, as in other embodiments parts beyond the solid plate may be pressure-applying and contribute to a largest lateral pressure-applying dimension). All components of housing 302 within largest lateral pressure-applying dimension 302 are under tension during application of force by the housing to first electrochemical cell 110 and/or second electrochemical cell 120. Housing 302 also has an overall largest lateral dimension 330 from a corner of solid plate 310 to a far corner of electronics component 332. However, because in this embodiment housing 302 is configured to apply the anisotropic force via solid plate 310 and tension in solid housing component 314, electronics component 332 is not under tension and consequently does not substantially contribute to the application of pressure to first electrochemical cell 110 and/or second electrochemical cell 120. Electronics component 332 would therefore not be considered part of a lateral pressure-applying dimension of housing 302. As a result, part 338 of overall largest lateral dimension 330 is not pressure-applying, and overall largest lateral dimension 330 is larger than the largest lateral pressure-applying dimension 328 of housing 302.

The housing may have a largest lateral pressure-applying dimension that is relatively small with respect to an electrochemical active region of one or more of the electrochemical cells in the battery pack. Having a relatively small lateral pressure-applying profile of the housing may stand in contrast to certain existing pressure-applying housings having larger lateral pressure-applying profiles (e.g., due to lateral space needed for load-applying fasteners to pass through one or more components of the housing such as a solid plate). Certain embodiments of this disclosure are directed to various techniques and configurations that can make housings having relatively small lateral pressure-applying profiles practical (e.g., via certain configurations of solid housing components). Small pressure-applying regions of housings (relative to the electrochemical cells) may afford overall battery packs having relatively small volumes, which can be advantageous in some applications.

In some embodiments in which the stack comprises a first electrochemical cell comprising a first electrochemical active region and a second electrochemical cell comprising a second electrochemical active region, a ratio of the largest lateral pressure-applying dimension to the largest lateral dimension of the first electrochemical active region and/or a ratio of the largest lateral pressure-applying dimension of the solid plate to the largest lateral dimension of the second electrochemical active region is less than or equal to 1.6, less than or equal to 1.5, less than or equal to 1.4, less than or equal to 1.3, less than or equal to 1.2, less than or equal to 1.1, less than or equal to 1.05, less than or equal to 1.02, less than or equal to 1.01, and/or as low as 1.005, as low as 1.001, or as low as 1. In some embodiments, at least 90%, at least 95%, at least 99%, or all of the first electrochemical active region of the first electrochemical cell and/or the second electrochemical active region of the second electrochemical cell is covered by a portion of the housing within the largest lateral pressure-applying dimension of the housing.

The solid housing component may couple (or contribute to coupling of) the solid plate covering at least a portion of a first end of the stack to a component of the housing covering at least a portion of second end of the stack. Such a coupling via the solid housing component (e.g., solid housing component 314) may contribute to the anisotropic force applied by the housing. In some embodiments, the solid housing component spans from the solid plate to the second end of the stack. For example, in FIG. 4, solid housing component 314 spans from first solid plate to second end 308 of stack 304. It should be understood that an object spanning from a first element to a second element may extend past some or all of either the first element of the second element, provided that it reach at least a portion of each the two elements in the direction of the spanning. For example, in FIG. 4, solid housing component 314, which reaches all of but does not extend past solid plate 310 and extends past second end 308, is considered to span from solid plate 310 to second end 308. In some embodiments in which the housing comprises a first solid plate covering at least a portion of the first end of the stack and a second solid plate covering at least a portion of the second end of the stack (e.g., as shown in FIG. 4A), the solid housing component spans from the first solid plate to the second solid plate.

Solid housing components may join two or more parts of the housing via any of a variety of coupling techniques. The solid housing components may be part of the underlying structure of the housing. For example, in some embodiments, the housing comprises a frame at least partially enclosing the stack, and a solid housing component is a part of the frame (e.g., a side of the frame joining two ends of the frame). FIG. 4B, for example, shows frame 490, which may be part of the housing of a battery pack in some embodiments. In some such embodiments, portion 491 of frame 490 can be considered a solid housing component as the term is used in this disclosure. A solid plate may be incorporated into such a frame at one or both open ends of the frame. A frame of a housing may in some instances be made of multiple discrete components. However, in some embodiments, a frame of a housing (e.g., frame 490) is a unitary object (e.g., a unitary piece of carbon fiber composite material).

In some embodiments, a housing has spaces lacking solid material (e.g., along a portion of a solid housing component). For example, in FIG. 4B, frame 490 of a housing has space 492 and space 493 lacking solid material. The spaces may pass through an entire thickness of the solid housing component. Such spaces may reduce a mass of the housing while maintaining same overall housing dimensions (which can promote greater specific energy density). Additionally, such a spaces can be used to assist with cooling some or all of the battery pack. For example, thermally conductive solid article portions (described in more detail below) may have portions extending from a stack in the interior of the housing through at least one of the spaces to an exterior of the housing. In some such embodiments, heat can be facilely transferred from these portions of the thermally conductive solid article portions extending out of the housing. As one example, a coolant (e.g., liquid nitrogen) can contact the portions of the thermally conductive solid article portions extending out of the housing, thereby promoting heat transfer and cooling of components within the housing (e.g., the electrochemical cells). Referring again to FIG. 4B, thermally conductive solid article portions of a stack within frame 490 may extend through space 493 in the bottom of frame 490, where the extended portions can be contacted with coolant (e.g., liquid nitrogen). FIG. 4C shows an alternate embodiment of frame 470, which is similar to frame 490 but includes fastener sites 471 along edges 472 of frame 470. The fastener sites of the solid housing component (e.g., frame) may be configured for fastening the solid housing component to components of a stack within the housing. In some embodiments, the fastener sites of the solid housing component (e.g., frame) are configured for fastening the solid housing component to a substrate of the battery pack. In some embodiments, the fastener sites comprise slots through which a fastener (e.g., a screw, a rod, a bolt) can pass.

The housing may have a single solid housing component, or the housing may comprise multiple solid housing components. In some embodiments, the housing comprises a first solid housing component along a first side of the stack and a second solid housing component on along a second (e.g., opposite) side of the stack. Housing 302 in FIG. 4A shows one such embodiment, where first solid housing component 314 and optional second solid housing component 316 are along opposite sides of stack 304.

In some embodiments, no auxiliary fastener spanning from the solid plate toward the second end of the stack along a side of the stack is in tension during application of the anisotropic force. An auxiliary fastener in this context is a fastener that is not part of the underlying housing structure. For example, in FIG. 3A, where housing 202 comprises first solid plate 201 coupled to second solid plate 203 via a fastener in the form of rod 205, rod 205 is not part of the underlying structure of housing 202 and is therefore considered an auxiliary fastener. In contrast, in FIG. 4A, housing 302 comprises first solid plate 310 and second solid plate 312 coupled via solid housing component 314, which is part of an underlying structure of housing 302 and is therefore not considered an auxiliary fastener. A housing in which no auxiliary fastener spans from the solid plate toward the second end of the stack along a side of the stack is in tension during application of the anisotropic force may still be able to apply the anisotropic force to the electrochemical cells of the stack even without tension from an auxiliary fastener at least because of the presence of a solid housing component in tension coupled to the solid plate, as described above and below. By not requiring an auxiliary fastener in tension for application of the anisotropic force, the housing may require less lateral extension (“overhang”) of pressure-applying components such as solid plates compared to housings that employ auxiliary fasteners in tension for force application. As discussed, less lateral extension beyond electrochemical active areas of the electrochemical cell may contribute to lower overall housing and battery pack volumes (and higher volumetric energy density). In some embodiments, no auxiliary fastener spans from the solid plate to the second end of the stack. For example, in FIG. 4, no auxiliary fastener spans from solid plate 310 to second end 308 of stack 304, in accordance with some embodiments. In some embodiments, no auxiliary fastener passes through a thickness of the solid plate. It should be understood that while in some embodiments no auxiliary fastener spans from the solid plate to the second end of the stack (or passes through a thickness of the solid plate), other fasteners may be present in the housing. For example, in some embodiments, fasteners couple the solid housing component to the solid plate or a solid portion adjacent to the solid plate, as described in more detail below.

The solid housing component may be made of any of a variety of materials, depending on desired properties of the solid housing component and/or the overall battery pack. The solid housing component may be made of any of the materials described above for the solid plate. In some embodiments, the solid housing component comprises a metal (e.g., aluminum, titanium, etc.), metal alloy (e.g., stainless steel), composite, polymeric material (e.g., a rigid plastic), or combination thereof. For example, some (e.g., at least 50 wt %, at least 75 wt %, at least 90 wt %, at least 95 wt %, at least 99 wt %) or all of the solid housing component may be metal, metal alloy, polymeric material, composite, or a combination thereof. In some embodiments, the solid housing component comprises a composite material. Exemplary composite materials that the solid housing component can be or comprise include, but are not limited to, reinforced polymeric, metallic, or ceramic materials (e.g., fiber-reinforced composite materials), carbon-containing composites, or combinations thereof. For example, in some embodiments, the solid housing component comprises carbon fiber. As described above in the context of the solid plate, the solid housing component may comprise multiple layers of carbon fiber (e.g., unidirectional carbon fiber weaves, optionally with binder). In some embodiments, the solid housing component comprises multiple layers of carbon fiber (e.g., unidirectional carbon fiber) having any of the orientation patterns described above (e.g., a “[0°/90°/0° ]” pattern, a “[0°/30°/0°/−30/0°]” pattern, etc.). In some embodiments, the solid housing component comprises a woven fabric. For example, the solid housing component may comprise multiple layers of woven fabric (e.g., woven carbon fibers). In some embodiments, the solid housing component comprises multiple layers of material such as woven fabric (e.g., woven carbon fiber), with at least two adjacent layers having a same or different weave pattern. In some such embodiments, the at least two adjacent layers with the same or different weave pattern are rotated with respect to each other (e.g., at an angle greater than 0°, greater than or equal to 15°, greater than or equal to 30°, greater than or equal to 45°, greater than or equal to 60°, greater than or equal to 90°, greater than or equal to 180°, or more). It has been observed that carbon fiber composite solid housing components may afford sufficient strength and rigidity for contributing to application of anisotropic force to cells in the stack while being relatively light-weight, which may promote desirable specific energy densities for certain applications. In some embodiments where a housing comprises a solid plate and a solid housing component coupled to the solid plate, the solid plate and the solid housing component have the same composition. For example, both may be made of the same metal or metal alloy (e.g., aluminum), polymeric material, composite (e.g., carbon fiber composite), or combination thereof. However, in some embodiments the solid plate and the solid housing component are made of different compositions (e.g., different types of materials or the same materials in different relative amounts).

In some embodiments, the solid housing component comprises a material (e.g., a composite comprising carbon fiber) having a relatively high modulus. In some embodiments, the solid housing component has a relatively high tensile modulus and a relatively high flexural modulus. In some embodiments, some or all of the solid housing component has a tensile modulus of at least 1 GPa, at least 5 GPa, at least 10 GPa, at least 20 GPa, at least 50 GPa, at least 75 GPa, at least 100 GPa, 120 GPa, at least 150 GPa, at least 200 GPa, at least 300 GPa, at least 500 GPa and/or up to 550 GPa, up to 600 GPa, up to 650 GPa, or greater, and a flexural modulus of at least 120 GPa at least 150 GPa, at least 200 GPa, at least 300 GPa, at least 500 GPa and/or up to 550 GPa, up to 600 GPa, up to 650 GPa, or greater at room temperature (25° C.). For example, in some embodiments the solid housing component comprises layers comprising a material (e.g., a composite comprising carbon fiber), and one or more of the layers has a relatively high tensile modulus and a relatively high flexural modulus. In some embodiments, the solid housing component comprises layers comprising a material (e.g., a composite comprising carbon fiber), one or more of the layers having a tensile modulus of at least 120 GPa, at least 150 GPa, at least 200 GPa, at least 300 GPa, at least 500 GPa or greater, and a flexural modulus of at least 120 GPa at least 150 GPa, at least 200 GPa, at least 300 GPa, at least 500 GPa, or greater at room temperature (25° C.). In some embodiments, the solid housing component comprises layers comprising a material (e.g., a composite comprising carbon fiber), one or more of the layers having a tensile modulus of less than or equal to 650 GPa, less than or equal to 600 GPa, less than or equal to 550 GPa, or less, and a flexural modulus of less than or equal to 650 GPa, less than or equal to 600 GPa, less than or equal to 550 GPa, or less at room temperature (25° C.). Combinations of the ranges (e.g., a tensile modulus of at least 120 GPa and less than or equal to 650 GPa and a flexural modulus of at least 120 GPa and less than or equal to 650 GPa) are possible. In certain instances, the solid housing component has a relatively large number of layers satisfying the modulus ranges above. For example, in some embodiments, the solid housing component comprises at least 1, at least 2, at least 3, at least 5, at least 10, at least 15, and/or up to 20, up to 25, up to 50, up to 60, up to 75, or more layers comprising a material (e.g., a composite comprising carbon fiber) having a tensile modulus of at least 120 GPa, at least 150 GPa, at least 200 GPa, at least 300 GPa, at least 500 GPa or greater, and a flexural modulus of at least 120 GPa at least 150 GPa, at least 200 GPa, at least 300 GPa, at least 500 GPa or greater at room temperature (25° C.). In some embodiments, the solid housing component comprises at least 1, at least 2, at least 3, at least 5, at least 10, at least 15, and/or up to 20, up to 25, up to 50, up to 60, up to 75, or more layers comprising a material (e.g., a composite comprising carbon fiber) having a tensile modulus of less than or equal to 650 GPa, less than or equal to 600 GPa, less than or equal to 550 GPa or less, and a flexural modulus of less than or equal to 650 GPa, less than or equal to 600 GPa, less than or equal to 550 GPa or less at room temperature (25° C.).

In some embodiments, a substantial portion of the housing comprises a material (e.g., a composite comprising carbon fiber) having a relatively high modulus. In some embodiments, a material having a flexural and/or tensile modulus of at least 120 GPa, at least 150 GPa, at least 200 GPa, at least 300 GPa, at least 500 GPa, and/or up to 550 GPa, up to 600 GPa, up to 650 GPa, or higher is present in the housing in an amount of at least 50 wt %, at least 75 wt %, at least 90 wt %, at least 95 wt %, or more. Some embodiments where the housing comprises a material having a relatively high modulus may be advantageous because they facilitate battery packs with a relatively small lateral profile, a relatively high volumetric energy density, and/or adequate resistance to deformation (e.g., upon application of force). In some embodiments where the housing comprises a solid plate and a solid housing component, each comprising a composite material having a relatively high modulus, such as a composite comprising carbon fiber, it can be beneficial to have some housing components with planarity parallel to a first plane and other housing components with planarity not parallel to that first plane. For example, in some embodiments it may be advantageous for a solid plate of the housing to have multiple layers of unidirectional carbon fiber having planarity parallel to a plane of the solid plate, as well as a solid housing component (e.g., a frame component spanning from the solid plate to a second end of the stack) having multiple layers of unidirectional carbon fiber with planarity nonparallel to (e.g., substantially perpendicular to) the plane of the solid plate.

While in some embodiments the solid housing component has a relatively high modulus, such a property is not necessary in all embodiments. In some embodiments, the solid housing component has a tensile strength sufficient to avoid observable deflection and/or failure when the housing applies the anisotropic force to the electrochemical cells. In some embodiments, the solid housing component has a tensile strength in at least one dimension of at least 10 MPa, at least 20 MPa, at least 50 MPa, at least 100 MPa, at least 200 MPa, at least 500 MPa, at least 1 GPa, at least 2 GPa, at least 5 GPa, and/or up to 10 GPa, up to 20 GPa, up to 50 GPa, up to 100 GPa, up to 120 GPa, or higher.

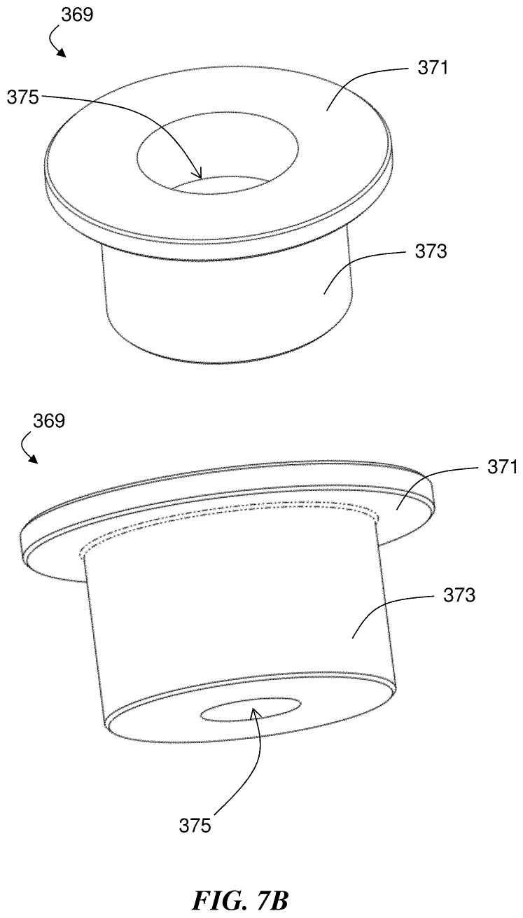

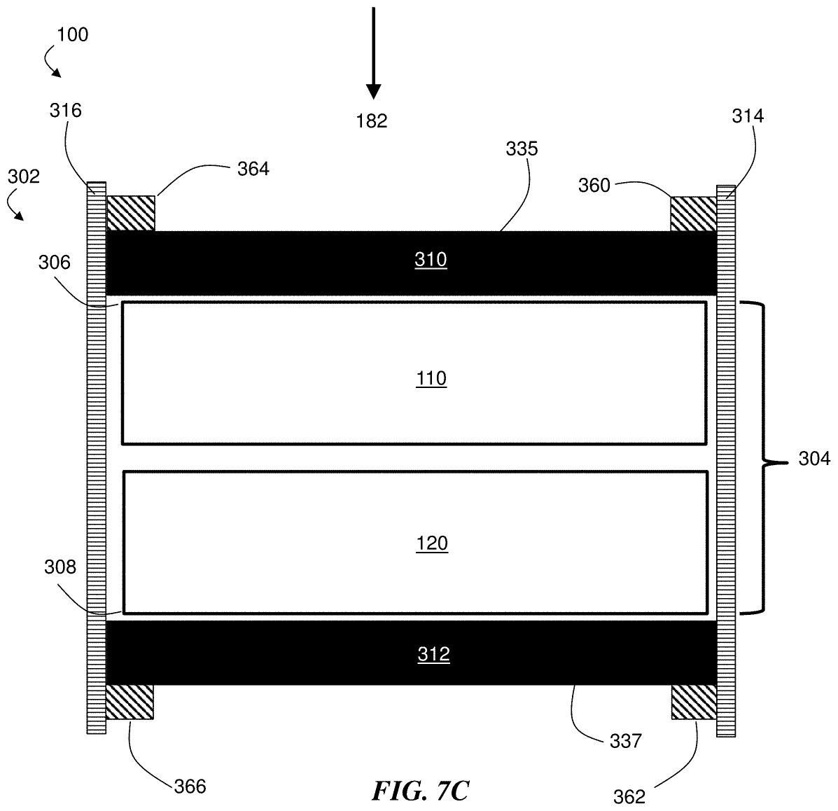

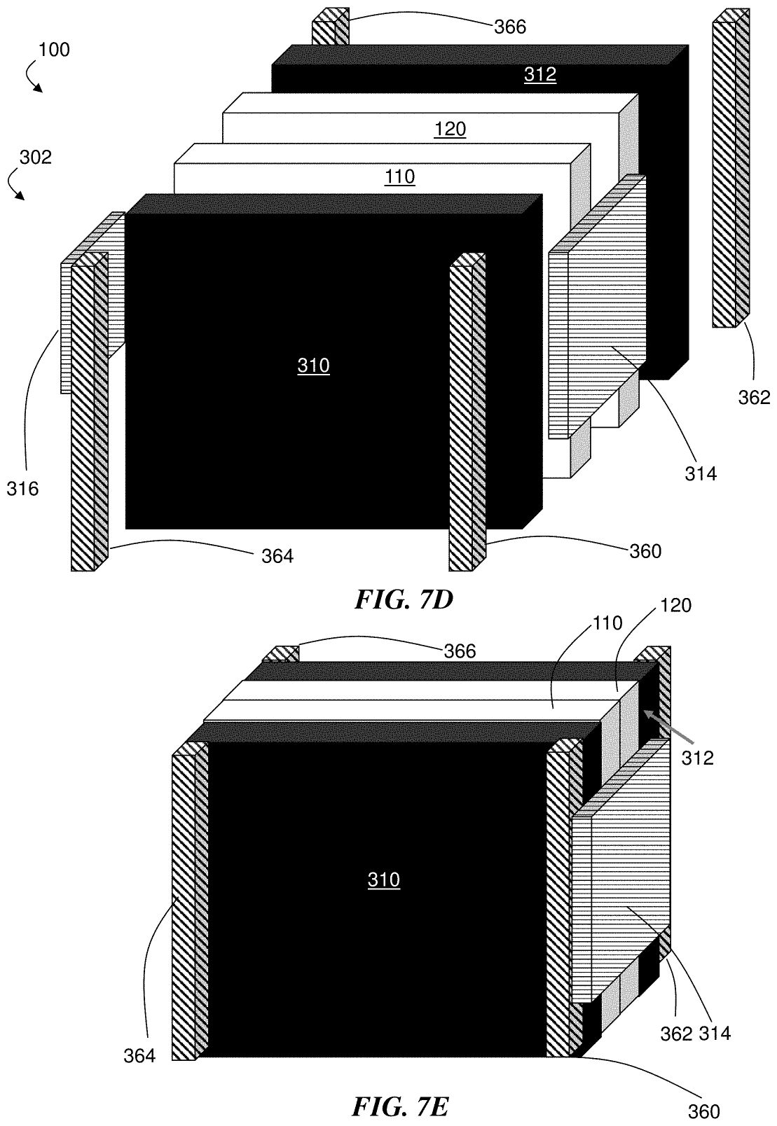

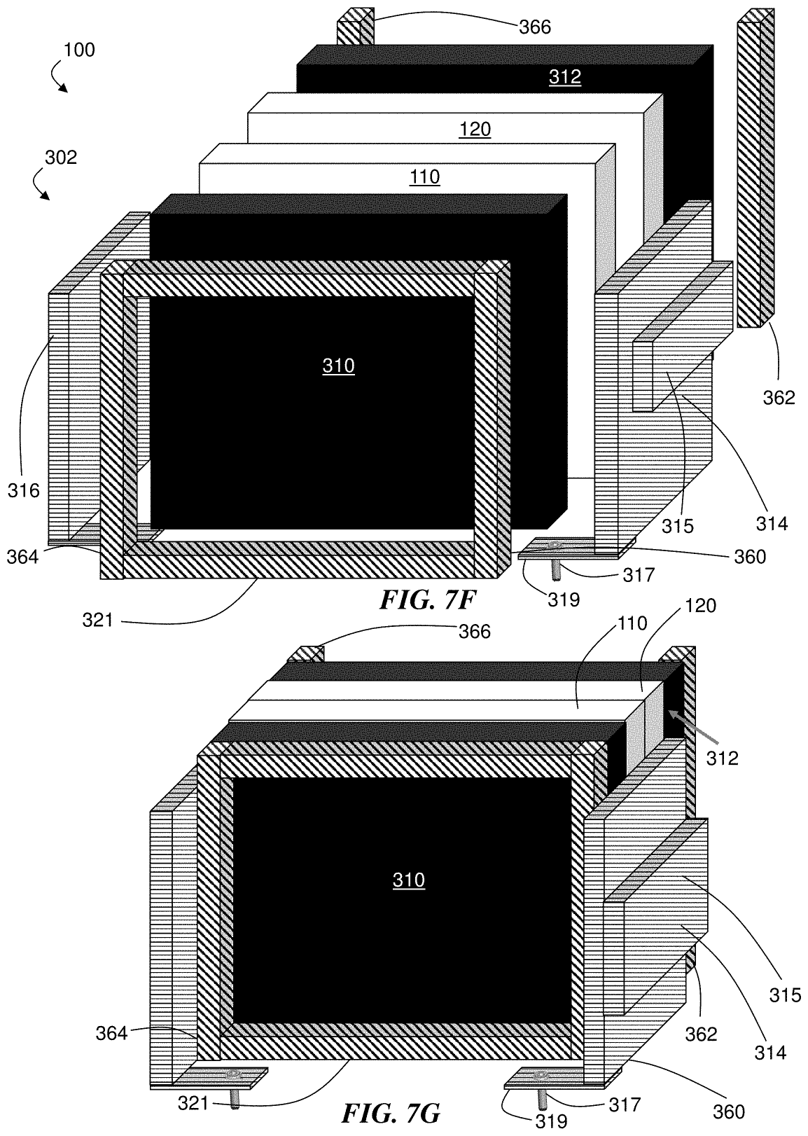

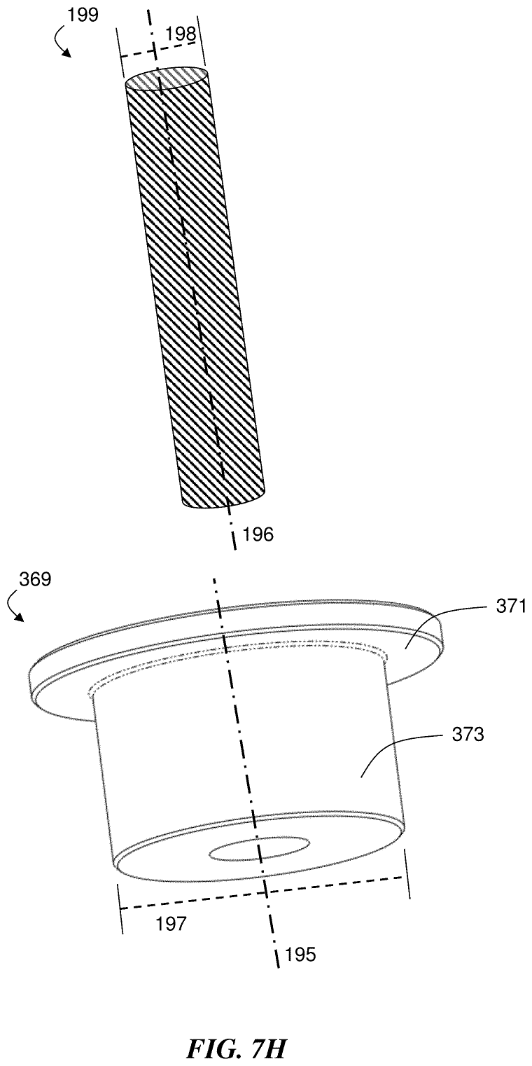

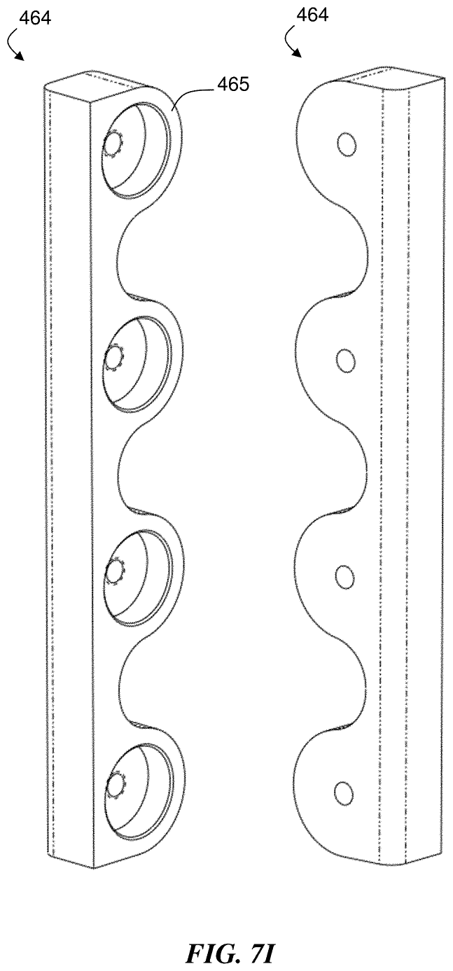

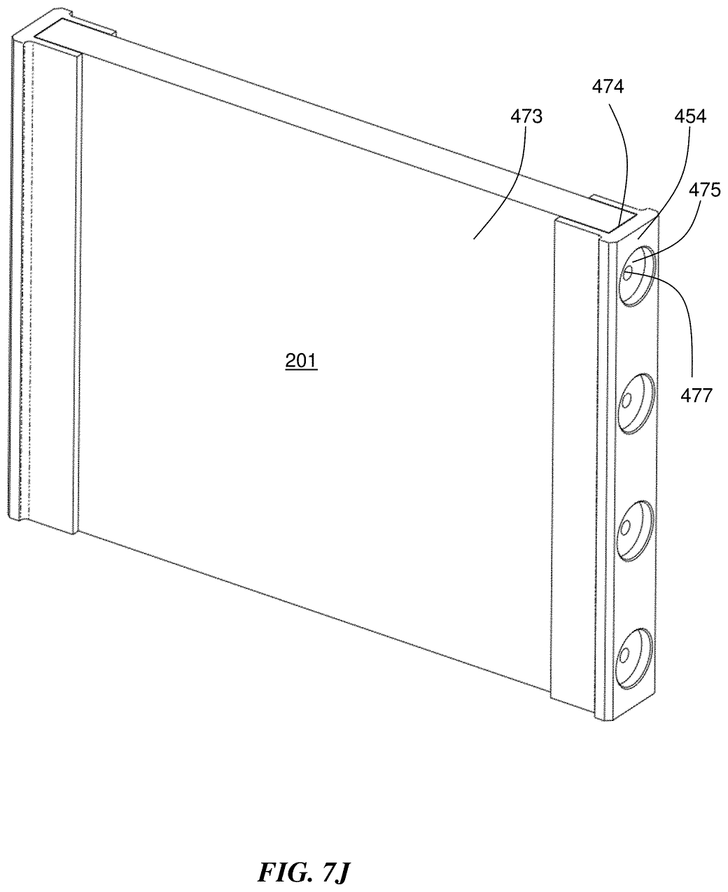

In some embodiments, components of the housing of the battery pack are reinforced by local increases in thickness and/or the attachment of mechanical doublers. In some embodiments, local increases in thickness and/or the attachment of mechanical doublers provide additional support for portions of the housing (e.g., solid housing components along a side of the stack) that are pressure-applying or are otherwise mechanically loaded under at least some configurations of the housing. In some embodiments, local increases in thickness and/or the attachment of mechanical doublers facilitate a reduction in the largest lateral pressure applying dimension of the housing and/or increase the gravimetric and/or volumetric energy density of the battery pack. A local increase in thickness or a mechanical doubler may have an area of less than 100%, less than or equal to 90%, less than or equal to 75%, less than or equal to 50%, less than or equal to 25%, less than or equal to 10%, less than or equal to 5%, or less of a corresponding solid housing component. Further, a thickness of the solid housing component at a local increase in thickness and/or a combined thickness of a solid housing component and a mechanical doubler may be greater than an average thickness of the solid housing component by a factor of greater than or equal to 1.05, greater than or equal to 1.1, greater than or equal to 1.25, greater than or equal to 1.5, greater than or equal to 2, and/or up to 3, up to 5, or greater. FIGS. 7D-7E introduce an exemplary embodiment of battery pack 100, where mechanical doubler 315 is attached to solid housing component 314. FIG. 7D presents an exploded perspective view schematic diagram of the battery pack, while FIG. 7E presents a perspective view schematic diagram of the battery pack. Note that while any feature appearing in FIGS. 7D-7E may appear in some embodiments, some embodiments can include fewer than all pictured features while still accomplishing any of a variety of the advantages and performances described above.

The solid housing component may have any of a variety of lengths while maintaining rigidity. In some embodiments, such a rigidity even at relatively long lengths (unlike traditional auxiliary fasteners) affords an ability for the ratio of the distance between a solid plate and the second end of the stack to the largest lateral dimension of the housing to be relatively large if desired. In turn, such a large ratio may allow for a relatively large number (e.g., at least 6, at least 12, at least 18, at least 24, at least 30, at least 36, or more) of electrochemical cells to be included in the stack of the battery pack. Such an ability for relatively long housing components spanning the stack stands in contrast to traditional auxiliary fasteners such as rods or bolts with nuts. Tension in long fasteners may produce bending moments that result in deleterious deflection. Solid housing components (e.g., comprising composites comprising carbon fiber) may not appreciably deflect under such tension. In some embodiments, the ratio of the distance between a solid plate and the second end of the stack to the largest lateral dimension of the battery pack is less than or equal to 20, less than or equal to 10, less than or equal to 5, less than or equal to 2, less than or equal to 1.5, less than or equal to 1, less than or equal to 0.5, less than or equal to 0.2, less than or equal to 0.1, or less. In some embodiments, the ratio of the distance between a solid plate and the second end of the stack to the largest lateral dimension of the battery pack is greater than or equal to 0.01, greater than or equal to 0.1, greater than or equal to 0.5, greater than or equal 1, greater than or equal to 2, greater than or equal to 5, or greater. Combinations of the above ranges are possible: for instance, in some embodiments, the ratio of the distance between a solid plate and the second end of the stack to the largest lateral dimension of the battery pack is greater than or equal to 0.01 and less than or equal to 20.

In some embodiments, housings with any given ratio of the distance between a solid plate and the second end of the stack to the largest lateral dimension of the housing can be reconfigured to have a new ratio of the distance between the solid plate and the second end of the stack to largest lateral dimension of the battery pack by modifying and/or adjusting one or more solid housing components of the housing. For a given collection of geometries, a variety of solid housing components for spanning along a side of the stack of the battery pack can be interchanged to accommodate a variety of ratios of the distance between a solid plate and the second end of the stack to the largest lateral pressure-applying dimension, in some embodiments. In some embodiments, the ability to reconfigure the length of the housing without the adjustment of auxiliary fasteners can facilitate a reduction in the largest lateral pressure applying dimension of the battery pack. In some embodiments, the ability to reconfigure the length of the housing in such a way advantageously reduces the number of parts of the housing.

In some embodiments, the housing comprises a lateral base portion proximate to and/or along a lateral edge of the solid plate. In some embodiments, the lateral base portion is part of the solid plate. However, in some embodiments, the lateral base portion is part of a solid housing component coupled to the solid plate. In some embodiments, battery packs can be mounted to an external surface using fasteners (e.g., auxiliary fasteners). In some embodiments, the lateral base portion is configured for mounting the battery pack to an external surface. For battery packs that lack a lateral base portion, additional portions of the solid plate may be required to mount the battery pack to an external surface, and these may increase the lateral profile of the battery pack. Therefore, inclusion of a lateral base portion may be advantageous for reducing the maximum lateral pressure-applying dimension of the housing and/or increasing the battery pack's volumetric energy density. For example, battery pack 100 in FIGS. 7D-7E includes lateral base portion 319 of housing 302, which may be mounted to an external surface via fasteners 317.

In some embodiments, a relatively large percentage of the stack of the battery pack is covered by the housing of the battery pack. This may, in some cases, be advantageous because it can afford substantial protection to the battery pack (e.g., from impact during handling and/or use). In some embodiments, the housing covers at least 30%, at least 50%, at least 70%, at least 90%, at least 95%, at least 99%, or 100% of an external surface area of the stack.

The solid housing component may couple to the solid plate of the housing in any of a variety of suitable ways. It has been realized that certain coupling techniques may establish coupling while maintaining relatively small lateral profiles for the housing. In some embodiments, mechanically interlocking features of the solid housing component and a lateral edge of the solid plate establish a joint. Any of a variety of suitable joints may be employed via the interlocking features. For example, any of a variety of woodworking joints may be suitable. It should be understood that woodworking joints refer to the geometries and balances of forces associated with the joints, and it is not required that any part of two components joined with a woodworking joint actually be made of wood. Examples of types of joints that may be established by interlocking features of the solid housing component and a lateral edge of the solid plate include, but are not limited to, box joints, dovetail joints, splice joints (e.g. tabled splice joints), and Knapp joints.

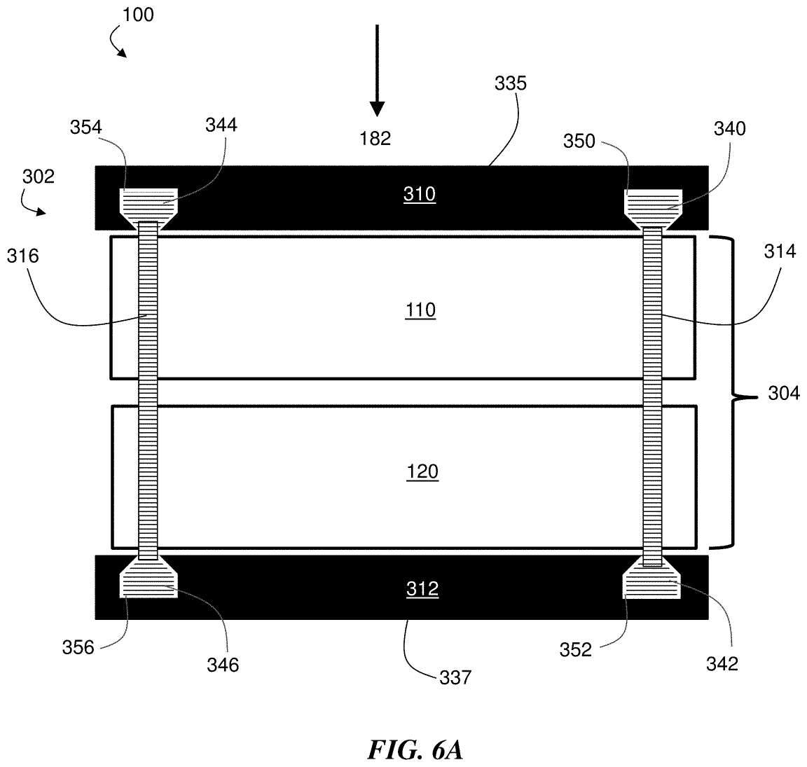

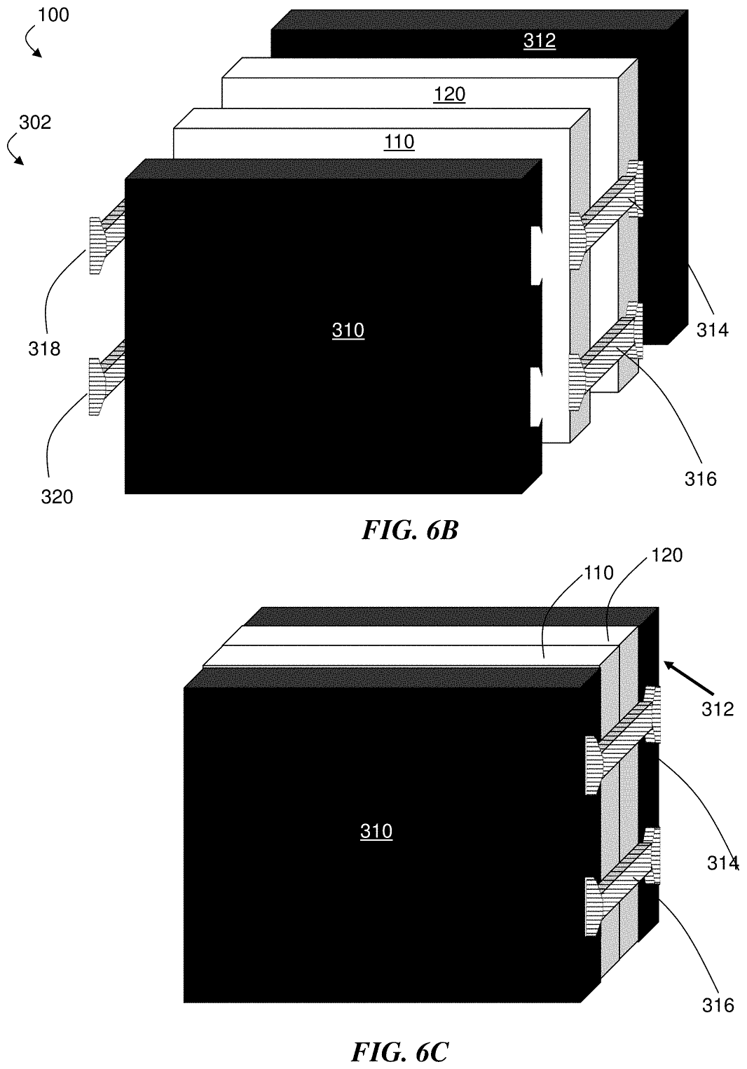

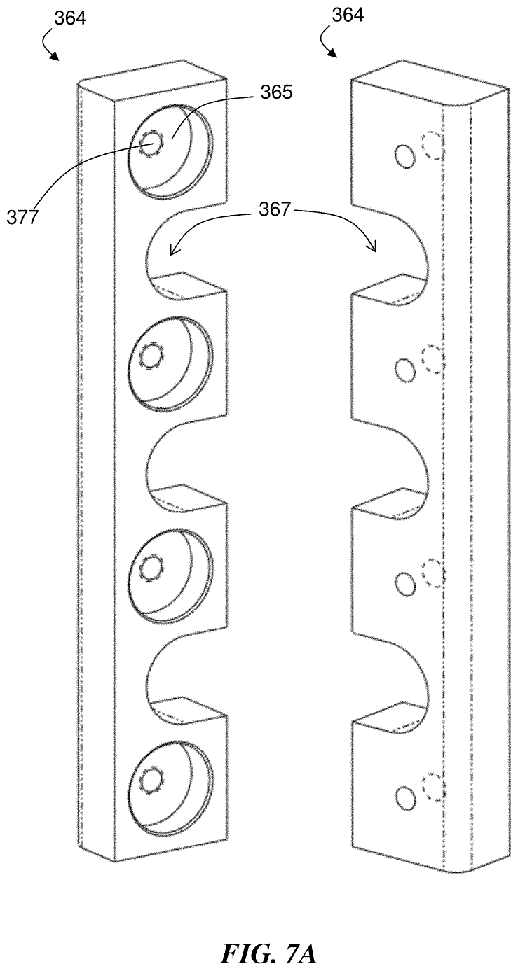

In some embodiments, a joint between the solid housing components and the solid plate of the housing is formed at least in part between a projection of the solid housing component (or solid plate) and a recess of the solid plate (or solid housing component). Some such embodiments may involve the solid housing comprising a projection, the solid plate comprising a recess, and the solid housing component and the solid plate being configured to form a joint at least in part via coupling of the projection and the recess. For example, referring to FIGS. 6A-6C, exemplary battery pack 100 may be configured such that first solid housing component 314 has first projection 340 and optional second projection 342, while optional second solid housing component 316 has third projection 344 and fourth projection 346. First projection 340 of first solid housing component 314 is configured to couple, at least in part, with first recess 350 of solid plate 310 to form a joint, while optional second projection 342 of first solid housing component 314 is configured to couple, at least in part, with optional second recess 352 of optional second solid plate 312 to form a joint. Third projection 344 of optional second solid housing component 316 is configured to couple, at least in part, with optional third recess 354 of solid plate 310 to form a joint, while the fourth projection 346 of optional second solid housing component 316 is configured to couple, at least in part, with optional fourth recess 356 of optional second solid plate 312 to form a joint. A housing of this type may, in some embodiments, decrease a largest lateral pressure-applying dimension of the housing relative to a housing comprising, for example, auxiliary fasteners coupling solid plates. Additionally, use of mechanically interlocking features (e.g., for woodworking joints) for coupling may require a lower part count than housings that employ auxiliary fasteners (e.g., nuts and bolts) for coupling. In some embodiments, the solid housing component and the solid plate are configured to be joined via a dovetail joint (e.g., via tapered projects and/or recesses in the solid housing component and solid plate). For example, the solid housing component may comprise male dovetail features at an end of the solid housing component, and the solid plate may comprise a female dovetail feature (e.g., proximate to a lateral edge of the solid plate). The male and female features may mate to form a joint.

FIG. 6A shows a side view schematic illustration of exemplary battery pack 100, where all recesses are identical and where all projections are identical, in accordance with some embodiments. FIG. 6B shows an exploded schematic illustration of exemplary battery pack 100 of this type, also revealing optional third solid housing component 318 and optional fourth solid housing component 320. FIG. 6C shows a perspective view schematic illustration of exemplary battery pack 100. It should be understood that other embodiments where projections differ from one another are also contemplated, as are embodiments with more or fewer solid housing components. In some embodiments, the solid housing component comprises recesses which can couple, at least in part, with projections of the solid plates to form joints. In some embodiments in which a solid housing component and a solid plate are coupled via interlocking mechanical features (e.g., via a woodworking joint), the solid housing component and the solid plate may further be coupled via, for example, an adhesive and/or a weld (e.g., at a joint formed by the interlocking features).

In some embodiments, the solid housing component is coupled to the solid plate via coupling to a housing stop portion adjacent to an exterior surface of the solid plate. The housing stop portion may be directly adjacent to the exterior surface of the solid plate (a surface of the plate facing away from the stack). However, in some embodiments, the housing stop portion is indirectly adjacent to the exterior surface of the solid plate such that one or more intervening components (e.g., washers, layers of material, etc.) is between the housing stop portion and the exterior surface of the solid plate. The housing stop portion may be discrete from the solid housing component and/or the solid plate. The housing stop portion may be made of any of a variety of materials, such as a metal (e.g., aluminum or titanium), a metal alloy (e.g., stainless steel), a composite (e.g., carbon fiber), a polymeric material (e.g., a rigid plastic), or a combination thereof. The housing stop portion may have any of a variety of shapes depending on, for example, a desired deflection of the solid plate and/or pressure distribution within the battery pack. It has been realized that some shapes of housing stop portions (e.g., elongated bars, or rings (e.g., rectangular or non-rectangular rings) conforming to a perimeter of the solid plate) can distribute force (e.g., from tension in the solid housing component) across the face of the solid plate more uniformly than, for example, solid plates coupled via discrete auxiliary fasteners (e.g., bolts with nuts) in contact with relatively small areas of the solid plate.

The stop portion may have any of a variety of configurations. FIG. 7A shows two perspective view schematic illustrations of stop portion 364 according to some embodiments. The embodiment of stop portion 364 shown in FIG. 7A comprises recesses 365 and spaces 367. Recesses 365 may be shaped to receive cylindrical inserts (e.g., inserts passed through holes of the solid housing component, according to some embodiments). Spaces 367 may allow for stop portion 364 to have a relatively low mass for its overall geometric dimensions, which may be useful in some instances where relatively high specific energy density of the battery pack is desired. In some embodiments, the housing stop portion includes rounded edges. Rounded edges may facilitate the stop portion having less mass than comparable stop portions having squared edges, such as in FIG. 7A. For example, FIG. 7I shows two perspective view schematic illustrations of housing stop portion 464 comprising rounded edges 465, according to some embodiments.

In some embodiments, the solid housing component is coupled to the solid plate at least partially via coupling of an insert to a housing stop portion adjacent to an exterior surface of the solid plate. As mentioned above, in some embodiments, the stop portion is coupled to the solid housing component at least in part via an insert. The insert may have a shape complementary to a recess of the stop portion. FIG. 7B shows two perspective view illustrations of insert 369, in accordance with some embodiments. The insert may comprise a head and a body. The head and/or the body may be circular, though other shapes are possible. Referring again to FIG. 7B, insert 369 has head 371 and body 373, according to some embodiments. In some embodiments, the insert has a body that can pass through the solid housing component and enters a complementary recess of the housing stop portion adjacent to a first side of the solid housing component. In some embodiments, the insert has a head (e.g., a flange) adjacent to a second side of the solid housing component opposite the first side of the solid housing component. In some embodiments, a stop portion is coupled to a solid housing component by placing the stop portion on a first side of the solid housing component and the insert on a second, opposite side of the solid housing component such that the body of the insert passes through a hole in the solid housing component and enters a complementary recess of the stop portion, with the head of the insert adjacent to the second side of the solid housing component. For example, in some embodiments, stop portion 364 as shown in FIG. 7A is coupled to frame 490 as shown in FIG. 4B at least partially via insert 369 as shown in FIG. 7B by passing body 373 of insert 369 through hole 494 from an exterior of frame 490 such that it enters recess 365 of stop portion 364 located in the interior of frame 490, resulting in head 371 of insert 369 being adjacent to an exterior surface of frame 490. The stop portion may be coupled to the insert via a fastener. For example, a fastener may pass through space 377 of stop portion 364 and space 375 of insert 369 to couple stop portion 364 to insert 369. It has been observed in the context of this disclosure that coupling the stop portion to the solid housing component (e.g., part of a frame of a housing) at least partially via an insert can result in greater durability for the solid housing component when under tension (e.g., during application of anisotropic force to electrochemical cells by the housing) compared to certain other configurations. For example, it has been observed that coupling the stop portion to the solid housing component solely via a conventional fastener (e.g., a screw or bolt) can concentrate stress on the solid housing component when under tension, even in instances where the solid housing component (e.g., frame) is made of relatively strong materials such as carbon fiber composites. Such concentrated stress may result in mechanical failure of the solid housing component. By contrast, it has been observed that an insert as described herein (e.g., an insert with a head and broad cylindrical body) can better distribute stress within the solid housing component when under tension (e.g., due to the body having a relatively wide diameter as compared to typical fasteners). Such better distributed stress can mitigate or even avoid mechanical failure of the solid housing components when under stress. The body of the insert and the fastener may each have a “through-axis” that at least partially passes through the solid housing component when the battery pack is assembled. Further, the body of the insert and the fastener may each have a largest cross-sectional dimension perpendicular to its corresponding through-axis. In this context, the largest cross-sectional dimension of the body or the fastener refers to portions of each that pass through the solid housing component and not other portions of the body or fastener such as flanges. For example, referring to FIG. 7H, insert 369 may have through-axis 195 that at least partially passes through the solid housing component when the battery pack is assembled, and fastener 199 may have through-axis 196 that at least partially passes through the solid housing component when the battery pack is assembled, according to some embodiments. Therefore, as shown in FIG. 7H, body 373 of insert 369 may have largest cross-sectional dimension 197 perpendicular to through-axis 195, and fastener 199 may have largest cross-sectional dimension 198 perpendicular to through-axis 196. In some embodiments, the ratio of the largest cross-sectional dimension of the body of the insert perpendicular to the through-axis of the body to the largest cross-sectional dimension of the fastener perpendicular to the through-axis of the fastener is relatively large, which can in some instances allow for the body of the insert to better distribute stress within the solid housing component than if the fastener were used in the absence of the insert. In some embodiments, the ratio of the largest cross-sectional dimension of the body of the insert perpendicular to the through-axis of the body to the largest cross-sectional dimension of the fastener perpendicular to the through-axis of the fastener is greater than or equal to 1.5, greater than or equal to 2, greater than or equal to 5, and/or up to 10, up to 20, or greater.

In some embodiments in which the solid housing component is coupled to the solid plate at least partially via coupling of an insert to a housing stop portion adjacent (e.g., directly adjacent) to an exterior surface of the solid plate, the housing stop portion is also adjacent (e.g., directly adjacent) to at least one other surface of the solid plate. The other surface may be, for example, a lateral edge surface. As one example, in some embodiments, the housing stop portion is in the form of a bracket. The bracket may couple to an edge of the solid plate that is proximal to the solid housing component to which the solid plate is coupled. As a result, the bracket may be adjacent to both the exterior surface of the solid plate (with respect to the housing) and the lateral edge surface of the solid plate proximal to the solid housing component. FIG. 7J shows a perspective view schematic illustration of one such embodiment, where housing stop portion 454 is a bracket adjacent to both exterior surface 473 of solid plate 201 and lateral edge surface 474 of solid plate 201. In some embodiments, the housing stop portion is adjacent to the exterior surface of the solid plate, and also adjacent to an interior surface of the solid plate (opposite the exterior surface). In some embodiments, the housing stop portion is adjacent to at least three surfaces of the solid plate. For example, the housing stop portion may be adjacent to the exterior surface of the solid plate, a lateral edge surface of the solid plate, and an interior surface of the solid plate (opposite the exterior surface). In the embodiment shown in FIG. 7J, for example, housing stop portion 454 is a bracket adjacent to each of exterior surface 473 of solid plate 201, lateral edge surface 474 of solid plate 201, and an interior surface of 201 opposite exterior surface 473.

In some embodiments where the housing stop portion comprises recesses complementary to the inserts, the recesses are located on a region of the housing stop portion adjacent to the lateral edge surface of the solid plate. FIG. 7J shows one such embodiment, where recesses 475 are located along a region of housing stop portion 454 adjacent to lateral edge surface 474 of solid plate 201. Such an arrangement of the recesses and the housing stop portion may reduce an amount of the housing stop portion located adjacent to the exterior surface of the solid plate. Such a reduction may in turn reduce an overall length of the housing for a given stack length in the battery, which can be advantageous in some instances where a relatively low dimensional profile of the battery is desired.

For some embodiments in which the housing stop portion is adjacent to multiple sides of the solid plate (e.g., as in FIG. 7J), the coupling of a solid housing component to the solid plate via a housing stop portion and/or inserts can be accomplished in a similar manner to that described above for the other housing stop portion embodiments such as that shown in FIG. 7A, and can use the same inserts such as inserts 369 shown in FIGS. 7B and 7H. For example, in some embodiments, housing stop portion 454 as shown in FIG. 7J is coupled to frame 490 in FIG. 4B at least partially via insert 369 as shown in FIG. 7B by passing body 373 of insert 369 through hole 494 from an exterior of frame 490 such that it enters recess 475 of housing stop portion 454 located in the interior of frame 490, resulting in head 371 of insert 369 being adjacent to an exterior surface of frame 490. A fastener may pass through space 477 of housing stop portion 364 and space 375 of insert 369 to couple housing stop portion 454 to insert 369.

Referring to FIGS. 7C-7E, exemplary battery pack 100 may be configured such that first solid housing component 314 is coupled to first solid plate 310 via coupling of the first solid housing component 314 to first housing stop portion 360 adjacent to exterior surface 335 of first solid plate 310. Optionally, in some embodiments first solid housing component 314 is coupled to optional second solid plate 312 via coupling of first solid housing component 314 to optional second housing stop portion 362 adjacent to exterior surface 337 of optional second solid plate 312. Optionally, exemplary battery pack 100 may further be configured as illustrated in FIGS. 7C-7E, such that optional second solid housing component 316 is coupled to first solid plate 310 via coupling of optional second solid housing component 316 to third housing stop portion 364 adjacent to exterior surface 335 of first solid plate 310, as well as to optional second solid plate 312 via coupling of first solid housing component 314 to optional fourth housing stop portion 366 adjacent to exterior surface 337 of optional second plate 312. The couplings between exemplary housing stop portions and exemplary solid housing components may comprise, for example, welds, fasteners, adhesives, or combinations thereof. A housing of this type may, in some embodiments, decrease a largest lateral pressure-applying dimension of the housing relative to a housing comprising, for example, fasteners coupling solid plates.

FIG. 7C shows a front view schematic illustration of exemplary battery pack 100 in one embodiment, where all housing stop portions are identical. FIG. 7D shows an exploded perspective view of the same exemplary battery pack 100, and FIG. 7E shows a perspective view illustration of the same exemplary battery pack 100. It should be understood that other embodiments, where housing stop portions have different geometries from each other, are possible, as are embodiments with more or fewer solid housing components and/or housing stop portions. In some embodiments, stop portions are discrete, as illustrated by FIGS. 7C-7E. However, in some embodiments, stop portions are portions of a single unitary object connected to multiple solid housing components (e.g., a first solid housing component and a second solid housing component). For example, FIGS. 7F-7G illustrate an embodiment where stop portion 360 and stop portion 364 are portions of single unitary object 321. The geometry of the stop portion may be configured to apply force to and/or support a relatively large area of the solid plate, in contrast to auxiliary fasteners (e.g., a bolt and nut), which may apply pressure in a fairly localized region. In some embodiments, at least 50%, at least 60%, at least 75%, at least 90%, at least 95%, at least 99%, or 100% of a perimeter of an exterior surface of a solid plate is covered by (e.g., adjacent to) one or more housing stop portions.

The solid housing component may be coupled to the housing stop portion via any of a variety of suitable techniques. For example, the solid housing component may be coupled to the housing stop portion via a weld, a fastener, an adhesive, or a combination thereof. As mentioned above, the coupling of the housing stop portion to the solid housing component may be at least partially via an insert.

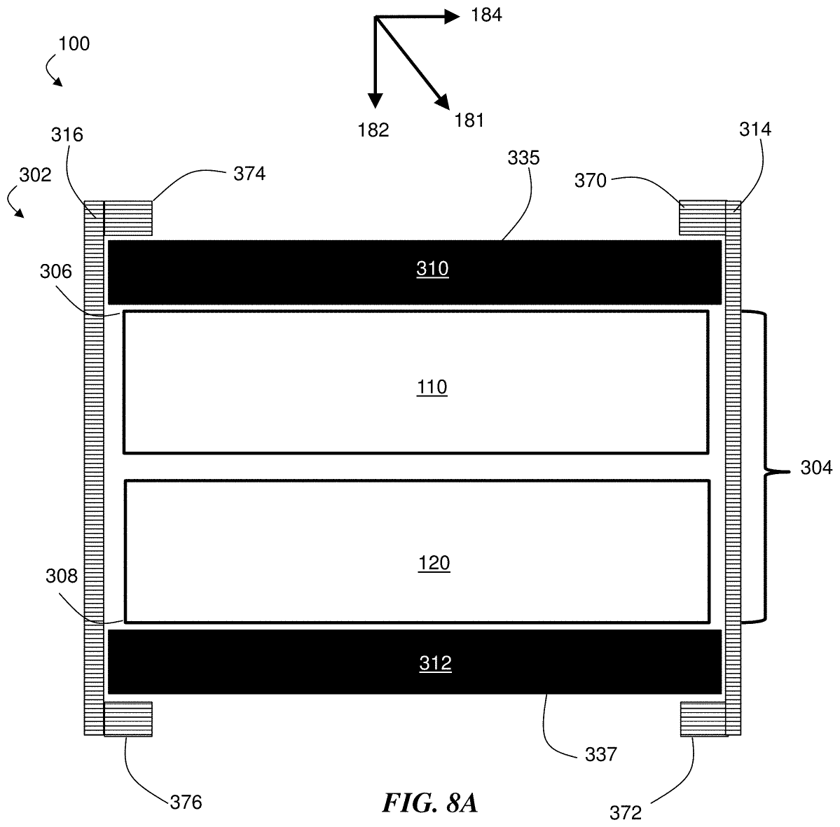

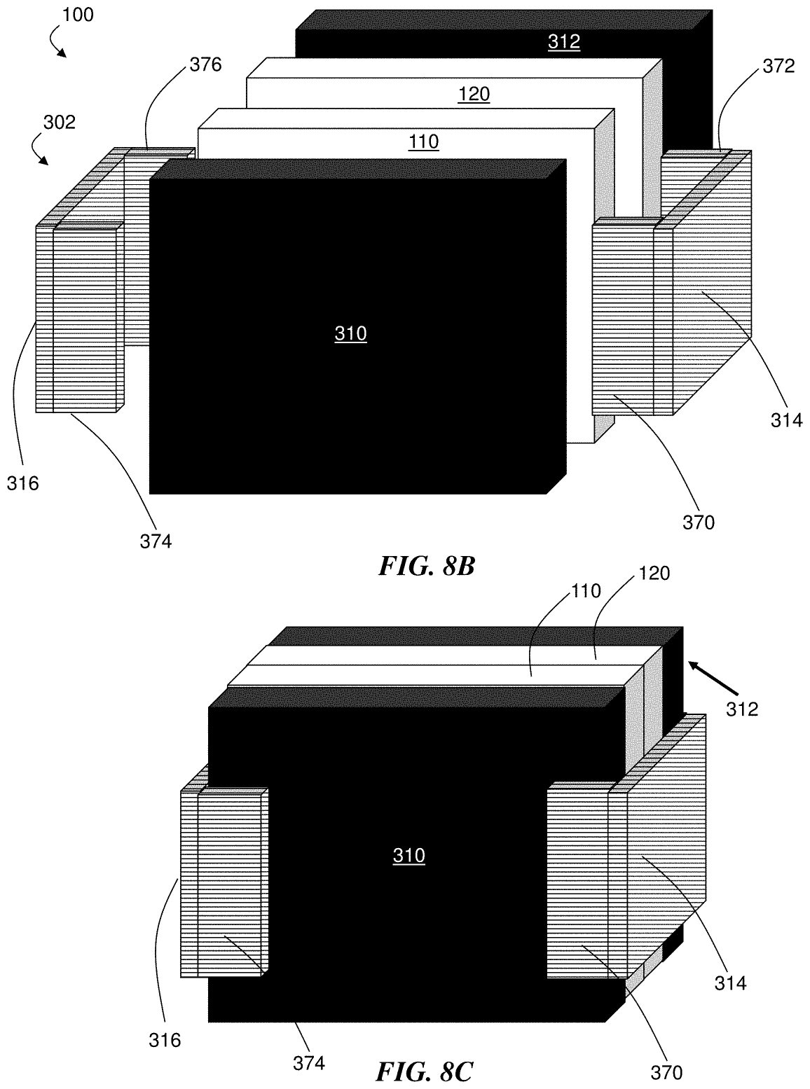

In some embodiments, the solid housing component is coupled to the solid plate via a lateral portion of the solid housing component adjacent to an exterior surface of the solid plate. A lateral portion of the solid housing component refers to one which can be substantially parallel to a lateral surface of the solid plate when the solid housing component and the solid plate are coupled in the housing of the battery pack. For example, referring to FIGS. 8A-8C, exemplary battery pack 100 may be configured such that first solid housing component 314 is coupled to first solid plate 310 via first lateral portion 370 of first solid housing component 314 adjacent to exterior surface 335 of first solid plate 310. In FIG. 8A, first lateral portion 370 is substantially parallel to exterior surface 335 of solid plate 310, in accordance with some embodiments. Optionally, in some embodiments first solid housing component 314 is coupled to optional second solid plate 312 via second lateral portion 372 of optional second solid housing component 316 adjacent to exterior surface 337 of optional second solid plate 312. In some embodiments, the exemplary battery pack may further be configured as illustrated in FIGS. 8A-8C, such that optional second solid housing component 316 is coupled to first solid plate 310 via third lateral portion 374 of optional second solid housing component 316 adjacent to exterior surface 335 of first solid plate 310, and such that optional second solid housing component 316 is coupled to optional second solid plate 312 via fourth lateral portion 376 of optional second solid housing component 316 adjacent to exterior surface 337 of optional second solid plate 312. When the solid housing component coupled to the solid plate is in tension, the lateral portion of the solid plate may apply a force to at least a portion of the solid plate. For example, in FIGS. 8A-8C, tension in first solid housing component 304 may cause lateral portion 370 to press against exterior surface 335 of solid plate 310, thereby causing stack 304 to experience an anisotropic compressive force having a component in the direction of arrow 182 in FIG. 8A).

The lateral portion of the solid housing component may have any of a variety of shapes depending on, for example, a desired deflection of the solid plate and/or pressure distribution within the battery pack. It has been realized that some shapes of lateral portions (e.g., relatively flat portions) can distribute force (e.g., from tension in the solid housing component) across the face of the solid plate more uniformly than, for example, solid plates coupled via discrete auxiliary fasteners (e.g., bolts with nuts) in contact with relatively small areas of the solid plate. A housing of this type may, in some embodiments, decrease a largest lateral pressure-applying dimension of the housing relative to a housing comprising, for example, auxiliary fasteners coupling solid plates.

FIG. 8A shows a front view schematic illustration of exemplary battery pack 100 in one embodiment, where all the lateral portions are identical. FIG. 8B shows an exploded schematic illustration of the same exemplary battery pack 100, and FIG. 8C shows a perspective view schematic illustration of the same exemplary battery pack 100. It should be understood that other embodiments, where lateral portions have different geometries from each other, are possible, as are embodiments with more or fewer solid housing components and/or lateral portions of solid housing components.

The lateral portion of the solid housing component may be directly adjacent to the exterior surface of the solid plate (a surface of the plate facing away from the stack). However, in some embodiments, the lateral portion is indirectly adjacent to the exterior surface of the solid plate such that one or more intervening components (e.g., washers, layers of material, etc.) is between the lateral portion of the solid housing component and the exterior surface of the solid plate. In some embodiments, the lateral portion of the solid housing component and a remainder of the solid housing component form a unitary object.

In some embodiments, the battery pack further comprises a contoured solid article portion between a lateral exterior surface of the first electrochemical cell and a portion of the housing. The contoured solid article portion may comprise a surface adjacent (e.g., directly adjacent or indirectly adjacent) to the lateral exterior surface of the first electrochemical cell that is convex with respect to the lateral exterior surface in the absence of an applied force. In some embodiments, under at least one magnitude of applied force, the surface of the contoured solid article portion becomes less convex. Further description of contoured surfaces and related devices and methods is provided in International Patent Application Publication No. WO2020/257414, filed as International Patent Application No. PCT/US2020/038375 on Jun. 18, 2020, and entitled “METHODS, SYSTEMS, AND DEVICES FOR APPLYING FORCES TO ELECTROCHEMICAL DEVICES” and U.S. patent application Ser. No. 16/952,177, filed Nov. 19, 2020, and entitled “BATTERIES, AND ASSOCIATED SYSTEMS AND METHODS,” each which is incorporated herein by reference in its entirety for all purposes.

In some embodiments, the battery pack is a single battery having only a single pair of terminals (a positive terminal and a negative terminal) electronically coupled to the electrochemical cells of the battery. However, in some embodiments, the battery pack comprises multiple batteries at least partially enclosed by the housing. For example, the battery pack may comprise a first battery having a first electrochemical cell and a second battery having a second electrochemical cell, where both the first electrochemical cell and the second electrochemical cell are at least partially enclosed by a same housing of the battery pack. Each of the multiple batteries may operate as an independent battery by having its own pair of terminals (a positive terminal and a negative terminal) electronically coupled to the electrochemical cells of that battery within the battery pack. Further, in some embodiments, the same housing is configured to apply an anisotropic force having a component normal to an electrode active surface of the first electrochemical cell of the first battery and/or an electrode active surface of the second electrochemical cell of the second battery (e.g., during a least a portion of a discharging and/or charging process). It has been realized that applications of battery-powered electricity may require different batteries with different battery parameters (e.g., voltages, currents, charge/discharge rates) for different aspects of the application. However, it has further been realized in the context of this disclosure that efficiencies in space utilization and ease of incorporation into devices can be realized if multiple different batteries (e.g., with different battery parameters) are present in a single battery pack instead of in separate battery packs. For example, having multiple batteries within the same housing of a battery pack can allow for simultaneous application of force to the electrochemical cells of each of the multiple batteries rather than supplying force-applicating apparatuses for each battery separately. There is no practical limit to the number of batteries (e.g., battery modules) the battery pack may comprise at least partially enclosed by the housing. In some embodiments, the battery pack comprises at least 2, at least 3, at least 4, at least 5, and/or up to 10 batteries or more at least partially enclosed by the housing.

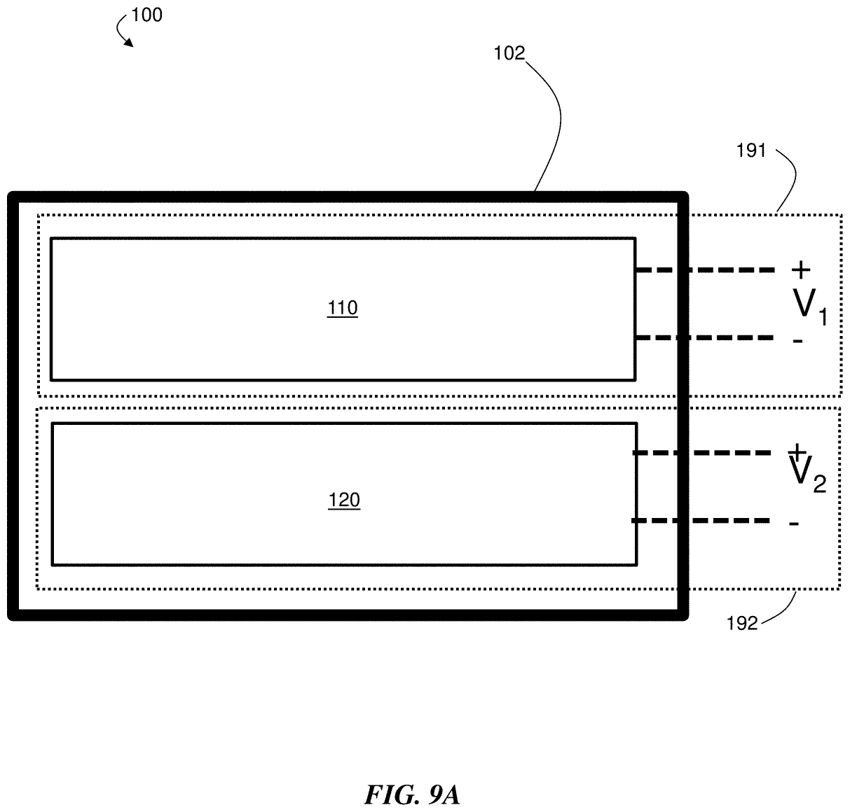

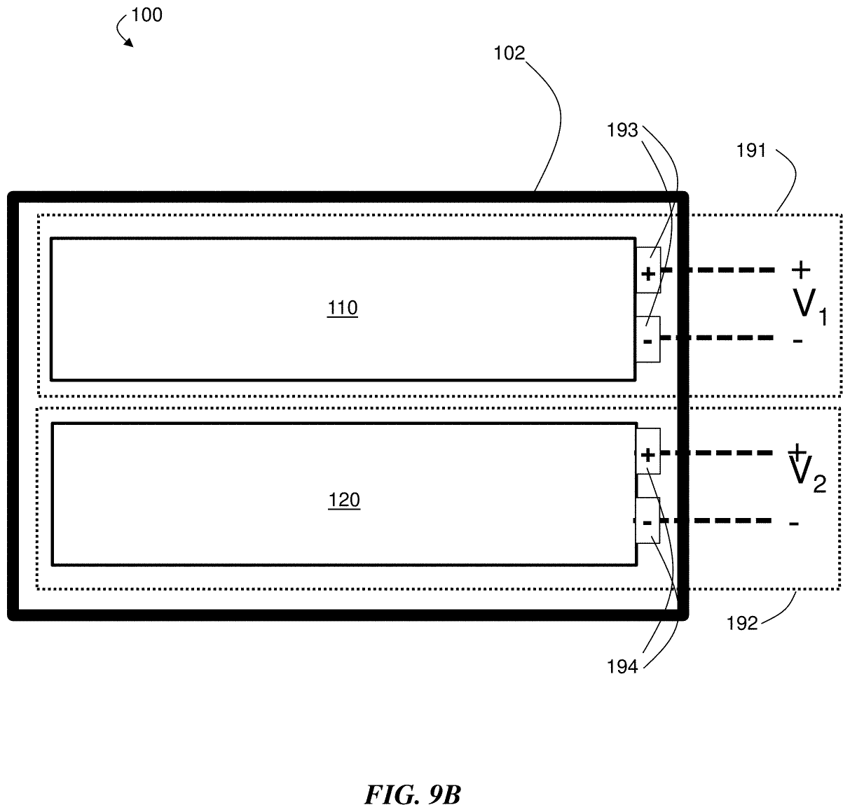

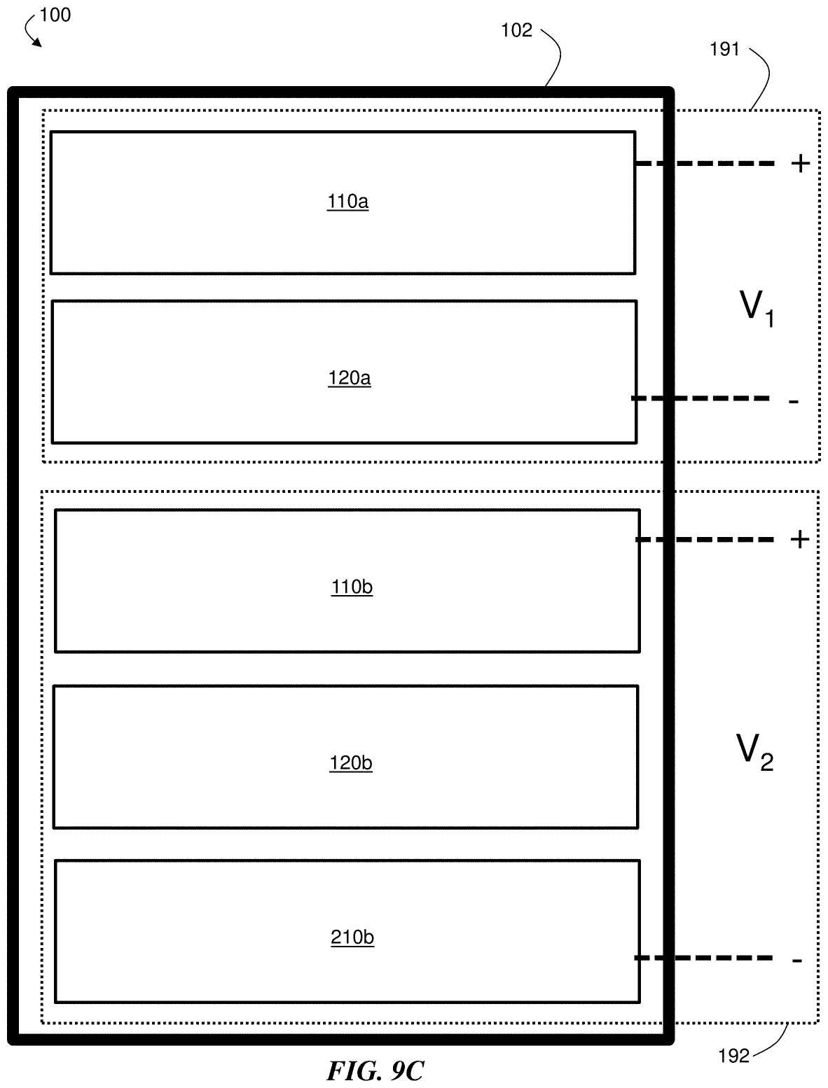

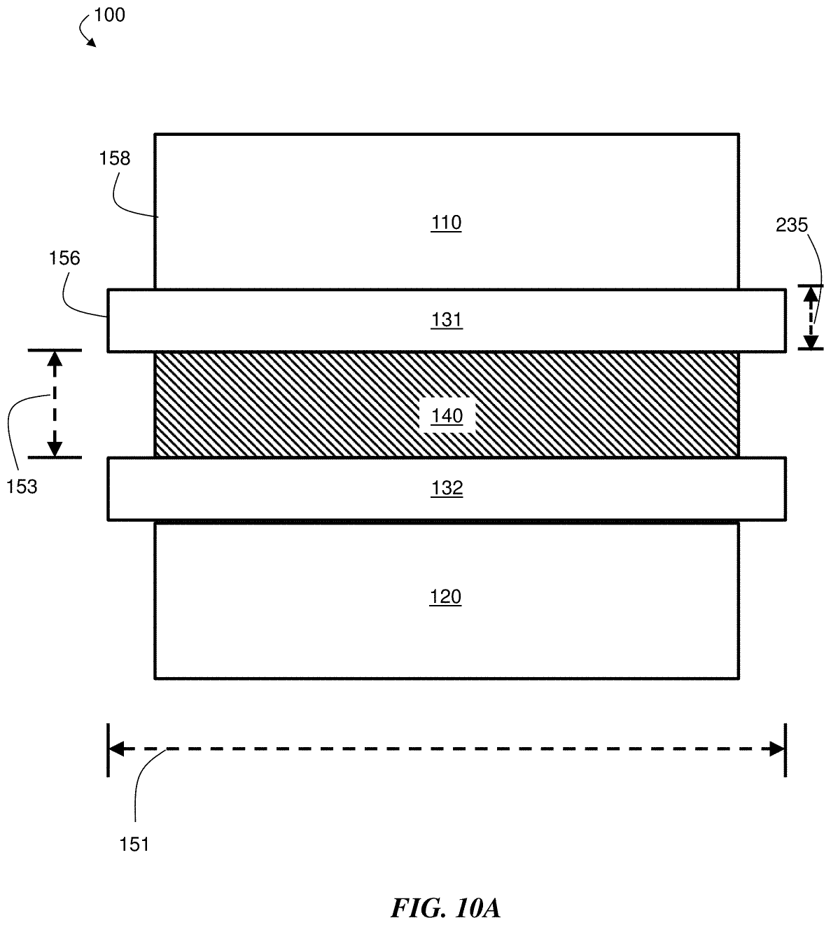

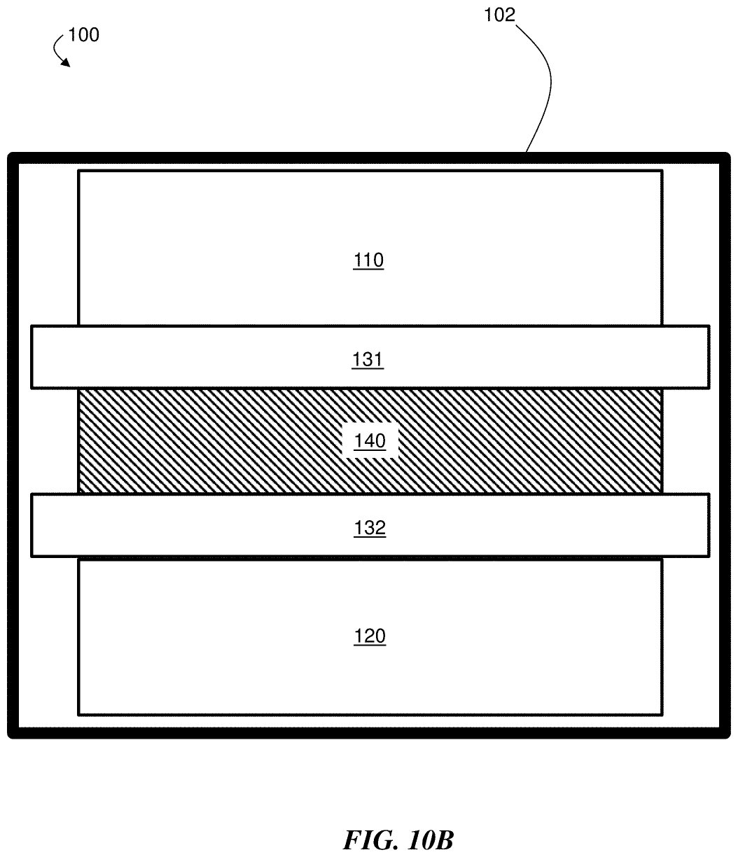

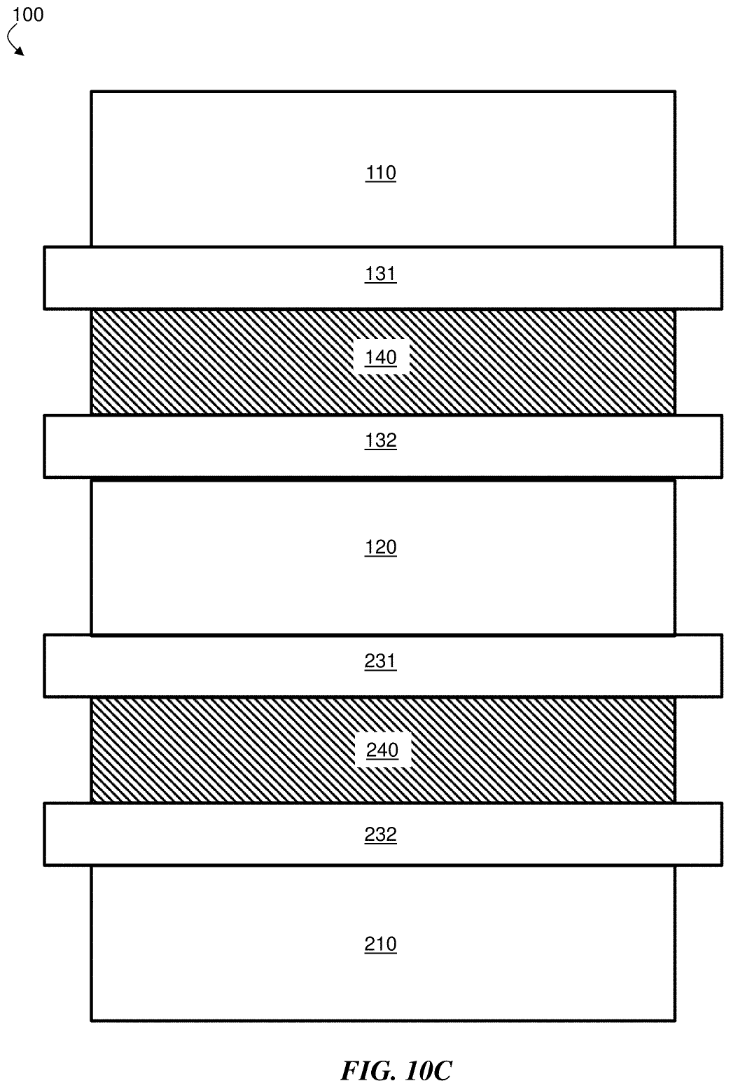

As an illustrative example, FIG. 9A shows battery pack 100 comprising housing 102 at least partially enclosing first battery 191 comprising first electrochemical cell 110 and also at least partially enclosing second battery 192 comprising second electrochemical cell 120. The different batteries of the battery pack may be electronically isolated from each other such that electronic current cannot pass from one battery to another of the battery pack. The different batteries of the battery pack may each have their own respective positive and negative terminals and may be part of different electrical circuits (e.g., when the batteries are electronically coupled to loads when incorporated into an end-use application). Referring again to FIG. 9A, first battery 191 of battery pack 100 may be configured to be part of a first circuit with a load and a voltage V₁, and second battery 192 of battery pack 100 may be configured to be part of a second circuit with a load and a voltage V₂. As mentioned above, the batteries may each have a corresponding pair of terminals. For example, the battery pack may comprise a first battery comprising a first electrochemical cell and a first pair of terminals electronically coupled to the first electrochemical cell, and a second battery comprising a second electrochemical cell and a second pair of terminals electronically coupled to the second electrochemical cell. FIG. 9B shows first battery 191 comprising first pair 193 of terminals electronically coupled to first electrochemical cell 110 and second battery 192 comprising second pair 194 of terminals electronically coupled to second electrochemical cell 120, according to some embodiments. The different batteries of the battery pack may be charged and/or discharged independently. In some instances, a first battery of the battery pack is configured to charge and/or discharge at different rates than does a second battery of the battery pack. In some instances, a first battery of the battery pack is configured to charge and/or discharge at the same rates as does a second battery of the battery pack.

In some embodiments the battery pack comprises multiple different batteries as multiple different battery modules, each battery module comprising multiple electrochemical cells. The battery modules may be at least partially enclosed by the housing of the battery pack. For example, in some embodiments in which a battery pack comprises a stack of electrochemical cells (e.g., at least partially enclosed by a housing), a first battery of the battery pack comprises a first battery module comprising a subset of the electrochemical cells and a second battery of the battery pack comprises a second battery module comprising a, different subset of the electrochemical cells. Each of the multiple battery modules may operate as an independent battery by having its own pair of terminals (a positive terminal and a negative terminal) electronically coupled to the electrochemical cells of that battery module. Referring to FIG. 9C as an illustrative example, battery pack 100 may comprise housing 102 at least partially enclosing first battery module 191 comprising first electrochemical cell 110a and second electrochemical cell 120a. Battery pack 100 may further comprise second battery module 192 comprising first electrochemical cell 110b, second electrochemical cell 120b, and third electrochemical cell 210b, in accordance with some embodiments. In FIG. 9C, first battery module 191 (which may have a first pair of terminals not shown) of battery pack 100 may be configured to be part of a first circuit with a load and voltage V₁, and second battery module 192 (which may have a second pair of terminals not shown) of battery pack 100 may be configured to be part of a second circuit with a load and voltage V₂. In some embodiments, some or all of the multiple electrochemical cells of a battery module within the battery pack are electronically coupled to an electrical circuit in series. In some embodiments, some or all of the multiple electrochemical cells of a battery module within the battery pack are electronically coupled to an electrical circuit in parallel. In some embodiments, some of the multiple electrochemical cells of a battery module within the battery pack are electronically coupled to an electrical circuit in series and some of the multiple electrochemical cells of a battery module within the battery pack are electronically coupled to an electrical circuit in parallel.

In some embodiments, the first battery is configured to be part of a circuit having a first voltage, and the second battery is configured to be part of a circuit having a second, different voltage.

In some embodiments, a first battery module of the battery pack has a different number of electrochemical cells than does a second battery module of the battery pack. Having different numbers of electrochemical cells (which may each be a same type of electrochemical cell) for different batteries may provide for batteries modules with different battery parameters. For example, a voltage of a battery may depend at least in part on a number of electrochemical cells electronically coupled to a circuit in series. Therefore, different battery modules of the battery pack having different numbers of electrochemical cells in series will have different battery voltages. Such a battery pack configuration may be useful in instances where it is desirable for a single battery pack to power different components with different voltage requirements without requiring reconfiguration of the battery pack. As an illustrative example, in FIG. 9C, if each of electrochemical cell 110a, 120a, 110b, 120b, and 210b have the same cell voltage, then voltage V₂ of second battery module 192 will be 50% greater than voltage V₁ of first battery module 191 if electrochemical cells 110a and 120a are electronically coupled in series within first battery module 191 and electrochemical cells 110b, 120b, and 210b are electronically coupled in series within second battery module 192.

It should be understood that while each electrochemical cell of each battery (e.g., battery module) of the battery pack may be a same type of electrochemical cell having a same battery chemistry (e.g., same anode active material and same cathode active material), other embodiments are possible. For example, at least some of the electrochemical cells of a first battery module of the battery pack may have a different battery chemistry (e.g., a different anode active material and/or a different cathode active material) than at least some of the electrochemical cells of a second battery module of the battery pack. Battery modules having electrochemical cells with differing battery chemistries may result in the different battery modules of the battery pack having different voltages, which may be desirable in some applications where the different uses of the different battery modules have different voltage requirements. In some embodiments where the first battery is configured to be part of a circuit having a first voltage, and the second battery is configured to be part of a circuit having a second, different voltage, the first battery has the same number of electrochemical cells as the second battery, but at least one electrochemical cell of the first battery has a different cell voltage than an electrochemical cell of the second battery (e.g., due to different cell chemistries).

It should also be understood that while each electrochemical cell of each battery (e.g., battery module) of the battery pack may be a same type of electrochemical cell having a same capacity, other embodiments are possible. For example, at least some of the electrochemical cells of a first battery module of the battery pack may have a different capacity than at least some of the electrochemical cells of a second battery module of the battery pack. For example, the first electrochemical cell of the first battery (e.g., first electrochemical cell 110 of first battery 191) may have a different capacity than the second electrochemical cell of the second battery (e.g., second electrochemical cell 120 of second battery 192) of the battery pack.

While FIGS. 9A-9C show battery packs having two batteries (a first battery and a second battery), the battery pack may comprise greater than two batteries (e.g., at least partially enclosed by the same housing). For example, the battery pack may comprise greater than or equal 3, greater than or equal to 5, and/or up to 10 or more batteries (e.g., each at least partially enclosed by the same housing and each having a pair of terminals). Each battery of the battery pack can have any of a variety of numbers of electrochemical cells (e.g., depending on desired voltage and/or capacity). For example, each battery of the battery pack may independently have greater than or equal to 1, greater than or equal to 2, greater than or equal to 3, greater than or equal to 5, and/or up to 10, up to 12, or more electrochemical cells.

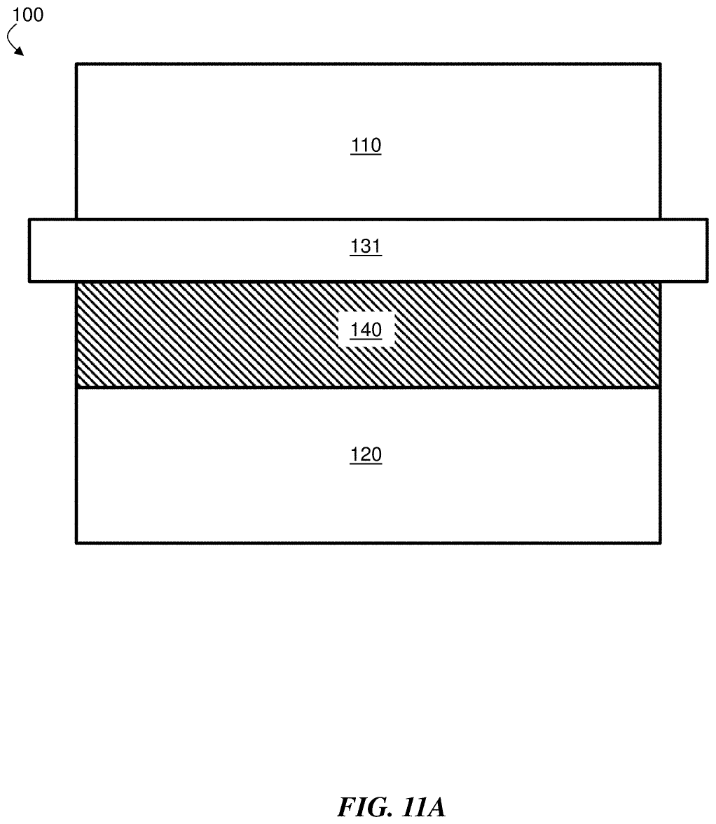

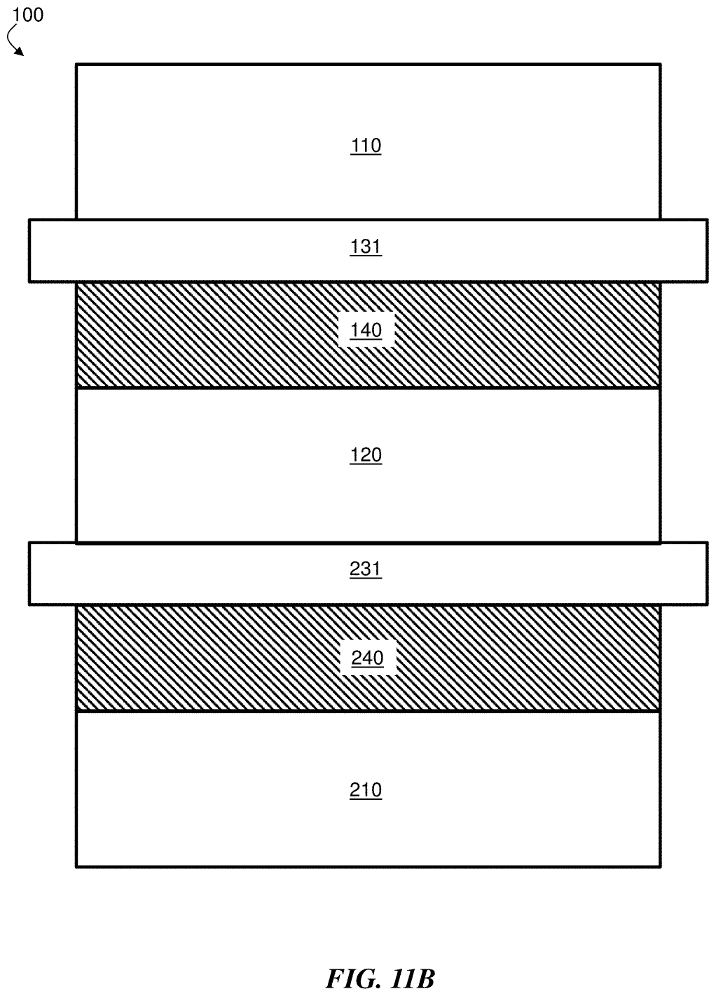

As mentioned above, the battery pack may comprise components having a potentially advantageous arrangement (e.g., for thermal management). For example, in some embodiments, a multicomponent stack is described comprising electrochemical cells, thermally conductive solid article portions, and thermally insulating compressible solid article portions. The multicomponent stack or stack of electrochemical cells may be part of a battery pack described herein. In some embodiments, a multicomponent stack comprises the following in the order listed: a first electrochemical cell; a thermally conductive solid article portion; and a thermally insulating compressible solid article portion. In some embodiments, a multicomponent stack comprises the following in the order listed: an electrochemical cell; a first thermally conductive solid article portion; a thermally insulating compressible solid article portion; a second thermally conductive solid article portion; and a second electrochemical cell. For example, referring to FIG. 10A, battery pack 100 comprises a multicomponent stack comprising first electrochemical cell 110, first thermally conductive solid article portion 131, thermally insulating compressible solid article portion 140, second thermally conductive solid article portion 132, and second electrochemical cell 120.

In some embodiments, the arrangement of components of the battery pack may be repeated. For example, in FIG. 10C, battery pack 100 comprises first electrochemical cell 110, first thermally conductive solid article portion 131, first thermally insulating compressible solid article portion 140, second thermally conductive solid article portion 132, second electrochemical cell 120, third thermally conductive solid article portion 231, second thermally insulating compressible solid article portion 240, fourth thermally conductive solid article portion 232, and third electrochemical cell 210.

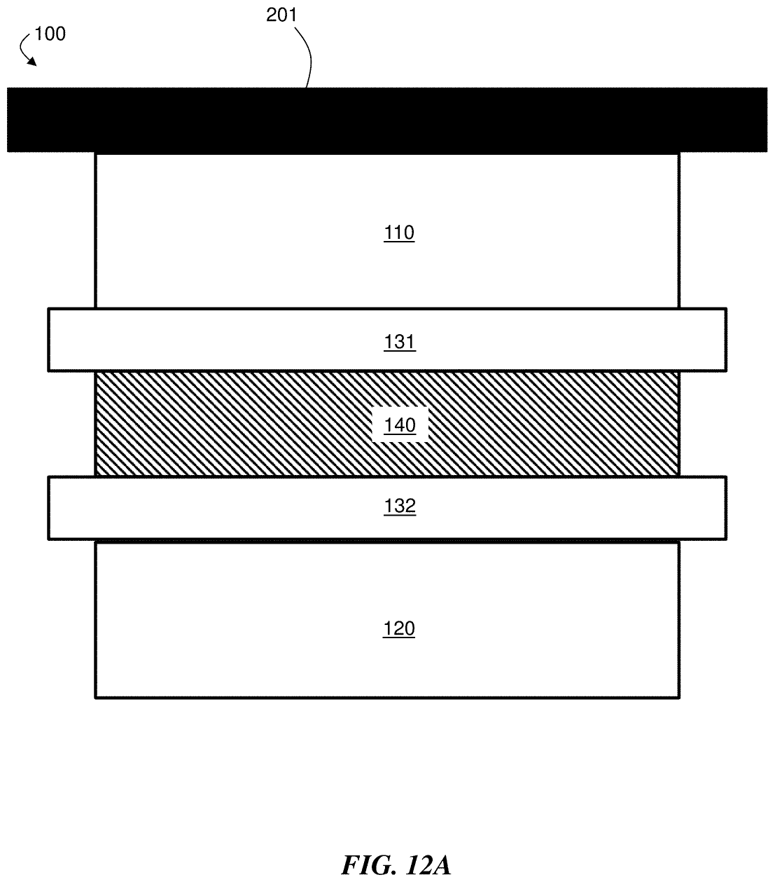

In some embodiments, a multicomponent stack comprises the following in the order listed: a first electrochemical cell; a thermally conductive solid article portion; a thermally insulating compressible solid article portion, and a second electrochemical cell. For example, FIG. 11A shows a cross-sectional schematic diagram of one such embodiment, where stack of electrochemical cells 100 comprises, in order: electrochemical cell 110, thermally conductive solid article portion 131, thermally insulating compressible solid article portion 140, and second electrochemical cell 120. In some embodiments, a multicomponent stack comprises the following in the order listed: a first electrochemical cell; a first thermally conductive solid article portion; a first thermally insulating compressible solid article portion, a second electrochemical cell, and second thermally conductive solid article portion, a second thermally insulating compressible solid article portion, and a third electrochemical cell. For example, FIG. 11B shows a cross-sectional schematic diagram of one such embodiment, where stack of electrochemical cells 100 comprises, in order: first electrochemical cell 110, first thermally conductive solid article portion 131, first thermally insulating compressible solid article portion 140, second electrochemical cell 120, second thermally conductive solid article portion 231, second thermally insulating compressible solid article portion 240, and third electrochemical cell 210.

The abovementioned arrangements of thermally conductive and thermally insulating components may facilitate relatively rapid transfer of heat away from electrochemical cells in the stack while mitigating thermal transfer between electrochemical cells of the stack. For example, battery pack 100 may have a relatively low rate of thermal transfer in thickness direction 153 shown in FIG. 10A, while at least a portion of battery pack 100 may have a relatively high rate of thermal transfer in lateral direction 151 as shown in FIG. 10A. Additionally, having one or more of the components be compressible may assist with mitigating expansion of the battery pack, e.g., during cumulative expansion of electrochemical cells during cycling. The stack may be at least partially enclosed by a housing. For example, battery pack 100 may be at least partially enclosed by optional housing 102 in FIG. 10B. In some, but not necessarily all embodiments, there are no intervening layers or components between these articles. For example, in some embodiments, the first electrochemical cell is directly adjacent to the first thermally conductive solid article portion, the first thermally conductive solid article portion is directly adjacent to the thermally insulating compressible solid article portion, the thermally insulating compressible solid article portion is directly adjacent to the second thermally conductive solid article portion, and the second thermally conductive solid article portion is directly adjacent to the second electrochemical cell. However, in other embodiments, intervening articles or layers may be present, such as sensors (e.g., pressure sensors, temperature sensors, etc.). In some embodiments, at least one lateral edge of the thermally conductive solid article portion extends past a lateral edge of the first electrochemical cell. For example, in FIG. 10A lateral edge 156 of first thermally conductive solid article portion 131 extends past lateral edge 158 of first electrochemical cell 110, in accordance with certain embodiments. This may facilitate removal of heat from the electrochemical cells. In some such embodiments, a portion of thermally conductive solid article portion proximate to the lateral edge extended past the electrochemical cell may be folded over itself. Folding a portion proximate the lateral edge may reduce the lateral dimension of the thermally conductive solid article portion, which may allow for a smaller overall dimension of the battery pack, thereby increasing the volumetric energy density of the battery pack. It has also been observed that a folded portion proximate to the lateral edge may have increased stiffness compared to unfolded portions (due to an effectively doubled thickness), which can improve the durability of the thermally conductive solid article portions in some instances.

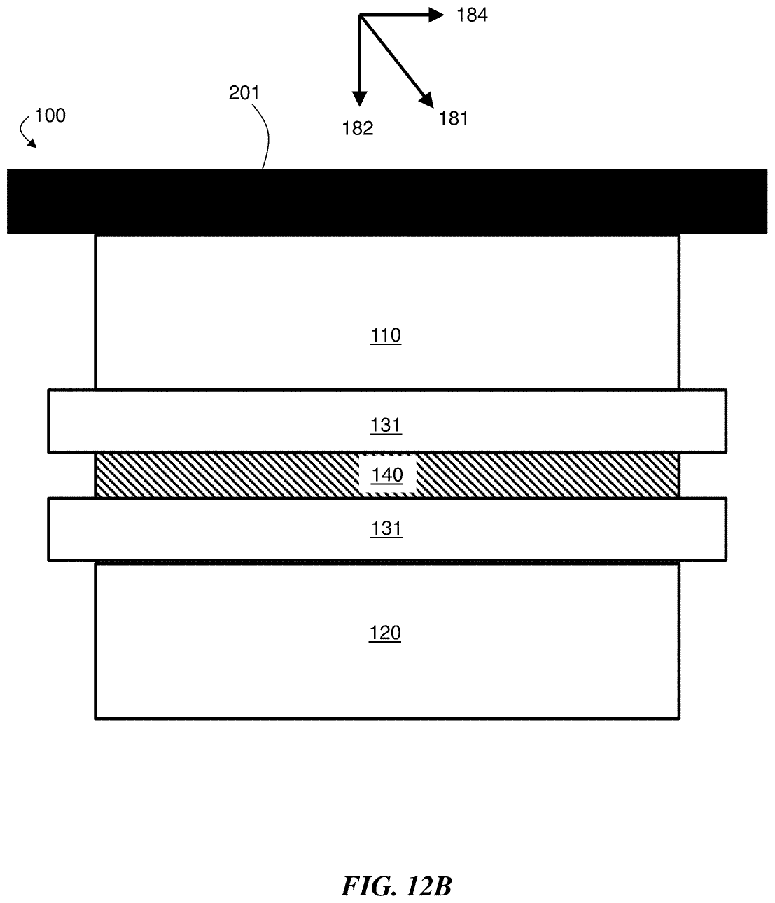

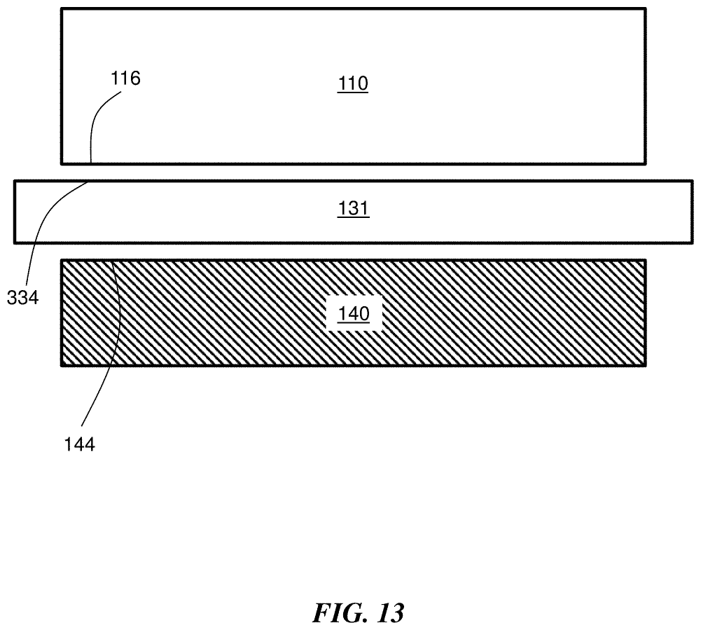

As mentioned above, some embodiments may comprise application of an anisotropic force (e.g., via a solid plate). FIGS. 12A-12B show one such embodiment, where anisotropic force 181 is applied via first solid plate 201 (see FIG. 12B). FIG. 12B illustrates how in some embodiments, the application of such a force causes thermally insulating compressible solid article portion 140 to compress.

In some embodiments, the battery pack comprises thermally conductive solid article portions. For example, referring back to FIGS. 10A-10B, battery pack 100 comprises first thermally conductive solid article portion 131 and second thermally conductive solid article portion 132. As mentioned above, the thermally conductive solid article portions may promote heat transfer away from components of the battery pack (e.g., the electrochemical cells) while also facilitating alignment of electrochemical active regions of the electrochemical cells. In some, but not necessarily all, cases thermally conductive solid article portions are in direct contact with the electrochemical cells. For example, in FIGS. 10A-10B, first thermally conductive solid article portion 131 is shown as being in direct contact with first electrochemical cell 110. However, direct contact is not required, and in some embodiments, there are one or more intervening components (e.g., sensors, etc.) between the thermally conductive solid article portions and the electrochemical cells.

In some embodiments, the thermally conductive solid article portion of the battery pack has a relatively high effective thermal conductivity. As mentioned above, such a high effective thermal conductivity may allow the thermally conductive solid article to assist with dissipating heat from one or more electrochemical cells of the battery pack. Thermal conductivity is generally understood to be an intrinsic property of a material related to its ability to conduct heat. Thermal conductivity is a temperature-dependent quantity and is typically reported in units of W m⁻¹ K⁻¹. The effective thermal conductivity of an article generally refers to the ability of an article to conduct heat, taking into account that the article may be made of a single material or may a non-homogeneous material that may be made of a combination of materials (e.g., a composite material such as a particulate material or layered material). An exemplary method for measuring the thermal conductivity or effective thermal conductivity of a thermally insulating compressible solid article portion is using a hot disk method, as described in ISO/DIS 22007-2.2.

In some embodiments, a thermally conductive solid article portion (e.g., first thermally conductive solid article portion, second thermally conductive solid article portion) has a relatively high effective thermal conductivity in an in-plane direction. Referring again to FIG. 10A, for example, first thermally conductive solid article portion 131 and/or second thermally conductive solid article portion 132 may have a high effective thermal conductivity in lateral direction 151, which is parallel to the in-plane directions of first thermally conductive solid article portion 131 and/or second thermally conductive solid article portion 132. As a result, first thermally conductive solid article portion 131 and/or second thermally conductive solid article portion 132 may enhance the rate at which heat conducted from first electrochemical cell 110 and/or second electrochemical cell 120 is then transferred away (in a lateral direction) from first electrochemical cell 110 and/or second electrochemical cell 120, according to certain embodiments. A resulting accelerated rate of cooling of the electrochemical cells may occur, and in combination with a reduced extent of heat transfer in the thickness direction can, in some instances, improve the safety and performance of the battery pack (e.g., by reducing thermal propagation). In some embodiments, a thermally conductive solid article portion (e.g., first thermally conductive solid article portion, second thermally conductive solid article portion) has an effective thermal conductivity of greater than or equal to 10 W m⁻¹ K⁻¹, greater than or equal to 25 W m⁻¹ K⁻¹, greater than or equal to 50 W m⁻¹ K⁻¹, greater than or equal to 65 W m⁻¹ K⁻¹, greater than or equal to 80 W m⁻¹ K⁻¹, greater than or equal to 100 W m⁻¹ K⁻¹, greater than or equal to 150 W m⁻¹ K⁻¹, and/or up to 159 W m⁻¹ K⁻¹, up to 200 W m⁻¹ K⁻¹, or greater in an in-plane direction at a temperature of 25° C. For example, a thermally conductive solid article portion (e.g., first thermally conductive solid article portion, second thermally conductive solid article portion) may be made of aluminum and have an effective thermal conductivity of 159 W m⁻¹ K⁻¹ in an in-plane direction at a temperature of 25° C.

The thermally conductive solid article portion (e.g., first thermally conductive solid article portion, second thermally conductive solid article portion) may comprise any of a variety of suitable materials. In some embodiments, a thermally conductive solid article portion (e.g., first thermally conductive solid article portion, second thermally conductive solid article portion) comprises a metal and/or metal alloy. Exemplary metals include, but are not limited to transition metals (e.g., titanium, manganese, iron, nickel, copper, zinc), non-transition metals (e.g., aluminum), and alloys or other combinations thereof. In certain embodiments, a thermally conductive solid article portion (e.g., first thermally conductive solid article portion, second thermally conductive solid article portion) comprises or is made of aluminum, at least because aluminum has a relatively high effective thermal conductivity and a relatively low mass density, which in some cases contributes to an overall high specific energy density for the battery pack. One exemplary type of aluminum material of which a thermally conductive solid article portion may be made is 3003 H14 series aluminum, which is aluminum alloyed with 1.2% manganese to increase strength. In some embodiments, a relatively high percentage (e.g., greater than or equal to 50 weight percent (wt %), greater than or equal to 75 wt %, greater than or equal to 90 wt %, greater than or equal to 95 wt %, greater than or equal to 99 wt %, or more) of the thermally conductive solid article portion is metal and/or metal alloy.

In some embodiments, the thermally conductive solid article portion comprises or is made of a carbon-based material. Suitable carbon-based materials include, but are not limited to, graphite, carbon-fiber, graphene (e.g., as part of thermally conductive solid article comprising a solid substrate and associated with graphene), and combinations thereof. In some embodiments, the carbon-based material is present in a relatively high percentage (e.g., greater than or equal to 50 wt %, greater than or equal to 75 wt %, greater than or equal to 90 wt %, greater than or equal to 95 wt %, greater than or equal to 99 wt %, or more) of the thermally conductive solid article portion. In some embodiments, a carbon-based material of a thermally conductive solid article portion has graphite, carbon-fiber, graphene, or a combination thereof present in an amount of at least 25 wt %, at least 50 wt %, at least 75 wt %, at least 90 wt %, at least 95 wt %, at least 99 wt %, or 100 wt %.

The thermally conductive solid article portion (e.g., first thermally conductive solid article portion, second thermally conductive solid article portion) may have any of a variety of form factors. In some embodiments, the thermally conductive solid article portion (e.g., first thermally conductive solid article portion, second thermally conductive solid article portion) is in the form of a relatively planar object (notwithstanding the non-planarities and/or alignment features described below). For example, the thermally conductive solid article portion (e.g., first thermally conductive solid article portion, second thermally conductive solid article portion) may be in the form of a sheet (e.g., a metal and/or metal alloy sheet). In some embodiments, the thermally conductive solid article portion (e.g., first thermally conductive solid article portion, second thermally conductive solid article portion) is or comprises a fin (e.g., a metal and/or metal alloy fin). In some embodiments, the thermally conductive solid article portion (e.g., first thermally conductive solid article portion, second thermally conductive solid article portion) is or comprises a solid plate. It should be understood that the surfaces of a sheet, fin, or solid plate do not necessarily need to be flat. For example, one of the sides of a sheet, fin, or solid plate could have any of the non-planarities and/or alignment features described herein.

The thermally conductive solid article portion (e.g., first thermally conductive solid article portion, second thermally conductive solid article portion) may have a thickness as well as two orthogonal lateral dimensions that are orthogonal to each other as well as orthogonal to the thickness. For example, referring to FIG. 10A, first thermally conductive solid article portion 131 has maximum thickness 235, lateral dimension 151, and a second lateral dimension (not pictured) orthogonal to both maximum thickness 235 and lateral dimension 151 (which would run into and out of the plane of the drawing in FIG. 10A).

The dimensions of the thermally conductive solid article portion may be chosen based on any of a variety of considerations. For example, the thickness or lateral dimensions may be chosen based on the desired total size of the battery pack and/or a desired pack burden. In some embodiments, one or more lateral dimensions of the thermally conductive solid article portion is such that heat generated by the electrochemical cells, once conducted to the thermally conductive solid article portions, can be transferred a relatively long distance from the electrochemical active regions of the electrochemical cells. In some embodiments, the thermally conductive solid article portion has one or more lateral dimensions that extends at least 1 mm, at least 2 mm, at least 5 mm, at least 1 cm, at least 2 cm, at least 5 cm, and/or up to 10 cm or more past the electrochemical active region of the electrochemical cell coupled to the thermally conductive solid article portion.

In some embodiments, the thermally conductive solid article portion (e.g., first thermally conductive solid article portion, second thermally conductive solid article portion) has at least one lateral dimension that is at least 5 times, at least 10 times, and/or up to 20 times, up to 50 times, up to 100 times or more greater than the maximum thickness of the thermally conductive solid article portion.

In some embodiments, the battery pack comprises a thermally insulating compressible solid article portion. The thermally insulating compressible solid article portion may be between two electrochemical cells of the battery pack. For example, referring back to FIGS. 10A-10B, battery pack 100 comprises thermally insulating compressible solid article portion 140 between first electrochemical cell 110 and second electrochemical cell 120, according to certain embodiments. A more detailed description of exemplary thermally insulating compressible solid article portions is described below.

In some embodiments, the thermally conductive solid article portion is relatively smooth as compared to the thermally insulating compressible solid article portion. This may, in some cases, be advantageous, because, under high magnitudes of force, surface irregularities in certain types of thermally insulating compressible solid article portions (e.g., microcellular foams) may cause non-uniform pressure distributions on the electrode active surfaces of the battery pack. A relatively smooth thermally conductive solid article portion (e.g., a metal sheet) may, comparatively, have few irregularities and “smooth” out the pressure distribution. As one example, in FIG. 13, surface 144 of thermally insulating compressible solid article portion 140 may be relatively rough (e.g., have a relatively high surface roughness), while surface 334 of first thermally conductive solid article portion 131 may be relatively smooth (e.g., have a relatively low surface roughness), thereby mitigating irregularities in pressure distribution to surface 116 of first electrochemical cell 110. In some embodiments, the thermally conductive solid article portion has a surface facing a surface of the first electrochemical device having a surface roughness of less than or equal to 10 micrometers, less than or equal to 5 micrometers, less than or equal to 1 micrometer, less than or equal to 0.5 micrometers, less than or equal to 0.1 micrometers, less than or equal to 0.05 micrometers, less than or equal to 0.01 micrometers, or less. In some embodiments, the thermally conductive solid article portion has a surface facing a surface of the first electrochemical device having a surface roughness as low as 0.005 micrometers. That is to say, in some embodiments, the thermally conductive solid article portion has a surface having a surface roughness as low as 0.005 micrometers, with that surface facing a surface of the first electrochemical device.

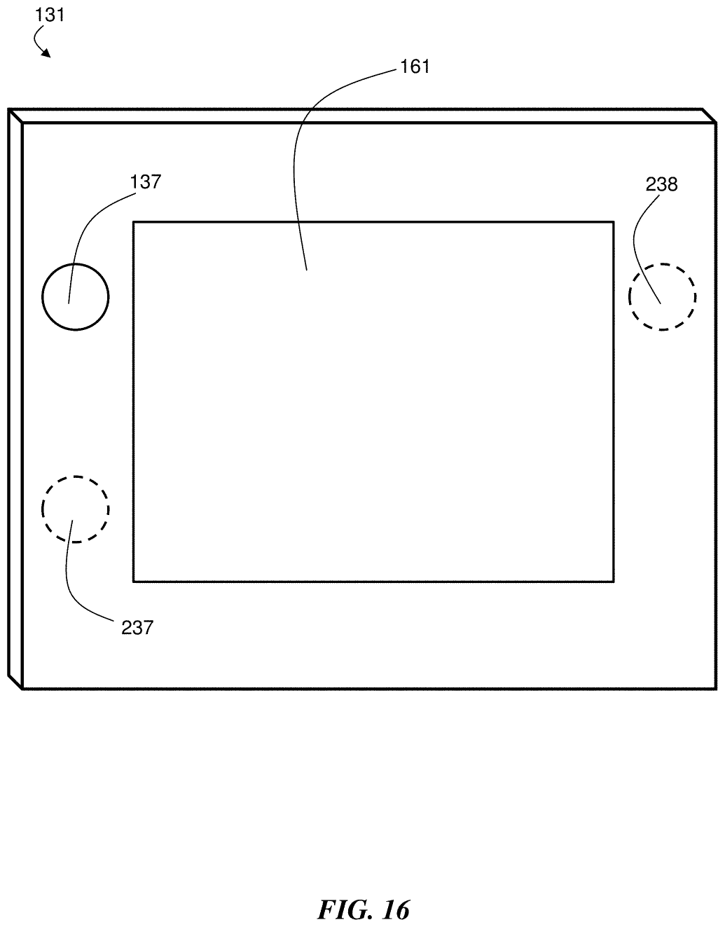

In some embodiments, the arrangement of components of the battery pack may be repeated. For example, in FIG. 16, battery pack 400 comprises first electrochemical cell 110, first thermally conductive solid article portion 131, first thermally insulating compressible solid article portion 140, second thermally conductive solid article portion 132, second electrochemical cell 120, third thermally conductive solid article portion 231, second thermally insulating compressible solid article portion 240, fourth thermally conductive solid article portion 232, and third electrochemical cell 210.

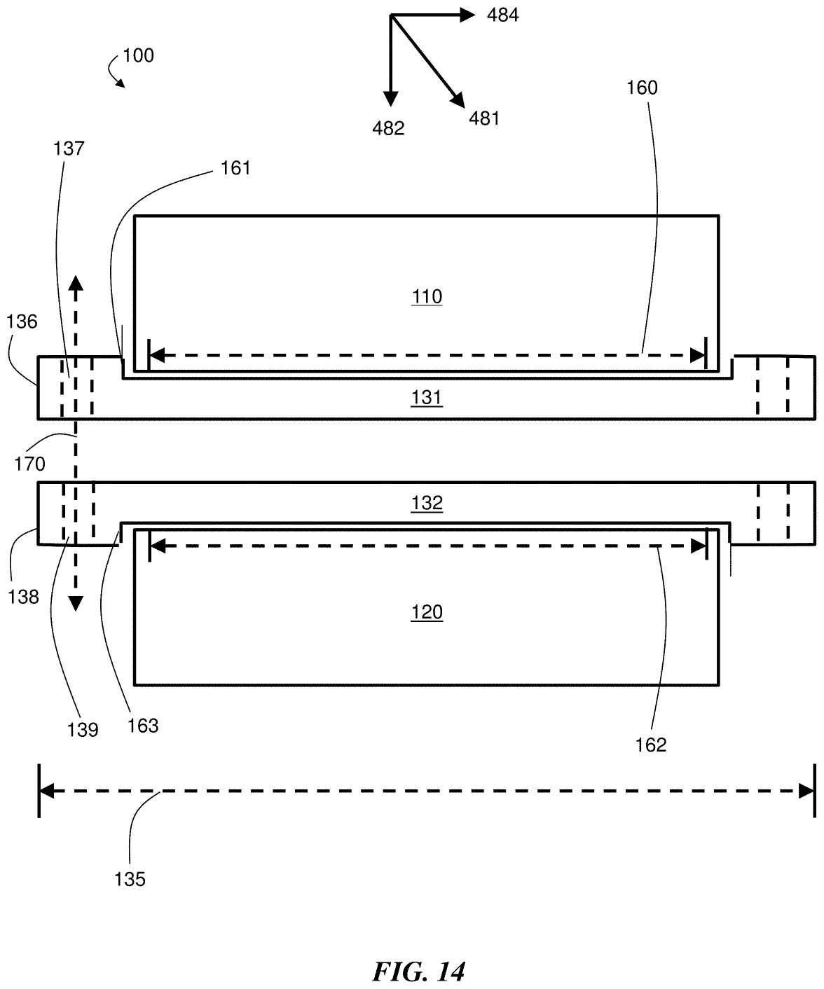

In certain aspects, battery packs with components that may facilitate alignment of electrochemical active areas are generally described. FIG. 14 is a schematic diagram of a non-limiting embodiment of battery pack 100. Battery pack 100 in FIG. 1 comprises first electrochemical cell 110 and second electrochemical cell 120 as part of a stack with first thermally conductive solid article portion 131 and second thermally conductive solid article portion 132, in accordance with certain embodiments. The thermally conductive solid article portions may comprise alignment features, as described in more detail below.

Each of the electrochemical cells in the battery packs described herein may have an electrochemical active region. For example, FIG. 14 shows an embodiment where battery pack 100 comprises first electrochemical cell 110 comprising first electrochemical active region 160 and second electrochemical cell 120 comprising second electrochemical active region 162. An electrochemical active region refers to a region defined by the overlap of the anode active surfaces of the anodes and cathode active surfaces of the cathodes of the electrochemical cell. For example, referring to FIG. 15, first electrochemical cell 110 has electrochemical active region 160 defined by the overlap of anode active surface 166 and cathode active surface 167. In some embodiments, a portion of an anode and/or cathode may not be part of the electrochemical active region of the electrochemical cell. For example, an anode and cathode may be offset such that a portion of an anode does not overlap with the corresponding cathode, thereby preventing that portion of the anode from participating in electrochemical reactions with the cathode. Referring to FIG. 15, portion 168 of anode 112 does not overlap with any of cathode 114 and therefore cannot participate in any electrochemical reactions with cathode 114, and therefore portion 118 of anode 112 is not part of first electrochemical active region 160, according to certain embodiments.

In some embodiments, an electrochemical cell of the battery pack (e.g., first electrochemical cell, second electrochemical cell) is coupled to a non-planarity of a thermally conductive solid article portion (e.g., first thermally conductive solid article portion, second thermally conductive solid article portion) of the battery pack. FIG. 14 shows one non-limiting such example, where battery pack 100 comprises first electrochemical cell 110 coupled to non-planarity 161 of first thermally conductive solid article portion 131 and battery pack 100 further comprises second electrochemical cell 120 coupled to non-planarity 163 of second thermally conductive solid article portion 132. Any of a variety of non-planarities may be part of a thermally conductive solid article portion and used to couple to an electrochemical cell. For example, a non-planarity of a thermally conductive solid article portion may be a deviation from the mean plane of a surface of the thermally conductive solid article portion facing the electrochemical cell to which it is coupled.

As used herein, a surface is said to be “facing” an object when a line extending normal to and away from the bulk of the material comprising the surface intersects the object. For example, a first surface and a second surface can be facing each other if a line normal to the first surface and extending away from the bulk of the material comprising the first surface intersects the second surface. A surface can be facing another object when it is in contact with the other object, or when one or more intermediate materials are positioned between the surface and the other object. For example, two surfaces that are facing each other can be in contact or can include one or more intermediate materials between them. In some instances, a surface and an object (e.g., another surface) facing each other are substantially parallel. In some embodiments, two surfaces can be substantially parallel if, for example, the maximum angle defined by the two planes is less than or equal to 10°, less than or equal to 5°, less than or equal to 2°, or less than or equal to 1°.

In some embodiments, the non-planarity of a thermally conductive solid article portion (e.g., first thermally conductive solid article portion, second thermally conductive solid article portion) of the battery pack is a recess in the thermally conductive solid article portion. FIG. 14 and FIG. 16 show non-limiting such embodiments. In FIG. 14, non-planarity 161 and non-planarity 163 are recesses in first thermally conductive solid article portion 131 and second thermally conductive solid article portion 132, respectively, according to some embodiments. FIG. 16 shows a perspective view schematic diagram of first thermally conductive solid article 131 comprising non-planarity 161, which may be a recess in first thermally conductive solid article 131. A non-planarity (e.g., recess) may have any of a variety of shapes and dimensions, depending, for example, on the size and shape of a corresponding electrochemical cell (and its electrochemical active region).

An electrochemical cell may be coupled to a recess in a thermally conductive solid article portion by having a shape such that the at least a portion of the electrochemical cell can fit into the recess. For example, referring again to FIG. 14, first electrochemical cell 110 fits into non-planarity 161 like an object in a pocket such that when first electrochemical cell 110 and first thermally conductive solid article portion 131 are coupled, the position of first electrochemical cell 110 is fixed with respect to first thermally conductive solid article portion 131. It should be understood that while FIG. 14 shows an entirety of the illustrated first electrochemical cell 110 fitting into non-planarity 161, in some embodiments one or more portions of an electrochemical cell, such as a conductive tab or pouch, may not be fit into the non-planarity, and may extend past the thermally conductive solid article portion. In some embodiments in which the electrochemical cell comprises a pouch, a portion of the pouch extending past the electrode active surfaces of the electrochemical cell is folded. Folding portions of the pouch may reduce the lateral dimension of the electrochemical cell, which may allow for an overall smaller housing to be used for the battery pack (which can increase the volumetric energy density of the battery pack).

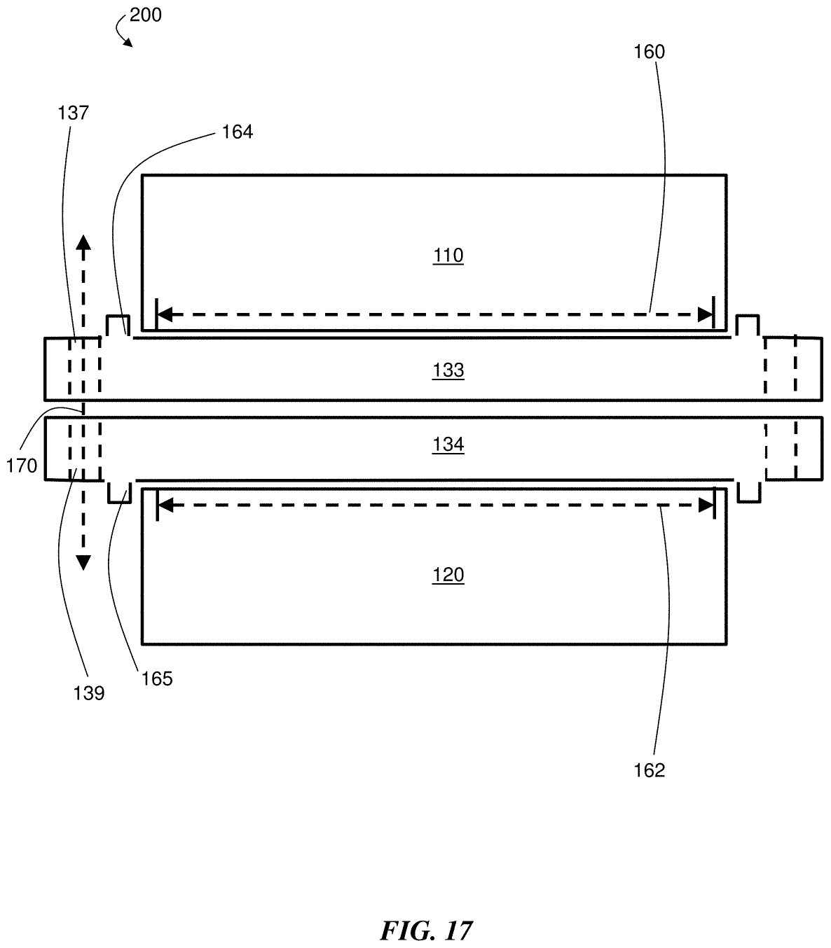

In some embodiments, the non-planarity of a thermally conductive solid article portion (e.g., first thermally conductive solid article portion, second thermally conductive solid article portion) of the battery pack is a protrusion. The protrusion may extend away from the main surface of the thermally conductive solid article portion facing the electrochemical cell. For example, FIG. 17 shows a cross-sectional schematic diagram of battery pack 200 comprising first electrochemical cell 110 coupled to non-planarity 164 of first thermally conductive solid article portion 133 and second electrochemical cell 120 coupled to non-planarity 165 of second thermally conductive solid article portion 134. In FIG. 17, non-planarity 164 and non-planarity 165 are protrusions from first thermally conductive solid article portion 133 and second thermally conductive solid article portion 134, respectively.

An electrochemical cell may be coupled to a protrusion in a thermally conductive solid article portion by having a shape such that the electrochemical cell can fit between protrusions. For example, referring again to FIG. 17, first electrochemical cell 110 couples to non-planarity 164 by fitting between the protrusions of non-planarity 164 such that the position of first electrochemical cell 110 is fixed with respect to first thermally conductive solid article portion 133. It should be understood that while FIG. 17 shows an entirety of the illustrated first electrochemical cell 110 fitting between protrusions of non-planarity 164, in some embodiments one or more portions of an electrochemical cell, such as a conductive tab or pouch, may not be fit into or between portions of the non-planarity, and may extend past the thermally conductive solid article portion.

A non-planarity that is protrusion may take any of a variety of forms. For example, in some embodiments, a non-planarity that is a protrusion is a raised edge in the thermally conductive solid article portion (e.g., first thermally conductive solid article portion, second thermally conductive solid article portion). In some embodiments a non-planarity is a plurality of posts extending from the thermally conductive solid article portion.

Non-planarities in thermally conductive solid article portions (e.g., recesses, protrusions) may be formed in any of a variety of suitable ways, such as via machining, milling, molding, additive manufacturing (e.g., 3D-printing), etc.

In some embodiments, a thermally conductive solid article portion (e.g., first thermally conductive solid article portion, second thermally conductive solid article portion) comprises an alignment feature. An alignment feature may be, for example, a structural component of the thermally conductive solid article portion that can assist with the positioning of the thermally conductive solid article portion with respect to another thermally conductive solid article portion of the battery pack. In FIG. 14, first thermally conductive solid article portion 131 comprises first alignment feature 137 and second thermally conductive solid article portion 132 comprises second alignment feature 139, according to some embodiments. In some instances, first alignment feature 137 and second alignment feature 139 can be used to fix the relative positions of first thermally conductive solid article portion 131 and second thermally conductive solid article portion 132 with respect to each other.

An alignment feature may take any of a variety of suitable structural forms. For example, in some embodiments, an alignment feature of the thermally conductive solid article portion (e.g., first thermally conductive solid article portion, second thermally conductive solid article portion) is a gap in the thermally conductive solid article portion. FIG. 14 shows one such example, where first alignment feature 137 and second alignment feature 139 are gaps in first thermally conductive solid article portion 131 and second thermally conductive solid article portion 132, respectively. FIG. 16 shows a perspective view of first alignment feature 137 as a gap in first thermally conductive solid article portion 131, according to some embodiments. In certain cases, a gap serving as an alignment feature may be a through-hole, slot, or opening in a thermally conductive solid article portion. In some embodiments, an alignment feature of the thermally conductive solid article portion (e.g., first thermally conductive solid article portion, second thermally conductive solid article portion) is an edge of the thermally conductive solid article. For example, while FIG. 14 shows first alignment feature 137 and second alignment feature 139 as gaps, in some embodiments, edge 136 of first thermally conductive solid article portion 131 and edge 138 of second thermally conductive solid article portion 132 can be alignment features. In some embodiments, an alignment feature of the thermally conductive solid article portion (e.g., first thermally conductive solid article portion, second thermally conductive solid article portion) is a protrusion of the thermally conductive solid article. In some embodiments an alignment feature of the first thermally conductive solid article portion and an alignment feature of the second thermally conductive solid article portion are substantially similar or the same (e.g., both gaps, both edges, both protrusions). However, in some instances an alignment feature of a first thermally conductive solid article portion and an alignment feature of a second thermally conductive solid article portion are different (e.g., a first alignment feature is a gap and a second alignment feature is a protrusion). In some such cases, a first alignment feature of a first thermally conductive solid article portion is complementary to a second alignment feature of a second thermally conductive solid article portion (e.g., a protrusion in one thermally conductive solid article portion may fit into a recess or through-hole of another thermally conductive solid article portion).

In some embodiments, a thermally conductive solid article portion comprises multiple alignment features. In certain cases, using multiple alignment features per thermally conductive solid article portion may facilitate easier and/or more accurate alignment of components of the battery pack. Referring again to FIG. 16, in some embodiments, first thermally conductive solid article 131 comprises first alignment feature 137 and third alignment feature 237. Each of first alignment feature 137 and optional third alignment feature 237 may be substantially aligned with corresponding alignment features of second thermally conductive solid article portion 132 during an alignment process. In some embodiments, a thermally conductive solid article portion comprises multiple alignment features on the same side of the thermally conductive solid article portion with respect to an electrochemical cell coupled to the thermally conductive solid article portion. FIG. 16 shows one exemplary such embodiment with first alignment feature 137 and third alignment feature 237 on the same side of first thermally conductive solid article 131. Moreover, in some embodiments, the thermally conductive solid article portion comprises multiple alignment features on different sides of the thermally conductive solid article portion with respect to an electrochemical cell coupled to the thermally conductive solid article portion. FIG. 16 also shows one exemplary embodiment with first alignment feature 137 and third alignment feature 238 on the opposite side of first thermally conductive solid article 131. Third alignment feature 238 may be optional, as indicated by the dashed line. In some embodiments, the thermally conductive solid article portion comprises one or more (e.g., multiple such as two or more) alignment features on the same side of the thermally conductive solid article portion with respect to an electrochemical cell coupled to the thermally conductive solid article portion and one or more (e.g., multiple such as two or more) alignment features on different sides of the thermally conductive solid article portion with respect to an electrochemical cell coupled to the thermally conductive solid article portion.

Some embodiments comprise substantially aligning a first feature (e.g., a first alignment feature) of a first thermally conductive solid article portion with a second feature (e.g., a second alignment feature) of a second thermally conductive solid article portion. Such an alignment process may result in a first electrochemical active region of a first electrochemical cell coupled to a non-planarity of the first thermally conductive solid article portion being substantially aligned with a second electrochemical active region of a second electrochemical cell coupled to a non-planarity of the second thermally conductive solid article portion. In certain cases, the first alignment feature and the second alignment feature are located such that when the first alignment feature is substantially aligned with the second alignment feature, the first electrochemical active region and the second electrochemical active region are substantially aligned. For example, in FIG. 14, first alignment feature 137 and second alignment feature 139 may be located (e.g., with respect to non-planarity 161 and non-planarity 163) such that substantial alignment of first alignment feature 137 and second alignment feature 139 results in the substantial alignment of first electrochemical active region 160 with second electrochemical active region 162 due to the coupling of first electrochemical cell 110 to non-planarity 161 and the coupling of second electrochemical cell 120 with non-planarity 163. Substantially aligning electrochemical active areas of electrochemical cells in the battery pack may result in substantially uniform conditions for the electrochemical active areas (e.g., during charge and/or discharge). As one example, in some embodiments in which an anisotropic force with a component normal to one or more of the electrochemical cells is applied, the pressure distribution experienced by two substantially aligned electrochemical active areas may be substantially identical, which can in some cases lead to beneficial performance and/or durability for the battery pack. In some embodiments when a first electrochemical active area of the first electrochemical cell is substantially aligned with the second electrochemical active area of a second electrochemical cell, the first electrochemical active area and second electrochemical active area are aligned to within a distance of less than or equal to 2 mm, less than or equal to 1 mm, less than or equal to 0.5 mm, and/or as low as 0.1 mm, or less. In some embodiments when a first electrochemical active area of the first electrochemical cell is substantially aligned with the second electrochemical active area of a second electrochemical cell, at least 90%, at least 95%, at least 98%, at least 99%, at least 99.5% or more of the first electrochemical active area overlaps with the second electrochemical active area. The extent of alignment may be determined, for example, by visual inspection. Visual inspection in battery packs may include discharging and charging the battery pack and visually examining and comparing the accumulation of electrode active material (e.g., lithium metal and/or a lithium metal alloy plating) on electrodes of the first electrochemical cell and second electrochemical cell.

One non-limiting way in which alignment features of thermally conductive solid article portions of the battery pack may be substantially aligned when they are gaps is by passing an object through the alignment features (e.g., through the first alignment feature and the second alignment feature). As an example, in FIG. 14, passing an object through first alignment feature 137 and second alignment feature 139 along an axis defined by arrow 170 may substantially align first alignment feature 137 and second alignment feature 139. The direction in which the object is passed through the alignment features may be substantially perpendicular to one or more lateral dimensions of the thermally conductive solid article portions (e.g., arrow 170 is substantially perpendicular to lateral dimension 135 of first thermally conductive solid article 131 and thermally conductive solid article portion 132 in FIG. 14). Exemplary objects that may be passed through the alignment features include, but are not limited to rods, fasteners, bands, and straps. An object passed through the alignment features may be kept in place even after alignment (e.g., permanently or removably kept in place), or the object may be removed following alignment. Another non-limiting way in which alignment features of the thermally conductive solid article portions of the battery pack may be substantially aligned is by visual or optical inspection (e.g., to see if electromagnetic radiation can pass through the alignment features).

Some embodiments may comprise substantially aligning two or more alignment features of the first thermally conductive solid article portion with two or more features of the second thermally conductive solid article portion. For example, alignment of components of the battery pack may comprise substantially aligning the first alignment feature of the first thermally conductive solid article portion with the second alignment feature of a second thermally conductive solid article portion and substantially aligning a third alignment feature of the first thermally conductive solid article portion with a fourth alignment feature of the second thermally conductive solid article portion. Aligning multiple alignment features of each thermally conductive solid article portion, can, in some cases, increase the accuracy and/or ease with which the components of the battery pack are aligned.

Another nonlimiting way of aligning features of a battery pack is by aligning components of the battery pack with a housing of the battery pack. For instance, in some embodiments, thermally conductive solid article portions may comprise alignment features that interlock with features of the housing. For example, an alignment feature such as non-planarity (e.g. a ridge) of a solid housing component of a housing may interlock with alignment features such as grooves of the thermally conductive solid article portions. In some embodiments, alignment may be achieved without the incorporation of alignment features, due to geometric constraints imposed by the housing (e.g., by one or more solid housing components described above) on components of the battery pack. Aligning components of the battery pack with the housing may prove advantageous to some embodiments by facilitating a reduction in the number of constituent parts of the housing, reducing a largest lateral pressure applying dimension of the housing, and/or increasing the battery pack's volumetric energy density.

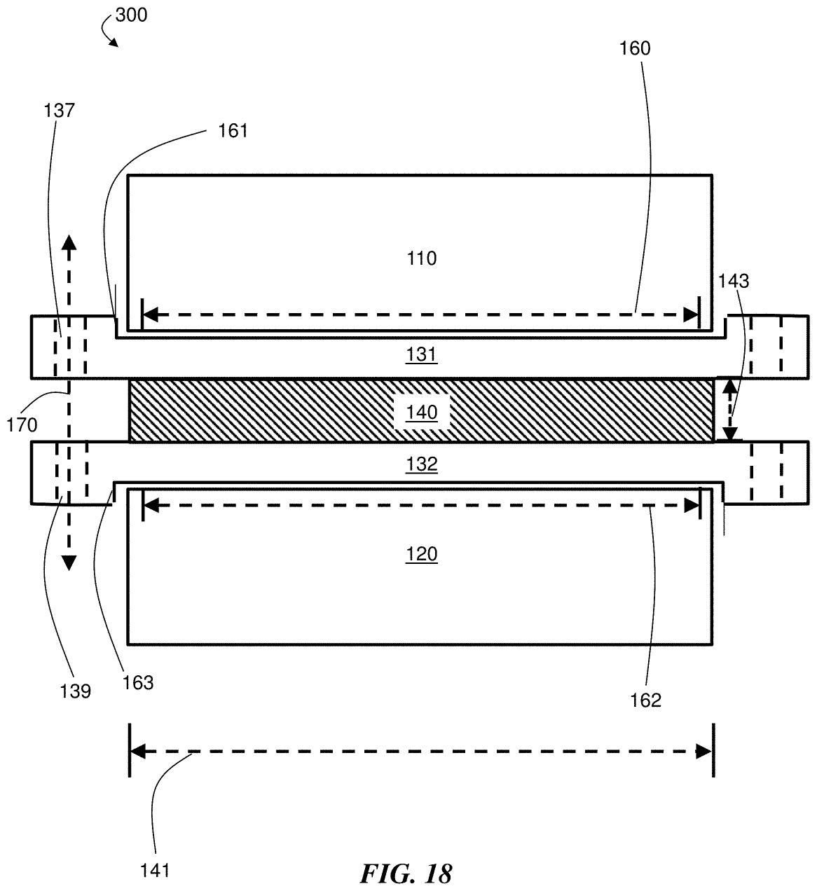

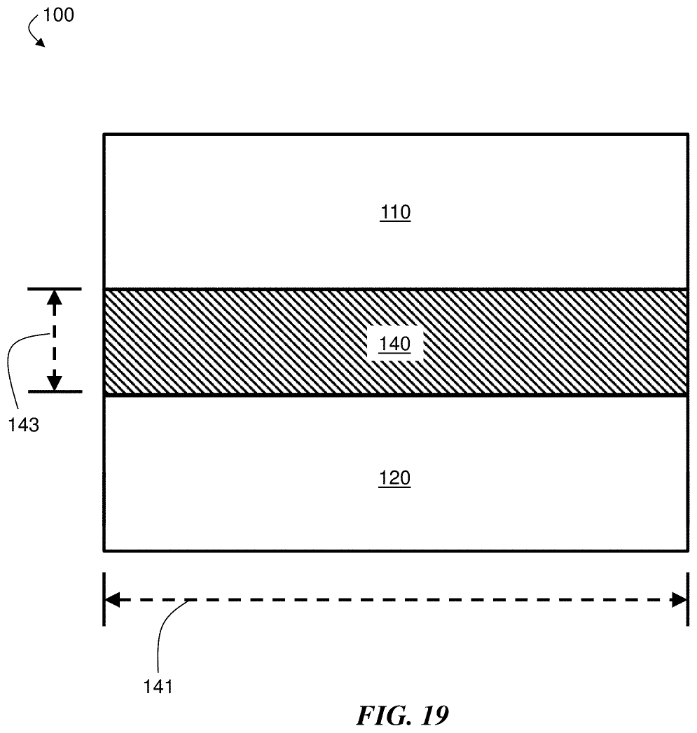

In some embodiments, a thermally conductive solid article portion (e.g., first thermally conductive solid article portion, second thermally conductive solid article portion) is between electrochemical cells (e.g., first electrochemical cell, second electrochemical cell) in the battery pack. FIG. 10A and FIG. 14 show examples of such embodiments, where first thermally conductive solid article portion 131 is between first electrochemical cell 110 and second electrochemical cell 120. In certain embodiments, both a first thermally conductive solid article portion and a second thermally conductive solid article portion are between the first electrochemical cell and the second electrochemical cell. For example, referring again to FIG. 10A and FIG. 14, first thermally conductive solid article portion 131 is between first electrochemical cell 110 and second electrochemical cell 120, and second thermally conductive solid article portion 132 is between first thermally conductive solid article portion 131 and second electrochemical cell 120. In some embodiments, a thermally insulating compressible solid article portion is between the first thermally conductive solid article portion and the second thermally conductive solid article portion. FIG. 18 shows one such embodiment, where thermally insulating compressible solid article portion 140 of exemplary battery pack 300 is between first thermally conductive solid article portion 131 and second thermally conductive solid article portion 132.

In some embodiments, the first thermally conductive solid article portion and the second thermally conductive solid article portion are part of discrete articles. Referring again to FIG. 10A, in some embodiments first thermally conductive solid article portion 131 and second thermally conductive solid article portion 132 are separate, discrete articles (e.g., separate sheets or fins). However, in some embodiments, first thermally conductive solid article portion and the second thermally conductive solid article portion are part of the same article. For example, first thermally conductive solid article portion 131 and second thermally conductive solid article portion 132 may be connected via a third thermally conductive solid article portion (not pictured) in FIG. 10A. As one example, the battery pack may comprise a thermally conductive solid article that is foldable and/or has a serpentine shape such that electrochemical cells and/or other components of the battery pack can be arranged between portions of the thermally conductive solid article.

In some aspects, battery packs comprising solid articles that can compensate for dimensional changes of other battery pack components while also limiting heat transfer between electrochemical cells are generally described. FIG. 19 is a schematic diagram of a non-limiting embodiment of battery pack 100. Battery pack 100 in FIG. 19 comprises first electrochemical cell 110 and second electrochemical cell 120 as part of a stack with thermally insulating compressible solid article portion 140. In some, but not necessarily all cases, the thermally insulating compressible solid article portion is in direct contact with the first electrochemical cell and/or the second electrochemical cell. For example, in FIG. 19, thermally insulating compressible solid article portion 140 is shown as being in direct contact with both first electrochemical cell 110 and second electrochemical cell 120. However, direct contact is not required, and in some embodiments there are one or more intervening components (e.g., other solid article portions such as plates or fins, sensors, etc.) between the thermally insulating compressible solid article portion and the first electrochemical cell and/or second electrochemical cell.

The thermally insulating compressible solid article portion may take any of a variety forms. For example, the thermally insulating compressible solid article portion may be in the form of a solid block, a foam sheet, a mesh, or any other suitable form, provided that it be thermally insulating and compressible. It should be understood that while the thermally insulating compressible solid article portion is referred to as a solid article, it may be at least partially hollow and/or contain pores or voids.

In some embodiments, the thermally insulating compressible solid article portion is a unitary object. FIG. 19 depicts thermally insulating compressible solid article portion 140 as a unitary object (e.g., a single sheet of foam), as one example. It should be understood that a thermally insulating compressible solid article portion that is a unitary object may be part of a larger article in some instances. In some embodiments, the thermally insulating compressible solid article portion comprises multiple separate objects. For example, the thermally insulating compressible solid article portion may comprise multiple layers (e.g., sheets) of either the same or different materials (e.g., foams) as a stack or otherwise arranged. For the properties described herein (e.g., uncompressed thickness, compression set, compressive stress versus percent compression, thermal conductivity, etc.), the measured values correspond to the entirety of the thermally insulating compressible solid article portion. For example, if the thermally insulating compressible solid article portion is a unitary object, the parameters correspond to that unitary object. In instances where the thermally insulating compressible solid article portion comprises multiple separate objects (e.g., a stack of foam sheets), the parameters of the thermally insulating compressible solid article portion correspond to that of the aggregate of all the separate objects of that portion (e.g., all foam sheets measured together as a stack).

In some embodiments, the thermally insulating compressible solid article portion comprises a foam. A foam solid article generally refers to a solid containing pockets of (“cells”) capable of being occupied by a fluid. The pockets may be present throughout the dimensions of the solid. The foam may be present as a relatively high percentage of the thermally insulating compressible solid article portion (e.g., greater than or equal to 50 weight percent (wt %), greater than or equal to 75 wt %, greater than or equal to 90 wt %, greater than or equal to 95 wt %, greater than or equal to 99 wt %, or more). The use of thermally insulating compressible solid article portions comprising a relatively large amount of foam may, in some cases, contribute to a relatively high compressibility of the thermally insulating compressible solid article portion. For example, referring back to FIG. 10A or FIG. 19, in certain embodiments in which thermally insulating compressible solid article portion 140 has a relatively high foam content, pressure experienced by battery pack 100 may result in a relatively large compression of thermally insulating compressible solid article portion 140.

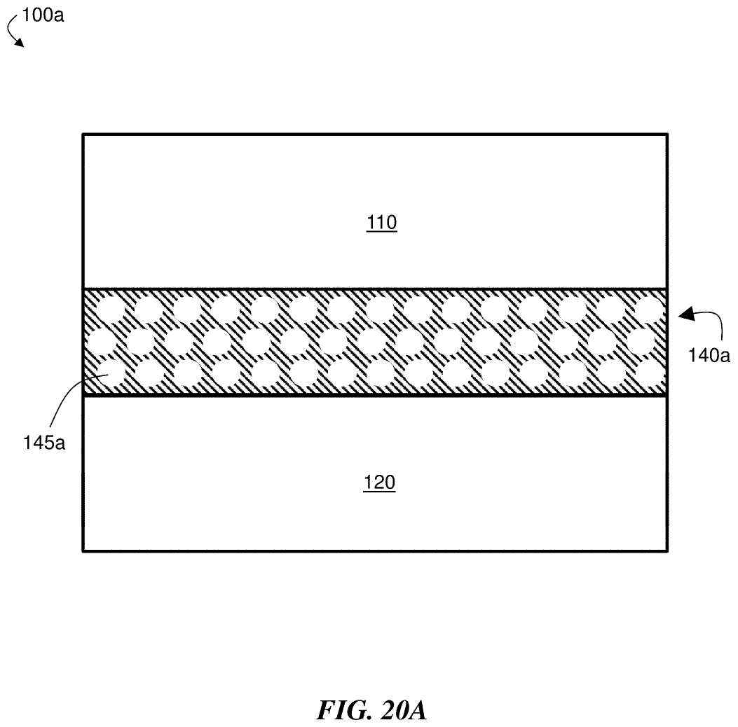

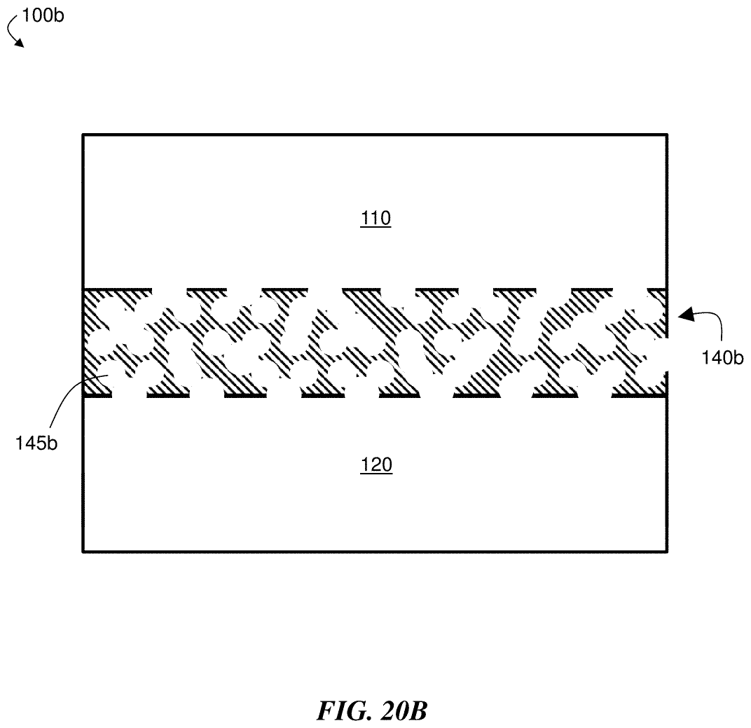

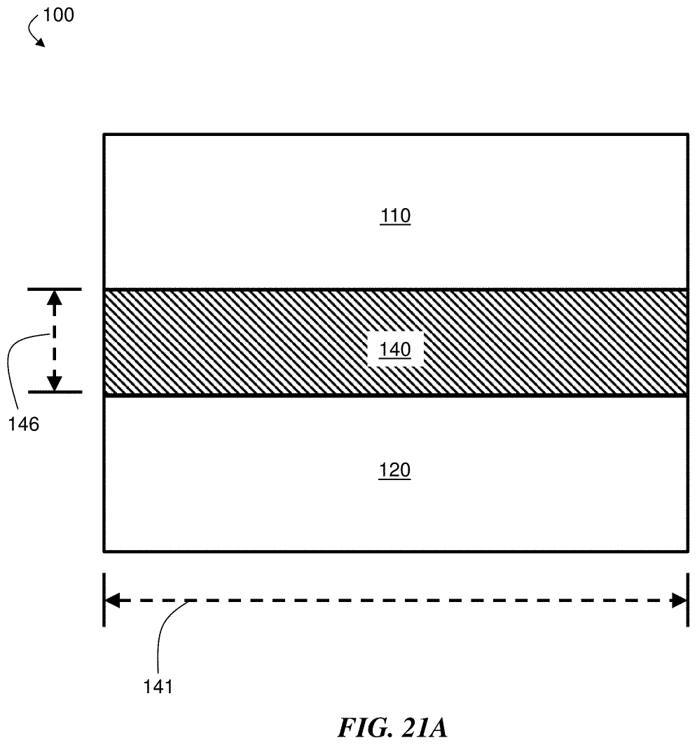

In some embodiments, the thermally insulating compressible solid article portion is or comprises a closed-cell foam. A closed-cell foam solid generally refers to a foam comprising cells (gas pockets) that are discrete and completely surrounded by the solid material of the foam. FIG. 20A shows one such example, where thermally insulating compressible solid article portion 140a of battery pack 100a is a closed-cell foam comprising discrete cells 145a.

However, in some embodiments, the thermally insulating compressible solid article portion is or comprises an open-cell foam. An open-cell foam solid generally refers to a foam comprising cells connected to each other, thereby allowing for a gas or other fluid to travel from cell to cell. FIG. 20B shows one such example, where thermally insulating compressible solid article portion 140b of battery pack 100b is an open-cell foam comprising connected cells 145b.

In some embodiments, thermally insulating compressible solid article portion 140 comprises a microcellular foam. A microcellular foam generally refers to a foam whose cells have an average largest cross-sectional dimension on the order of microns (e.g., greater than or equal to 0.1 micron, greater than or equal to 1 micron, and/or up to 50 microns, up to 100 microns, or up to 500 microns). For example, in embodiments in which thermally insulating compressible solid article portion 140 in FIG. 20A is a microcellular foam, cell 145a may have a largest cross-sectional dimension of between 0.1 and 500 microns. Microcellular foams are typically made of polymeric materials (e.g., plastics) and can be prepared, for example by dissolving gases under high pressure into the material from which the foam is made. Foams such as microcellular foams may be useful in some instances in which thermally insulating compressible solid article portions having a relatively low mass density are desired. A low-density thermally insulating compressible solid article portion may contribute at least in part to a battery pack having a high specific energy density. In some embodiments, the density of the thermally-insulating compressible solid article portion is variable. For example, in some embodiments, regions occupying at least 0.5%, at least 1%, at least 2%, at least 5%, at least 10%, or more of the external geometric volume of the thermally insulating compressible solid article portion have a density (mass density) that is at least 5%, at least 10%, at least 25%, at least 50%, at least 75%, at least 90%, at least 95%, or at least 99% lower than an overall average density of the thermally insulating compressible solid article portion (which can be calculating by dividing the mass of the overall thermally insulating compressible solid article by the overall uncompressed volume of the thermally insulating compressible solid article). One non-limiting way of achieving such variance in density is by including holes/gaps in the thermally insulating compressible solid article portion such that the overall external geometric dimensions of the thermally insulating solid article portion are suitable for performing some or all of the roles described herein, while a mass of the thermally insulating compressible solid article is reduced. It has been observed that some such configurations may provide for a relative reduction in the mass of the battery pack (and an increase in energy density) without significantly affecting performance of the battery pack. Further, it has also been observed that some such configurations may provide for relatively uniform pressure distribution experienced by one or more electrochemical cells of the battery pack is relatively uniform, at least because the density of region of a thermally compressible solid article may affect a magnitude of force experienced by an electrochemical cell adjacent to that region.

In some embodiments, the thermally insulating compressible solid article portion comprises a mesh. As an example, in certain instances, the thermally insulating compressible solid article portion is a mesh structure made of strands of flexible, thermally-insulating material (e.g., fiber, plastic) that are attached and/or woven together.

In some embodiments, the thermally insulating compressible solid article portion is porous. As one example, referring again to FIGS. 10A-10B and FIG. 19, thermally insulating compressible solid article portion 140 is made of a porous material. As used herein, a “pore” refers to a pore as measured using ASTM Standard Test D4284-07, and generally refers to a conduit, void, or passageway, at least a portion of which is surrounded by the medium in which the pore is formed such that a continuous loop may be drawn around the pore while remaining within the medium. Generally, voids within a material that are completely surrounded by the material (and thus, not accessible from outside the material, e.g., closed cells) are not considered pores within this context. As such, a thermally insulating compressible solid article portion may be or comprise an open-cell solid, such an open-cell solid foam. It should be understood that, in cases where the thermally insulating compressible solid article portion comprises an agglomeration of particles, pores include both the interparticle pores (i.e., those pores defined between particles when they are packed together, e.g., interstices) and intraparticle pores (i.e., those pores lying within the envelopes of the individual particles). Pores may comprise any suitable cross-sectional shape such as, for example, circular, elliptical, polygonal (e.g., rectangular, triangular, etc.), irregular, and the like.

The porosity of a component of a battery pack (e.g., the thermally insulating compressible solid article portion comprising open cells) may be measured by physically separating the different regions of the electrochemical device by, for example, cutting out a region of the component, and then measuring the separated portion using the above-referenced ASTM Standard Test D4284-07.

In some instances, the thermally insulating compressible solid article portion (e.g., comprising an open-cell solid such as an open-cell foam) has a relatively high porosity. Having a relatively high porosity may contribute to the thermally insulating compressible solid article portion having a relatively low density, which in some instances can be advantageous as described above. A high porosity may also contribute, in some cases, to a relatively high compressibility. In some embodiments, the thermally insulating compressible solid article portion has a porosity of greater than or equal to 40%, greater than or equal to 50%, greater than or equal to 60%, or higher by volume. In some embodiments, the thermally insulating compressible solid article portion has a porosity of less than or equal to 90%, less than or equal to 80%, less than or equal to 70%, or less by volume. Combinations of these ranges are possible. For example, in some cases, the thermally insulating compressible solid article portion has a porosity of greater than or equal to 40% and less than or equal to 90%.

The thermally insulating compressible solid article portion may have any of a variety of suitable pore sizes, depending on, for example, the choice of material for the compressible solid article portion or the magnitude of force to be applied to the battery pack. For example, in some cases, the thermally insulating compressible solid article portion has an average pore size of greater than or equal to 0.1 microns, greater than or equal to 0.5 microns, greater than or equal to one micron, greater than or equal to 10 microns, greater than or equal to 50 microns, or greater. In some cases, the thermally insulating compressible solid article portion has an average pore size of less than or equal to 1 mm, less than or equal to 500 microns, less than or equal to 100 microns, or less. Combinations of these ranges are possible. For example, in some embodiments, the thermally insulating compressible solid article portion has an average pore size of greater than or equal to 0.1 microns and less than or equal to 1 mm, or greater than or equal to 1 micron and less than or equal to 100 microns.

In some embodiments, the thermally insulating compressible solid article portion has a relatively high void percentage. The voids of a solid object in this context generally refers to portions of the solids object not occupied by solid material. Voids may be occupied by a fluid such as a gas (e.g., air) or a liquid. It should be understood that pores such as open-cells may contribute to the void percentage, and closed-cells may also contribute to void percentage. As such, a thermally insulating compressible solid article portion comprising closed cells (e.g., a closed-cell foam such as thermally insulating compressible solid article portion 140a in FIG. 20A) may have a relatively high void percentage. Void percentage a solid article may be determined by dividing the void volume of the article by the volume defined by the outer boundaries of the article. Having a relatively high void percentage may contribute to the thermally insulating compressible solid article portion having a relatively low density, which in some instances can be advantageous as described above. A high void percentage may also contribute, in some cases, to a relatively high compressibility. In some embodiments, the thermally insulating compressible solid article portion has a void percentage of greater than or equal to 25%, greater than or equal to 40%, greater than or equal to 50%, and/or up to 60%, up to 75%, up to 90%, or more.

As a thermal insulator, the thermally insulating compressible solid article portion may contribute at least in part to advantageous thermal management of components of the battery pack. In some embodiments, the thermally insulating compressible solid article portion has a relatively low effective thermal conductivity (consequently making it a relatively good thermal insulator). The thermal insulating capability of the thermally insulating compressible solid article portion can, in some cases, contribute at least in part to thermally isolating one or more electrochemical cells and the battery pack from one or more other portions of the battery pack. For example, referring back to FIGS. 10A-10B and FIG. 19, in some embodiments in which thermally insulating compressible solid article portion 140 has a relatively low effective thermal conductivity, thermally insulating compressible solid article portion 140 mitigates heat transfer between first electrochemical cell 110 and second electrochemical cell 120. Such a mitigation in heat transfer can, in some instances, reduce propagation of deleterious phenomena among the electrochemical cells (e.g., during cycling).

In some embodiments, the thermally insulating compressible solid article portion has a relatively low effective thermal conductivity in the thickness direction. Referring again to FIG. 19, for example, thermally insulating compressible solid article portion 140 may have a low effective thermal conductivity in thickness direction 143. As a result, thermally insulating compressible solid article portion 140 may reduce the rate at which heat is transferred from first electrochemical cell 110, through thermally insulating compressible solid article portion 140 in thickness direction 143, and to second electrochemical cell 120, according to certain embodiments. This reduced extent of heat transfer in the thickness direction can, in some instances, improve the safety and performance of the battery pack (e.g., by reducing thermal propagation). In some embodiments, the thermally insulating compressible solid article portion has an effective thermal conductivity of less than or equal to 0.5 W m⁻¹ K⁻¹, less than or equal to 0.25 W m⁻¹ K⁻¹, and/or as low as 0.1 W m⁻¹ K⁻¹, as low as 0.01 W m⁻¹ K⁻¹, or less in the thickness direction at a temperature of 25° C. For example, the thermally insulating compressible solid article portion may comprise a microcellular foam and have an effective thermal conductivity of 0.21 W m⁻¹ K⁻¹ in the thickness direction at a temperature of 25° C. In some embodiments, the rate of heat transfer between two components of the battery pack (e.g., first electrochemical cell 110 and second electrochemical cell 120 in FIG. 19) is relatively low. In certain cases, the rate of heat transfer from the first electrochemical cell to the second electrochemical cell is less than or equal to 5 W m⁻¹ K⁻¹, less than or equal to 2.5 W m⁻¹ K⁻¹, and/or as low as 1 W m⁻¹ K⁻¹, as low as 0.1 W m⁻¹ K⁻¹, or less when the temperature difference between the first electrochemical cell and the second electrochemical cell is 10 K.

The compressibility of the thermally insulating compressible solid article portion may be useful in any of a variety of applications. As one example, in some instances in which one or more components of the battery pack change dimension during a charging and/or discharge process, a resulting compression of the thermally insulating compressible solid article portion may compensate for that change in dimension. In some such cases, the compressibility of the thermally insulating compressible solid article portion under stress may reduce the extent to which a battery pack expands or contracts when electrochemical cells within the battery pack undergo expansion and/or contraction during cycling.

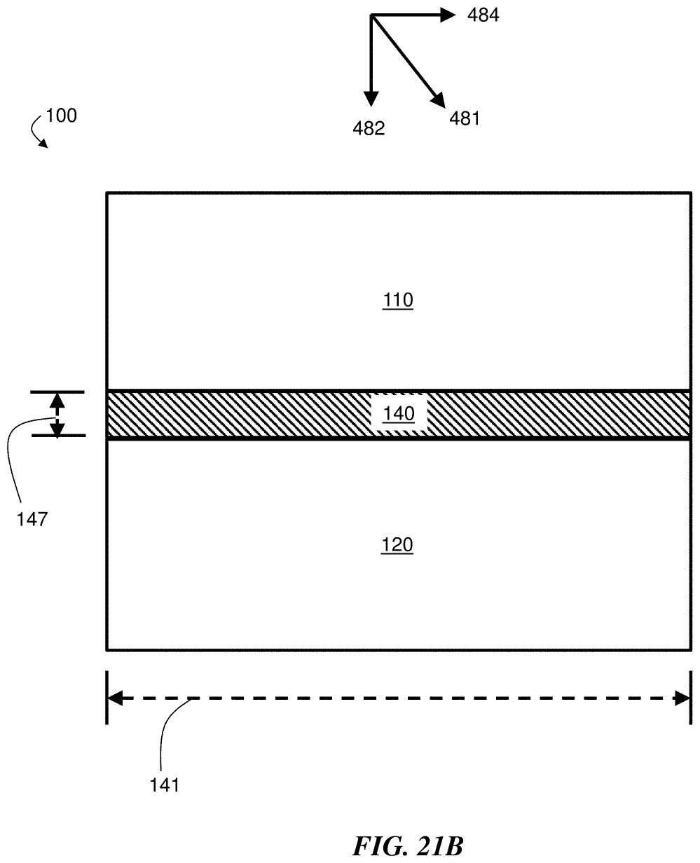

FIGS. 21A-21B show cross-sectional schematic diagrams of battery pack 100 in the absence (FIG. 21A) and presence (FIG. 21B) of an anisotropic force in the direction of arrow 481, with a component 482 normal to an electrochemical cell. The anisotropic force in the direction of arrow 481 may also have a component 484 parallel to an electrochemical cell. As described above, in some cases, at least a portion of the anisotropic force is applied by a pressure device such as solid plate (e.g., an endplate). In some instances, at least a portion of the anisotropic force is caused by a change in dimension (e.g., expansion) of one or more components of the battery pack. For example, in some cases a charging process of the battery pack causes one or more electrochemical cells (e.g., the first electrochemical cell, the second electrochemical cell) to expand in a thickness direction. One such example is in certain cases where a lithium metal and/or a lithium metal alloy is used as an anode active material, and lithium deposition on the anode occurs during charging.

In some embodiments, the application of force to the thermally insulating compressible solid article portion (e.g., via the first electrochemical cell and/or the second electrochemical cell or an intervening battery pack component) causes the thermally insulating compressible solid article portion to compress in the thickness direction. Referring again to FIGS. 21A-24B, for example, thermally insulating compressible solid article portion 140 may have uncompressed thickness 146 in the absence of an applied anisotropic force (as shown in FIG. 21A) and smaller compressed thickness 147 when anisotropic force 481 is applied and/or when expansion of first electrochemical cell 110 and/or second electrochemical cell 120 occurs.

In some embodiments, the thermally insulating compressible solid article portion has a relatively low compression set. The compression set of an article generally refers to the amount of permanent (plastic) deformation that occurs when the article is compressed to a given deformation, for a given amount of time, at a given temperature. Compression set of an article can be measured, for example using ASTM D395. For elastomeric materials, having a low compression set is associated with an ability for the material to maintain elastic properties even after prolonged compressive stress. Having a relatively low compression set may be beneficial, in some cases, where it is desired that the thermally insulating compressible solid article portion be able to regain at least a portion of its thickness when an applied compressive stress is removed. As an example, in some cases where the thermally insulating compressible solid article portion is compressed due to an expansion of an electrochemical cell in the battery pack, a subsequent contraction of the electrochemical cell may reduce the compressive stress applied. Having a relatively low compression set may then allow the thermally insulating compressible solid article to expand in thickness as the electrochemical cell contracts, thereby compensating for the change in dimension. In some embodiments, the thermally insulating compressible solid article portion has a compression set of less than or equal 15%, less than or equal to 12%, or less. In some embodiments, the thermally insulating compressible solid article portion has a compression set of less than or equal to 10%, less than or equal to 5%, or less. In some embodiments, the thermally insulating compressible solid article portion has a compression set of greater than or equal to 1%, greater than or equal to 2%, or more. Combinations of these ranges are possible. For example, in some embodiments, the thermally insulating compressible solid article portion has a compression set of greater than or equal to 1% and less than or equal to 10%. In some embodiments, the thermally insulating compressible solid article portion has a compression set value in one of the ranges above determined using a constant force measurement (e.g., ASTM D395 Test Method A). In some embodiments, the thermally insulating compressible solid article portion has a compression set value in one of the ranges above determined using a constant displacement measurement (e.g., ASTM D395 Test Method B).

In some embodiments, the thermally insulating compressible solid article portion has a relatively high compressibility. The compressibility of an article generally refers to the relative dimensional change of an article as a response to a change in compressive stress. In some instances, for example, the change in thickness 147 relative to thickness 146 in FIGS. 21A-21B is relatively large for a given magnitude of compressive stress (e.g., when the force from arrow 481 is applied). In some embodiments, at a compressive stress of 12 kg_{f}/cm², the percent compression of the thermally insulating compressible solid article portion is at least 30%, and at a compressive stress of 40 kg_{f}/cm², the percent compression of the thermally insulating compressible solid article portion is at least 80%. In some embodiments, at a compressive stress of 12 kg_{f}/cm², the percent compression of the thermally insulating compressible solid article portion is at least 30%, and at a compressive stress of 40 kg_{f}/cm², the percent compression of the thermally insulating compressible solid article portion is at least 50%.

The compressive response of a thermally insulating compressible solid article portion may be considered as a compressive stress versus percent compression curve. The thermally insulating compressible solid article portion may have a compressive stress versus percent compression curve that is suitable for a battery pack in which a high magnitude of anisotropic force with a component normal to one or more of the electrochemical cells is applied. In some instances, the thermally insulating compressible solid article portion has a compressive stress versus percent compression curve that is suitable for a battery pack in which one or more electrochemical cell undergoes a relatively high change in dimension during charging and discharging (e.g., such as certain electrochemical cells comprising lithium metal and/or lithium metal anode active materials).

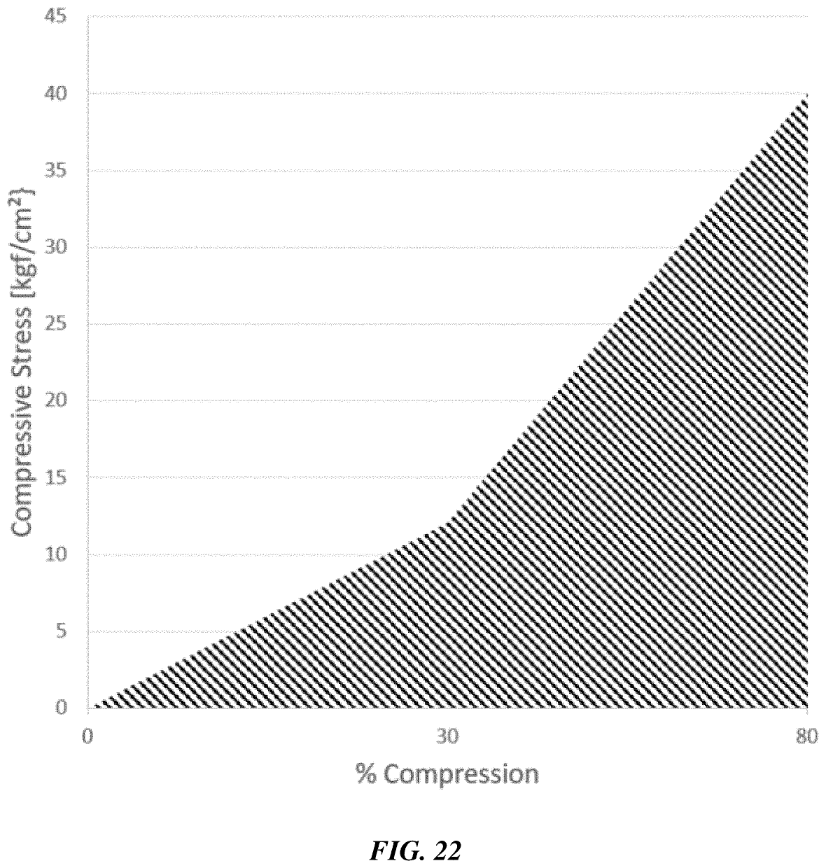

In some such embodiments, the thermally insulating compressible solid article has a compressive stress versus percent compression curve in the hatched region of FIG. 22. It should be understood that a curve is considered to be in the hatched region if it is in the interior of the hatched region or at a boundary of the hatched region. In some embodiments, at least 50%, at least 75%, at least 90%, or more of the x-axis values of the compressive stress versus percent compression curve of the thermally insulating compressible solid article portion is in the hatched region. For example, if a compressive stress versus percent compression curve is measured for a sample for 100 equally spaced compression values between 0% and 80% (i.e., x-axis increments of 0.8%), and the measured compressive stress falls within the hatched region of FIG. 22 for at least 50 of the 100 compression values measured, then at least 50% of the x-axis value of the compressive stress versus percent compression curve of that sample is in the hatched region. In some embodiments, the thermally insulating compressible solid article has a compressive stress versus percent compression curve in the hatched region of FIG. 22 for x-axis values of greater than or equal to 1%, greater than or equal to 10%, greater than or equal to 20%, greater than or equal to 30%, greater than or equal to 40%, and/or up to 50%, up to 60%, up to 80%, or greater. Combinations of these ranges (e.g., x-axis values of greater than or equal to 1% and less than or equal to 80% or greater than or equal to 30% and less than or equal to 50%) are possible. Properties that may affect the compressive stress versus percent compression curve of a thermally insulating compressible solid article portion include intrinsic properties (e.g., uncompressed density) and extrinsic properties (e.g., thickness).

The measurement of the compressive stress versus percent compression curve (as shown in FIG. 22) of a sample may be conducted as follows. The compression rate may be, for example, greater than or equal to 0.001 mm/s, greater than or equal to 0.05, and/or up to 0.1 mm/s using a modified version of ASTM D3574.

In some embodiments, the thermally insulating compressible solid article portion has a relatively high resilience. The resilience of an article generally refers to the percentage of energy released when a deformed object recovers from deformation relative to the energy required to produce the deformation. Resilience can be measured, for example, using ASTM D3574 Test H (a ball drop resilience measurement). A relatively high resilience may contribute to the thermally insulating compressible solid article portion being durable under multiple repeated compressions and decompression of the battery pack (e.g., during charging and discharging). In some embodiments, the thermally insulating compressible solid article portion has a resilience of at least 60%, at least 65%, at least 75%, at least 90%, at least 95%, or more. In some embodiments, the thermally insulating compressible solid article portion has both a relatively high compressibility and a relatively high resilience (e.g., with values in the ranges described above), which may contribute to a high extent of compensation of dimensional changes in the battery pack while also being durable.

In some embodiments, the thermally insulating compressible solid article portion has a relatively high dynamic continuous load limit. A dynamic continuous load limit generally refers to the maximum compressive stress applied to the article before failure occurs. Having a relatively high dynamic continuous load limit may be useful in some embodiments where a relatively high magnitude of anisotropic force with a component normal to one or more electrochemical cells of the battery pack is applied, or where one or more of the electrochemical cells undergoes a relatively large expansion during cycling. In some embodiments, the thermally insulating compressible solid article portion has a dynamic continuous load limit of greater than or equal to 30 kg_{f}/cm², greater than or equal to 35 kg_{f}/cm², greater than or equal to 40 kg_{f}/cm², and/or up to 45 kg_{f}/cm², or greater.

In some embodiments, the thermally insulating compressible solid article portion has a relatively low uncompressed mass density. A low mass density may contribute, at least in part, to the battery pack having a relatively high specific energy density. The uncompressed mass density of the thermally insulating compressible solid article portion refers to the bulk mass per unit volume of the article portion in the absence of a load (e.g., compressive stress). In some embodiments, the thermally insulating compressible solid article portion has an uncompressed mass density of greater than or equal to 0.3 g/cm³, greater than or equal to 0.35 g/cm³, greater than or equal to 0.4 g/cm³, greater than or equal to 0.45 g/cm³, greater than or equal to 0.5 g/cm³, and/or up to 0.55 g/cm³, up to 0.6 g/cm³, up to 0.65 g/cm³, up to 0.7 g/cm³, or greater at 25° C.

The thermally insulating compressible solid article portion can be made of any of a variety of suitable materials, provided that it have one or more of the combinations of thermal and mechanical properties in the present disclosure. In some embodiments, the thermally insulating compressible solid article portion comprises a polymeric material. A relatively large percentage of the thermally insulating compressible solid article portion may be made of a polymeric material. For example, greater than or equal to 50 wt %, greater than or equal to 75 wt %, greater than or equal to 90 wt %, greater than or equal to 95 wt %, greater than or equal to 99 wt %, or more (e.g., 100 wt %) of the thermally insulating compressible solid article portion may be made of a polymeric material. In certain embodiments, the thermally insulating compressible solid article portion comprises a polymeric foam, such as a microcellular polymeric foam.

While any of a variety of polymeric materials may be suitable, in certain instances the thermally insulating compressible solid article portion comprises a relatively elastic polymer. In some embodiments, the thermally insulating compressible solid article portion is or comprises an elastomer. As one non-limiting example, the thermally insulating compressible solid article portion may comprise a polyurethane. Polyurethanes are polymers comprising organic repeat units linked by carbamate (urethane) units. Polyurethanes can be made using any of a variety of techniques, such as by reacting isocyanates and polyols. In some embodiments, the thermally insulating compressible solid article portion is or comprises a microcellular polyurethane foam (e.g., foam sheet or foam layer). Referring to FIG. 19, for example, battery pack 100 may comprise first electrochemical cell 110, second electrochemical cell 120, and thermally insulating compressible solid article portion 140 between first electrochemical cell 110 and second electrochemical cell 120, where thermally insulating compressible solid article portion 140 is an elastomeric microcellular foam layer or sheet made of polyurethane. One non-limiting example of an elastomeric microcellular polyurethane foam that can be used as a thermally insulating compressible solid article portion is sold by BASF under the trade name Cellasto®.

The thermally insulating compressible solid article may have a thickness as well as two orthogonal lateral dimensions that are orthogonal to each other as well as orthogonal to the thickness. For example, referring to FIG. 21A, thermally insulating compressible solid article portion 140 has thickness 146, lateral dimension 141, and a second lateral dimension (not pictured) orthogonal to both thickness 146 and lateral dimension 141 (which would run into and out of the plane of the drawing in FIG. 21A). As mentioned above, the thermally insulating compressible solid article may have an uncompressed thickness (e.g., uncompressed thickness 146 in FIG. 21A) and a compressed thickness (e.g., compressed thickness 147 FIG. 21B), with the latter depending in some cases on the magnitude of an applied force.

The dimensions of the thermally insulating compressible solid article portion may be chosen based on any of a variety of considerations. For example, the thickness (e.g., uncompressed thickness) or lateral dimensions may be chosen based on the desired total size of the battery pack and/or a desired pack burden (defined as one minus the mass of the electrochemical cells of the battery pack divided by the total mass of the battery pack). In some embodiments, the uncompressed thickness of the thermally insulating compressible solid article portion is such that a sufficient amount of compression can occur (e.g., to compensate for expansion of the first electrochemical cell and/or second electrochemical cell during cycling).

In some embodiments, the thermally insulating compressible solid article portion has an uncompressed thickness of greater than or equal to 1 mm, greater than or equal to 2 mm, greater than or equal to 3 mm, greater than or equal to 4 mm, greater than or equal to 5 mm, greater than or equal to 5.5 mm, greater than or equal to 6 mm, or greater. In some embodiments, the thermally insulating compressible solid article portion has an uncompressed thickness of less than or equal to 10 mm, less than or equal to 9 mm, less than or equal to 7 mm, less than or equal to 6 mm, less than or equal to 5 mm, less than or equal to 3 mm, or less. Combinations of these ranges are possible. For example, in some embodiments, the thermally insulating compressible solid article portion has an uncompressed thickness of greater than or equal to 1 mm and less than or equal to 10 mm, greater than or equal to 1 mm and less than or equal to 5 mm, or greater than or equal to 2 mm and less than or equal to 3 mm.

In some embodiments the thermally insulating compressible solid article portion has one or more lateral dimension of greater than or equal to 50 mm, greater than or equal to 65 mm, greater than or equal to 80 mm, and/or up to 90 mm, up to 100 mm, up to 200 mm, or more. In some embodiments, the thermally insulating compressible solid article portion has at least one lateral dimension that is at least 5 times, at least 10 times, and/or up to 20 times, up to 50 times, up to 100 times or more greater than the uncompressed thickness of the thermally insulating compressible solid article portion.

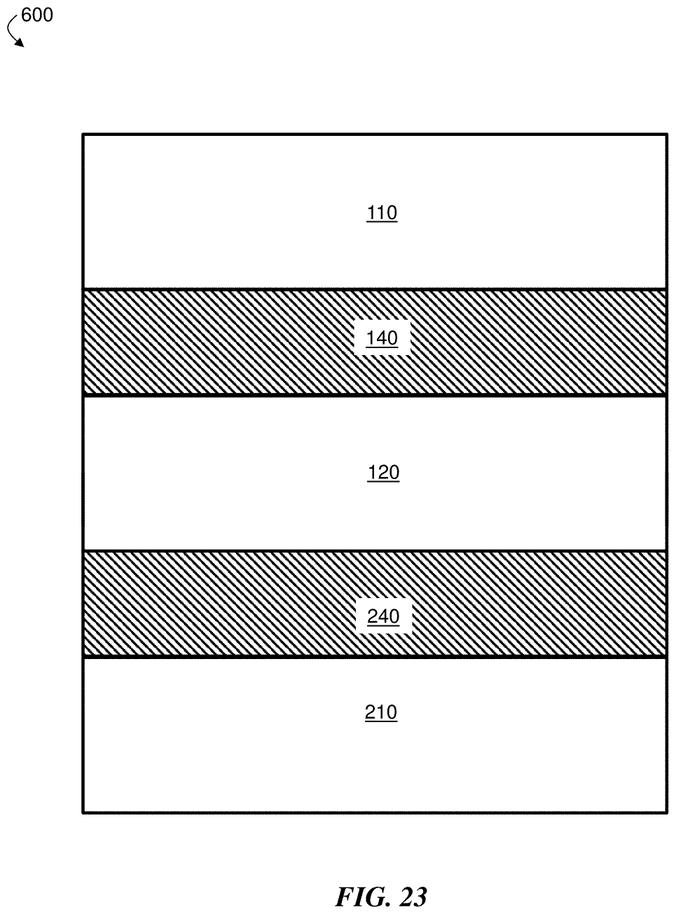

In some embodiments, the battery pack has more than one thermally insulating compressible solid article portion. For example, in some embodiments, the battery pack comprises a third electrochemical cell, and a second thermally insulating compressible solid article portion between the second electrochemical cell and the third electrochemical cell. FIG. 23 shows a cross-sectional schematic diagram of one such embodiment, where battery pack 600 comprises, in order: first electrochemical cell 110, first thermally insulating compressible solid article portion 140, second electrochemical cell 120, second thermally insulating compressible solid article portion 240, and third electrochemical cell 210. It should be understood that the battery pack may not be limited to three electrochemical cells, and may comprise at least 1, at least 2, at least 3, at least 5, at least 8, at least 10, at least 12, at least 18, at least 24, at least 30, at least 36 and/or up to 42, up to 48, or more electrochemical cells.

In some cases, the total number of thermally conductive solid article portions is equal to the total number of electrochemical cells in the stack of electrochemical cells (e.g., 12 electrochemical cells and 12 thermally conductive solid article portions, or 36 electrochemical cells and 36 thermally conductive solid article portions). In some such cases, the total number of thermally insulating compressible solid article portions is equal to one more than the total number of electrochemical cells in the battery pack (e.g., 12 electrochemical cells and 13 thermally insulating compressible solid article portions). For example, there may be an electrochemical cell between each of the thermally insulating compressible solid article portions.

In some embodiments, the first thermally insulating compressible solid article portion and the second thermally insulating compressible solid article portion are part of discrete articles. Referring again to FIG. 23, in some embodiments first thermally insulating compressible solid article portion 140 and second thermally insulating compressible solid article portion 240 are separate, discrete articles (e.g., separate foam sheets). However, in some embodiments, the first thermally insulating compressible solid article portion and the second thermally insulating compressible solid article portion are part of the same article. For example, first thermally insulating compressible solid article portion 140 and second thermally insulating compressible solid article portion 240 may be connected via a third thermally insulating compressible solid article portion hidden behind second electrochemical cell 120 in FIG. 23. As one example, the battery pack may comprise a thermally insulating compressible solid article that is foldable and/or has a serpentine shape such that electrochemical cells and/or other components of the battery pack can be arranged between portions of the thermally insulating compressible solid article.

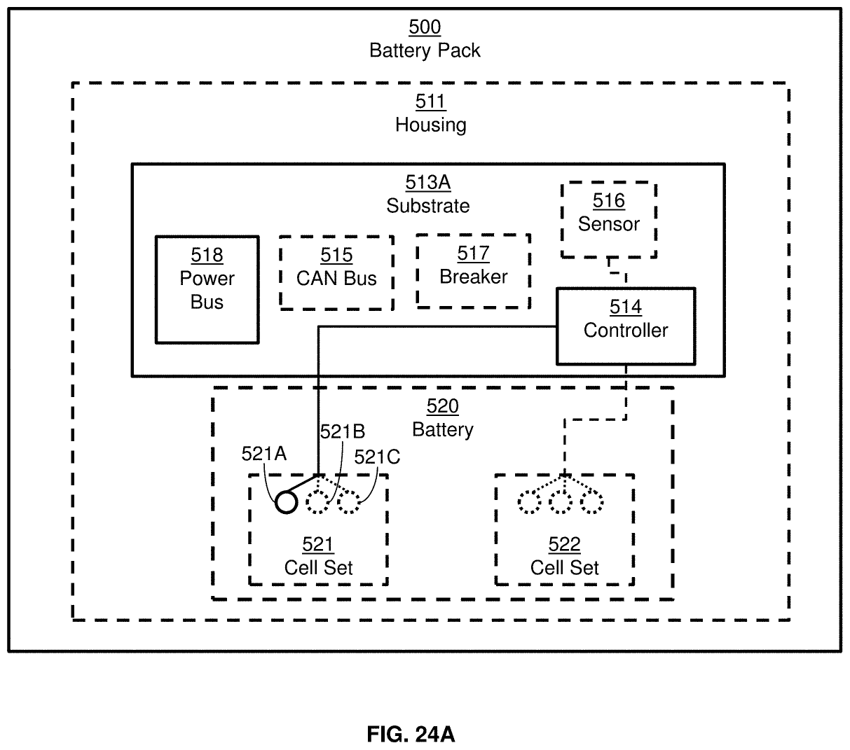

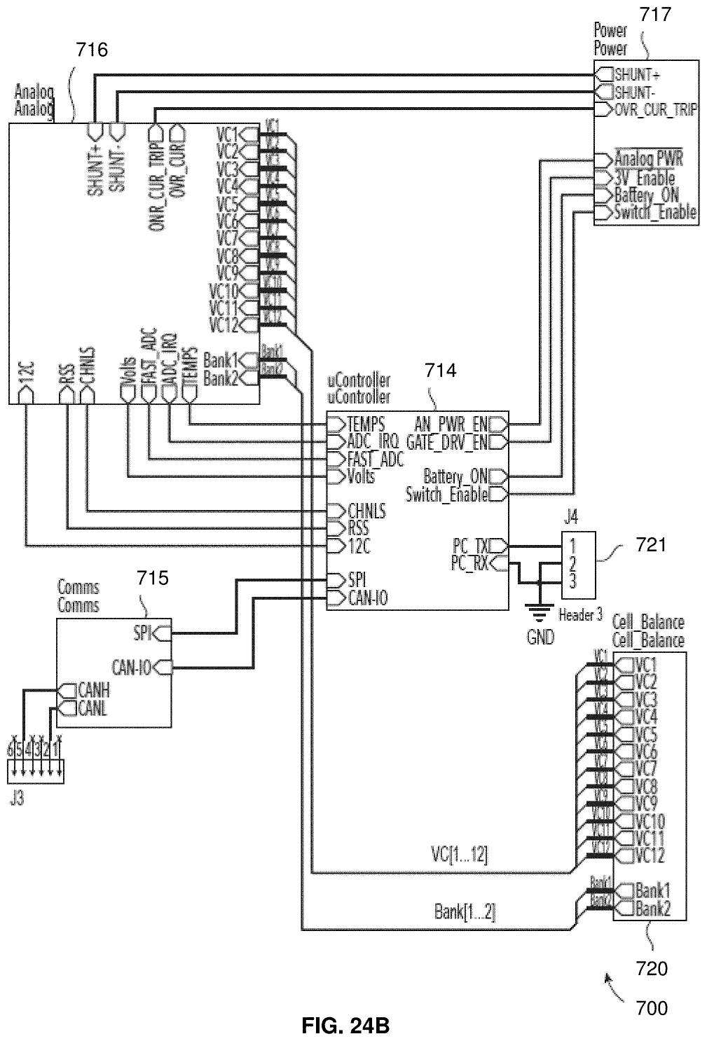

FIG. 24A depicts a representative battery pack 500. In some embodiments, representative battery pack 500 may include a pack controller (e.g., 514) and an electrochemical cell (e.g., 521A). In some embodiments, cell 521A may be present alone. In other embodiments, additional cells (e.g., optional cells 521B and 521C in FIG. 24A) and/or additional cell sets (e.g., optional cell set 522 in FIG. 24A in addition to cell set 521) may be present (e.g., to form battery 520). In some embodiments, the controller may include one or more processors, which may be of whatever complexity is suitable for the application. Alternatively or additionally, the controller may include an analog circuit and/or a less complex logic device than a processor or microprocessor. In some embodiments, battery pack 500 may include a substrate (e.g., 513A), which may include a battery power bus (e.g., power bus 518) for the battery pack integrated into the substrate. For example, the battery power bus may be permanently physically attached to or embedded into the substrate, such that it cannot be detached without removing or deforming (e.g., plastically deforming) material between the battery power bus and the substrate. In some embodiments, the battery power bus may include copper that is physically part of the substrate. For example, the battery power bus may be plated on to the substrate like traces and component footprints, but with a much greater thickness (e.g., at least 0.3 millimeters in thickness).

In some embodiments, the controller may interact with the power bus by measuring cell or cell group voltages and/or power bus current. In some embodiments, the controller may interact with the power bus by balancing cells or cell groups (which may also be called “cell sets” herein), connecting/disconnecting the power bus to/from the load, and/or measuring power bus temperatures.

In some embodiments, the substrate may be or include a printed circuit board. In some embodiments, the substrate may include a controller area network (CAN) bus (e.g., 515) and at least one circuit breaker (e.g., 517), all in a single board. Additionally, the substrate may include at least one electrochemical cell terminal to which the cell(s) may be connected. For example, the cell terminal(s) may rise directly out of the substrate.

In some embodiments, the cell(s) may be connected directly to the substrate. In some embodiments, the substrate may be physically connected to the cell(s) (which could be one or any number of cells) without wires, such as via a physical connection between the cell(s) and the power bus. The inventors have recognized and appreciated that, in accordance with certain embodiments, using this physical connection instead of wires may reduce the connection distance (e.g., the distance may be just the distance between cells, instead of having to go up and through bus), thereby reducing resistance and resulting waste heat and other inefficiencies, such as voltage loss.

In some embodiments, a physical connection between the substrate (via the power bus or otherwise) and the cell(s) may provide heat transfer to and/or from the cell(s). In some embodiments, the physical connection between the substrate and the cell(s) may provide heat transfer directly between multiple cells, and/or directly between the cell(s) and the substrate in either direction. Examples of these heat transfers are described in relation to FIGS. 2A-2D. In some embodiments, a heat transfer pathway is created between the cell(s) themselves and between the substrate and the cell(s) along the tabs of the cell(s) (e.g., 560 in FIGS. 2A-2D) into the vias (e.g., 565) of the substrate.

In some embodiments, cell(s) may be connected to the substrate at least in part by laser welding. In some embodiments, this laser welding or another kind of welding or permanent attachment may create the physical connection that provides the heat transfer to and/or from the cell(s). For example, ultrasonic, friction, and/or resistance welding may be used in addition to or alternatively to laser welding (or any other precision metal connection technique) to create the physical connection. In some embodiments, the physical connection may be both electrically and thermally low-resistance. For example, the physical connection may have on average an electrical resistivity of 3*10⁻⁸ ohm-meters or less and a thermal conductivity of 200 watts per meter-kelvin or more.

Various materials may be used to create the physical connection, such as thermally and electrically conductive materials. In some embodiments, the material(s) used to create the physical connection may provide a heat flux of at least 1500 watts per square meter through the connection when the cell(s) have a temperature of 100 degrees Celsius and the substrate has a temperature of 25 degrees Celsius. In some embodiments, materials like copper, aluminum, and/or stainless steel may be used for the physical connection.

In some embodiments, battery pack 500 may include a housing in which the at least one electrochemical cell and the substrate are disposed.

Optionally, battery pack 500 may include one or more sensors (e.g., 516). It should be appreciated that although only a single controller 514 and a single sensor 516 are shown in FIG. 24A, any suitable number of these components may be used. Any of numerous different modes of implementation may be employed.

In some embodiments, the controller may determine (e.g., using sensor 516) and/or communicate (e.g., using CAN bus 515) various information. Examples of this information include temperature information of the battery pack, voltage and/or current information of the cell(s) in the battery pack, balancing information of the battery pack, charging information of the battery pack, diagnostic information of the battery pack, and health information of the battery pack. The inventors have recognized and appreciate that, in accordance with certain embodiments, any of this various information may be more reliable due to it being obtained locally (e.g., on the single substrate) rather than sent from a remote location via wires.

In some embodiments, the power bus may include at least one layer of conductive material embedded in the substrate. In some embodiments, the layer(s) may be either or both thermally and electrically conductive. For example, the substrate may have embedded heavy copper inner layers, and, in some embodiments, heavy copper upper layers (e.g., the substrate may include up to 30 ounces of copper on each side). In some embodiments, the mass of the embedded inner layers (such as copper) may be between 10 and 30 ounces per square foot.

In some embodiments, the substrate itself may be thermally conductive. For example, the substrate may have a thermal conductivity of at least 200 watts per meter kelvin, such as between 350 and 400 watts per meter-kelvin. The inventors have recognized and appreciated that, in accordance with certain but not necessarily all embodiments, this may further improve heat management, including removal of waste heat and utilization of heat transfer where desirable. Thermal conductivity of the substrate and/or the power bus may be measured using any suitable method according to some embodiments, including steady-state methods and transient methods (such as the transient hot wire method). However, in some embodiments, the substrate itself has a relatively low thermal conductivity. For example, the substrate may have a thermal conductivity of less than or equal to 100 watts per meter kelvin, less than or equal to 50 watts per meter kelvin, less than or equal to 20 watts per meter kelvin, less than or equal to 10 watts per meter kelvin, less than or equal to 5 watts per meter kelvin, and/or as low as 3 watts per meter kelvin, as low as 2 watts per meter kelvin, or lower. For example, the substrate, in some instances, comprises a composite material having a relatively low thermal conductivity. One non-limiting example is of such a composite is one comprising woven fiberglass close with a binder (e.g., an epoxy resin binder). One such example is FR-4.

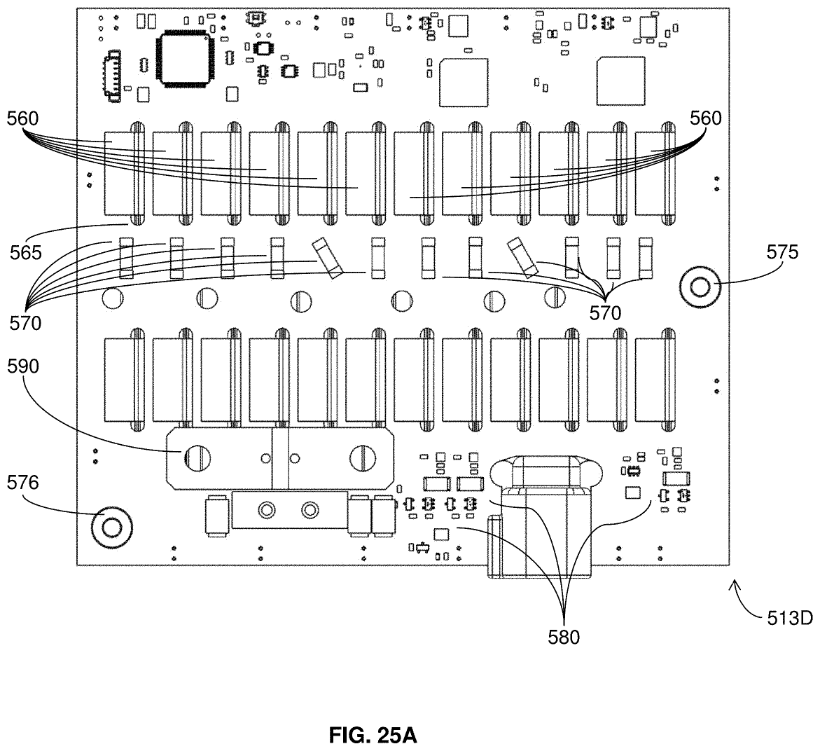

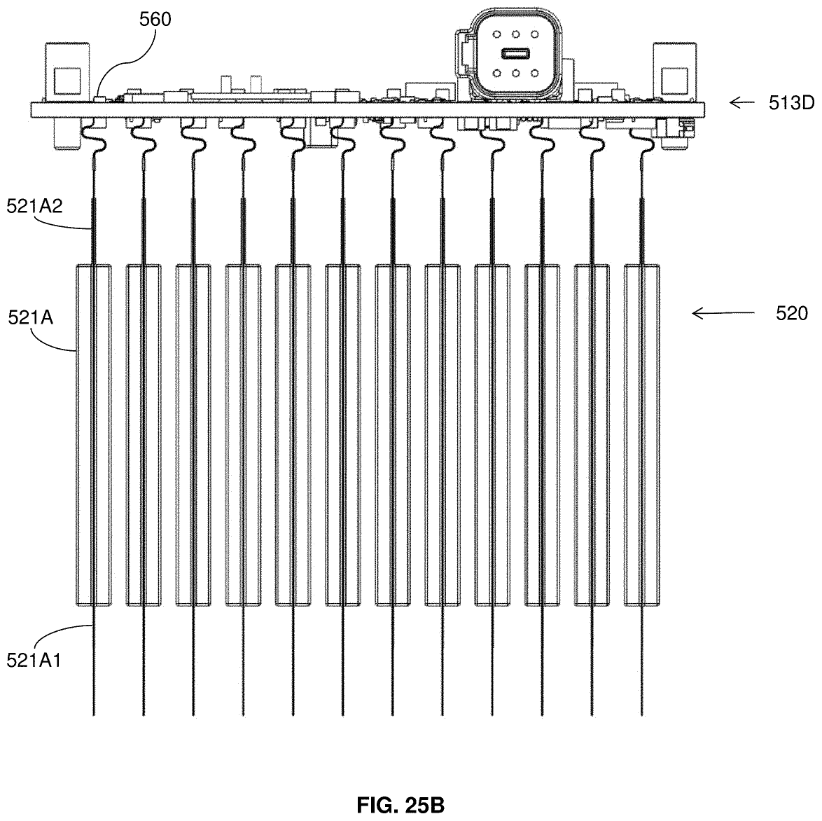

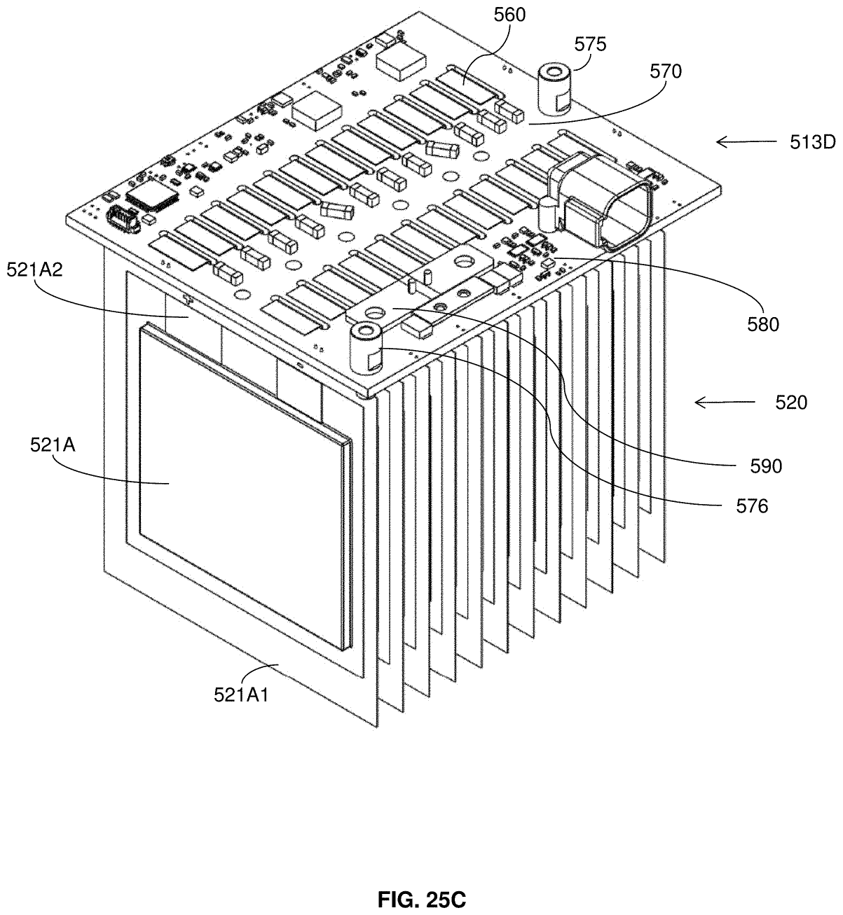

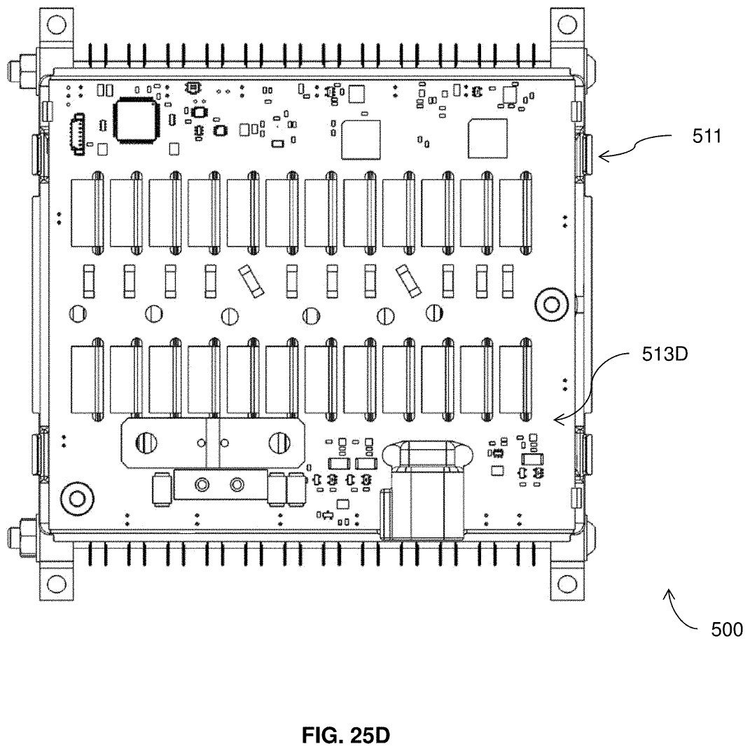

In some embodiments, the cell(s) may include alignment features that allow the substrate to be fitted on top of the cell(s) and/or allow the cell(s) to be inserted into the substrate. In some embodiments, the substrate includes at least one opening into which at least a portion of the cell(s) are inserted. For example, tab(s) of the cell(s) may be pulled through the opening(s) or inserted into them. In some embodiments, the tabs may be straight along the same axis as the cells, and then bent or otherwise rotated or deformed to make contact with the substrate (see FIGS. 25A-25D for exemplary configurations and orientations of cells and tabs within a substrate).

In some embodiments, the controller may balance charge and/or discharge between multiple cells. In some embodiments, the controller turns the balancing on or off, and the balancing is achieved at least in part through circuitry that is part of the battery management system. For example, the controller may ensure that the cell(s) attain the same state and/or depth of charge and/or discharge using passive balancing and/or active balancing. In some embodiments, balancing may be performed “at top of charge” such that when a cell reaches maximum charge voltage, it may be bypassed so other cells in series with it come up to that voltage value. Alternatively or additionally, balancing may be performed at “bottom of charge” or any other suitable configuration.

In some embodiments, the controller may use active balancing, such as by taking charge from either the entire battery pack or a cell that has more charge and give it to cell(s) with less charge, which can be done at any point of a cycle.

According to some embodiments, the cell(s) may include at least one lithium-metal electrode active material. Additionally, each set of cells (e.g., cell set 521) may include one or more cells (e.g., 521A-521C). In some embodiments, each set of cells may have a single cell. Alternatively, each set of cells may include multiple cells and may form a cell “block,” or multiple sets of cells may together form a cell block.

FIG. 24B depicts a representative wiring diagram of a battery management system 700. In some embodiments, system 700 may include at least one controller, such as microcontroller and associated circuitry 714, which may be similar to other controllers described elsewhere herein. In some embodiments, system 700 may include at least one communication bus, such as CAN Bus 715, which may be similar to CAN Bus 715 described elsewhere herein. In some embodiments, system 700 may include at least one conditioning and measurement component, such as circuitry 716, which may be similar to sensor 716 described elsewhere herein. In some embodiments, circuitry 716 may perform signal conditioning and measurement of characteristics such as voltages, temperatures, and currents.

In some embodiments, system 700 may include at least one communication bus, such as power circuitry 717, which may be similar to breaker 517 described elsewhere herein. In some embodiments, power circuitry 717 may provide circuit breaking, power supplying, shunts, and so on. In some embodiments, system 700 may include at least one balancing component, such as balancing circuitry 720. In some embodiments, balancing circuitry 720 may perform cell grouping and cell group balancing. In some embodiments, system 700 may include at least one interface, such as interface 721, which may include a serial interface, such as for transistor-transistor logic serial communication.

In some embodiments, any combination of the components in FIG. 24B, including all of them, may be included on a single substrate (e.g., a PCB). The inventors have recognized and appreciated that, in accordance with certain embodiments, including such components, like the balancing component, on a single substrate may reduce the risk of fire, especially as the components may be connected without wires (which can themselves catch fire) as described elsewhere herein.

FIG. 25A depicts a representative substrate (e.g., 513D) and battery (of which cell tabs are shown with 560 as one example) from a top view. In some embodiments, the substrate may include at least one cell group balance circuit, such as the three cell group balance circuits 580, which may be similar to balancing circuitry 720 described elsewhere herein. In some embodiments, the substrate may include at least one current measuring component, such as shunt 590, which may measure current going through connected components. In some embodiments, the substrate may include at least one fusing circuitry, such as the numerous fuses 570, which may be placed between the cell tabs 560 or in any other suitable position. In some embodiments, the fuses may each protect a cell, providing additional protection beyond the circuit breaker(s) described elsewhere herein.

In some embodiments, the substrate may include at least one PCB via, such as the numerous vias 565. In some embodiments, the substrate may include at least one battery post, such as positive battery post 575 and negative battery post 576.

FIG. 25B depicts the representative substrate and battery pack from a side view. In some embodiments, the battery (e.g., 520) may include at least one cell, such as cell 521A and the numerous other cells shown in FIG. 25B. In some embodiments, the cell(s) may include at least one tab, such as tab 560. In some embodiments, the cell(s) may include at least one active area, such as the full width active area pouch section 521A1. In some embodiments, the cell(s) may include at least one seal area, such as pouch seal area 521A2.

FIG. 25C depicts the representative substrate and battery from a perspective view, including elements shown in FIGS. 25A-25B from another view.

FIG. 25D depicts a representative battery pack (e.g., 500) from a top view. In some embodiments, the battery pack may include a housing, such as housing 511 (e.g., as described elsewhere herein).

In some embodiments, each set of cells may have a single cell. Alternatively, each set of cells may include multiple cells and may form a cell “block,” or multiple sets of cells may together form a cell block. Additionally, each cell (either in a battery, all the batteries in a battery pack, or in a set of cells) or set of cells may utilize the same electrochemistry. That is to say, in some embodiments, each cell may make use of the same anode active material and the same cathode active material.

In some embodiments, the controller may use the multiplexing switch apparatus to selectively discharge and charge the cells or sets of cells at different, programmable rates. For example, the controller may use the multiplexing switch apparatus to selectively discharge the cells or sets of cells at a first rate at least 2 times higher than a second rate of charging the sets of cells (i.e., discharging twice as fast as charging). Alternatively or additionally, the first rate of discharging may be at least 4 times higher than the second rate of charging the sets of cells (i.e., discharging four times as fast as charging). The inventors have recognized and appreciated that, in accordance with certain embodiments, such ratios of discharge rate to charge rate may improve the performance and cycle life of the cells.

In some embodiments, the load may be at least one component of a vehicle. The vehicle may be any suitable vehicle, adapted for travel on land, sea, air, and/or space. For example, the vehicle may be an automobile, truck, motorcycle, boat, helicopter, airplane, rocket, spaceship, and/or any other suitable type of vehicle.

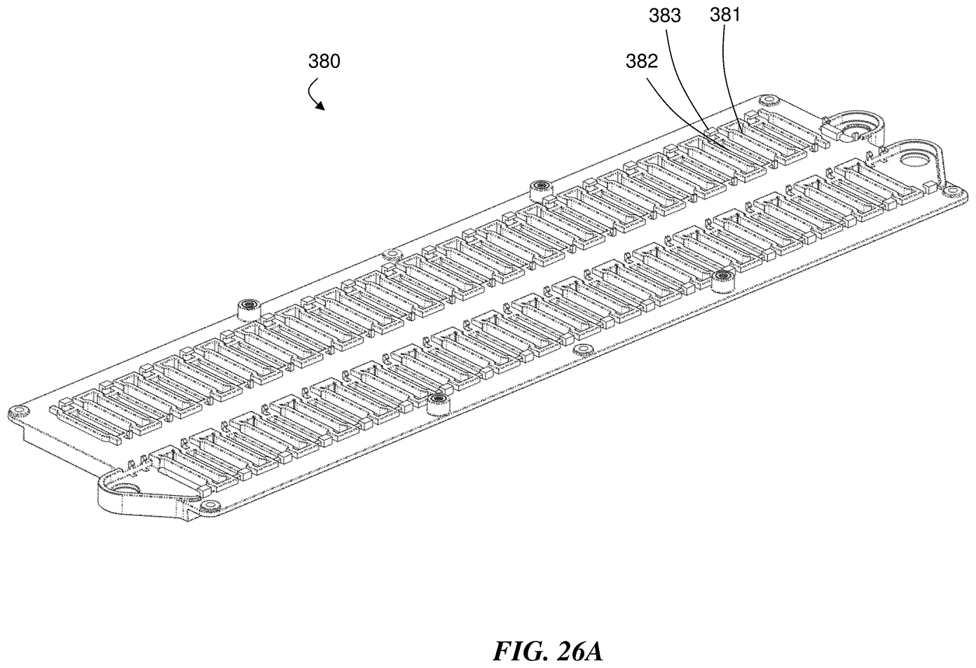

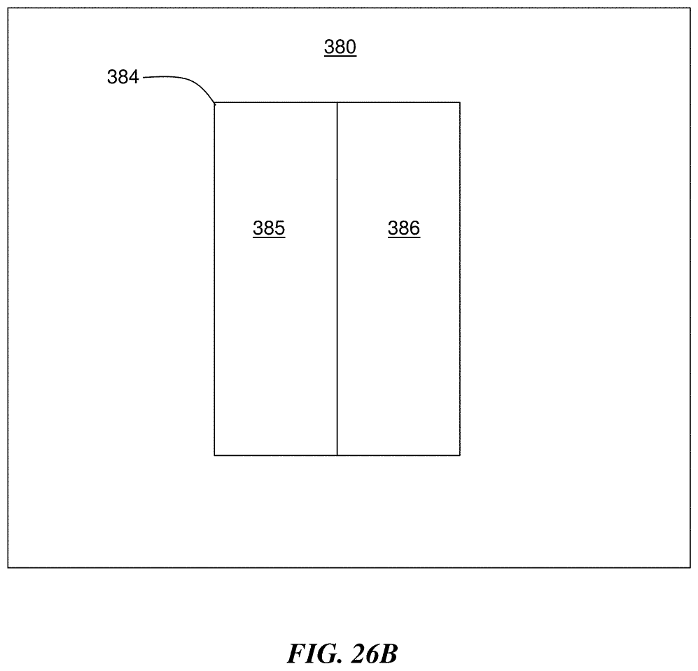

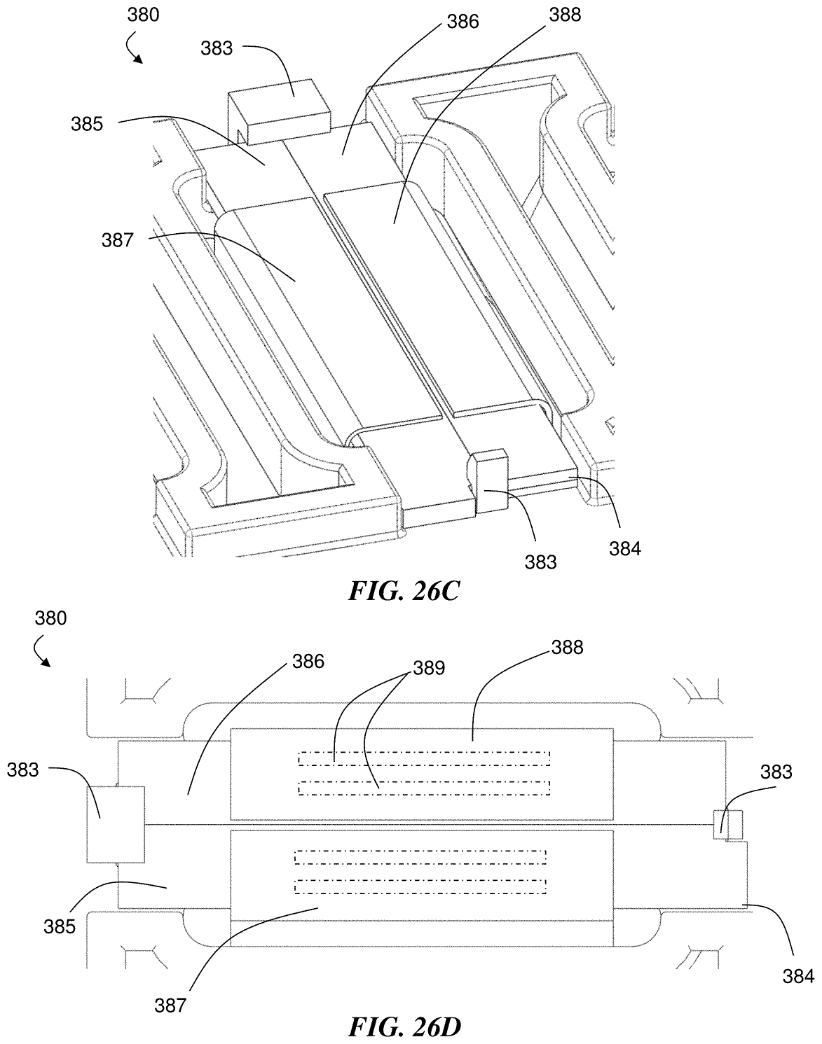

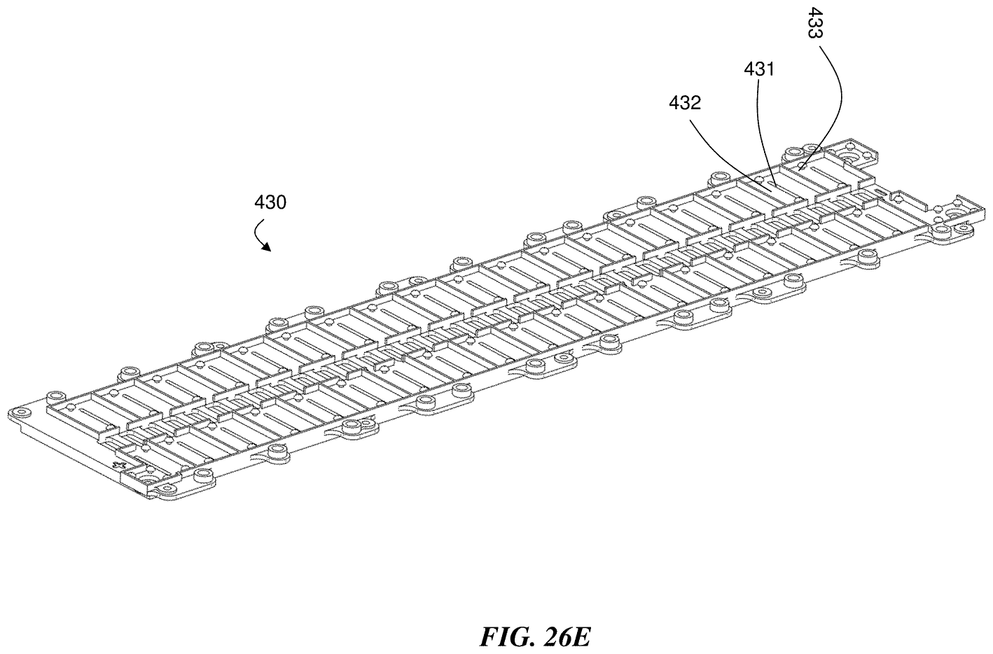

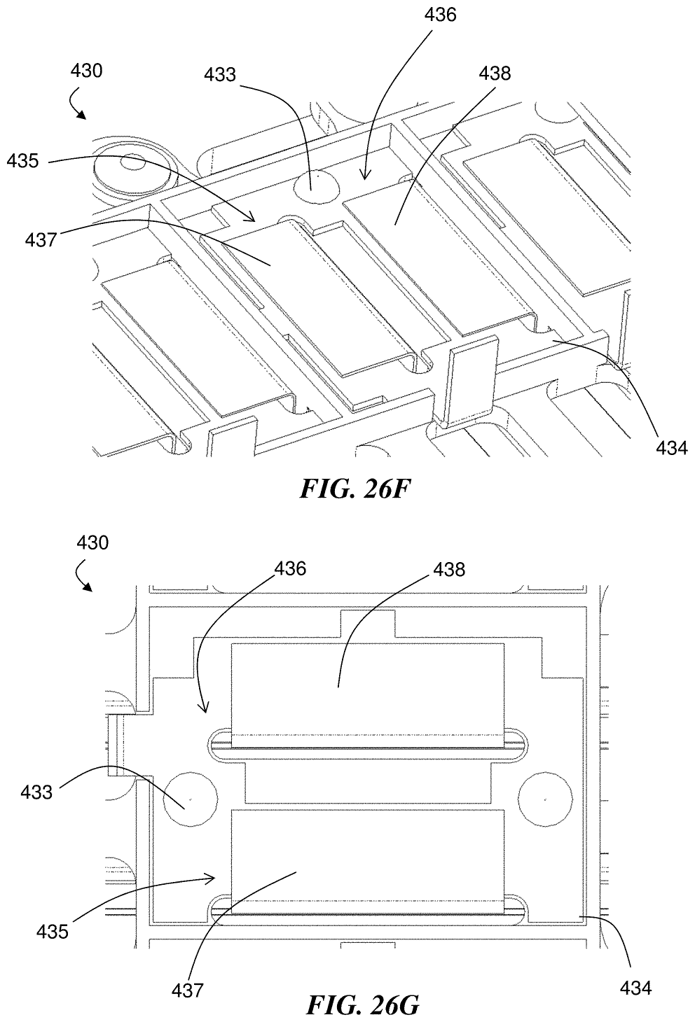

As mentioned above, the housing of the battery pack may comprise a substrate for facilitating electronic connections. In some embodiments, the battery pack comprises a substrate to which a tab of the first electrochemical cell and/or the second electrochemical cell can be connected. FIG. 26A shows a perspective view schematic illustration of substrate 380 to which tabs from electrochemical cells of the battery pack can be connected, according to some embodiments. The substrate may comprise spaces through a thickness of the substrate shaped such that one or more tabs from electrochemical cells of the battery pack can pass through from a bottom of the substrate (facing an interior of the housing) to the top of the substrate (facing away from the housing). For example, in some embodiments, substrate 380 comprises spaces 381 through which tabs from electrochemical cells can pass through. While substrate 380 has 36 spaces 381 to accommodate 36 electrochemical cells, other numbers of cells and spaces 381 can be used, depending on the desired attributes of the battery pack (e.g., desired total voltage, desired energy storage capacity, etc.).

The substrate may have locations between the above-mentioned spaces for electronically conductive interconnects. In some embodiments, the battery pack comprises an electronically conductive interconnect on the substrate connected to at least one tab of an electrochemical cell (e.g., the first electrochemical cell and/or the second electrochemical cell). Electronically conductive interconnects, which can be made of one or more electronically conductive solid materials, may be discrete objects separable from the substrate, or may be fabricated such that they are part of the substrate (e.g., the substrate may be molded at least partially surrounding the interconnects). When tabs from electrochemical cells pass through the spaces of the substrate, the tabs may then be connected to the electronically conductive interconnects to establish electronic connections (e.g., to an electronic circuit). In FIG. 26A, substrate 380 comprises locations 382 where electronically conductive interconnects can be located in an assembled battery pack. The substrate may further comprise a mechanically interlocking feature configured to hold an interconnect in place. Such a mechanically interlocking feature may be, for example, a portion of the substrate that forms a hook or snap that can hold an interconnect in place (e.g., via friction). For example, substrate 380 in FIG. 26C includes mechanically interlocking features 383. In some embodiments, a tab of an electrochemical cell having a first polarity from a first electrochemical cell is connected to an electronically conductive interconnect, and a tab having a second, opposite polarity from a second, adjacent electrochemical cell is connected to the same interconnect. For example, an anode tab of a first electrochemical cell and a cathode tab from a second, adjacent electrochemical cell may each connected to a same electronically conductive interconnect. FIGS. 26B-26D, for example, show first tab 387 and second tab 388 connected to first material portion 385 and second material portion 386 of interconnect 384, respectively. Such connections may be achieved, for example, using welding (e.g., laser welding) at weld areas 389 as shown in FIG. 26D. In such a way, adjacent electrochemical cells can be electronically coupled in series, which may be desired in some embodiments. In some embodiments, two tabs connected to a same electronically conductive interconnect are folded over toward each other, rather than having all tabs folder to face a same direction. For example, in FIGS. 26C-26D, tab 387 and tab 388 are folder toward each other.

In some embodiments, an electronically conductive interconnect on the substrate comprises a first material portion and a second material portion. In some embodiments, the electronically conductive interconnect comprises a first material portion connected to a first tab of the first electrochemical cell and a second material portion connected to a second tab of the second electrochemical cell. For example, FIG. 26B shows a top view schematic diagram of electronically conductive interconnect 384 on substrate 380, interconnect 384 having first material portion 385 and second material portion 386. A first tab of a first electrochemical cell may be connected to first material portion 385, and a second tab of a second electrochemical cell may be connected to second material portion 386. The first material portion and the second material portion may each independently comprise any of a variety of electronically conductive materials, such as metals and/or metal alloys. In some embodiments, the first material portion and the second material portion are made of different metals and/or metal alloys. Such a configuration may be beneficial in establishing effective contacts with tabs of different materials (e.g., via laser welding). For example, in some embodiments where the electrochemical cells have copper anode tabs and aluminum cathode tabs, the electronically conductive interconnect may comprise a first material portion comprising copper metal and a second material portion comprising aluminum metal, such that the copper anode tabs are connected to the copper material portion (e.g., via laser welding) (thereby establishing an electronic coupling) and the aluminum cathode tabs are connected to the aluminum material portion (e.g., via laser welding) (thereby establishing an electronic coupling. It has been observed that some connection methods, such as some laser welding methods, are more effective in creating high quality connections when like materials are welded with like (or similar) materials. The above-described configuration of interconnects with multiple material portions can promote facile arrangement of such like-like connections. The first material portion and the second material portion can in some instances be independently fabricated and then joined (e.g., mechanically, such as via joints such as dovetail joints). However, in some instances the first material portion and the second material portion are fabricated together (e.g., via deposition with masking). In some embodiments, the first material portion and the second material portion of the interconnect as well as the mechanically interlocking features of the substrate described above (e.g., feature 383) are configured asymmetrically such that the interconnect can fit in the space for the interconnect only in a single orientation. The embodiment shown in FIGS. 26C-26D show one such set of asymmetric interlocking features 383 of substrate 380. Such a configuration can ensure that correct tabs are connected to correct materials of the electronically conductive interconnect.

FIG. 26E shows a perspective view schematic illustration of substrate 430, which is an alternate embodiment of a substrate to which tabs from electrochemical cells of the battery pack can be connected. Substrate 430 may comprise spaces 431 through which tabs from electrochemical cells can pass. While substrate 430 has 36 spaces 481 to accommodate 36 electrochemical cells, other numbers of cells and spaces 431 can be used, depending on the desired attributes of the battery pack (e.g., desired total voltage, desired energy storage capacity, etc.). In FIG. 26E, substrate 430 comprises locations 432 where electronically conductive interconnects can be located in an assembled battery pack. As mentioned above, in some embodiments, a tab of an electrochemical cell having a first polarity from a first electrochemical cell is connected to an electronically conductive interconnect, and a tab having a second, opposite polarity from a second, adjacent electrochemical cell is connected to the same interconnect. For example, an anode tab of a first electrochemical cell and a cathode tab from a second, adjacent electrochemical cell may each be connected to a same electronically conductive interconnect. FIGS. 26F-26G, for example, show first tab 437 and second tab 438 connected to first material portion 435 and second material portion 436 of interconnect 434, respectively. Such connections may be achieved, for example, using welding (e.g., laser welding). In some embodiments, the first material portion and the second material portion are made of a same metal and/or metal alloy. For example, the first material portion and the second material portion may each be different regions of a same unitary interconnect (e.g., comprising a metal and/or metal alloy such as copper metal or copper alloy). In the embodiment shown in FIGS. 26F-26G, for example, first material portion 435 and second material portion 436 of interconnect 434 correspond to spatially distinct regions of a unitary copper metal interconnect. As mentioned above, the electronically conductive interconnects may be coupled to the substrate using any of a variety of techniques, such as using mechanically interlocking features. Another technique for coupling the interconnects to the substrate is via staking, where an interference fit between the interconnects and the substrate is created. For example, the substrate may be formed of a plastic material and the interconnect may be coupled to the plastic material via heat staking. For example, in FIGS. 26E-26G, substrate 430 comprises studs 433 which are used for heat staking by being fit through holes of interconnect 434 and then being deformed via softening (e.g., via heating) to form a head that mechanically locks interconnect 434 to substrate 430. Heat-staking, like use of mechanically interlocking parts as described above, may permit coupling of interconnects to substrates without the need for additional components such as screws.

It has been recognized and appreciated that conventional techniques for management and operation of rechargeable electrochemical cells have resulted in the previously poor longevity and performance of cells (and batteries in which they may be included). For example, cells have suffered a short cycle life (e.g., a low number of complete cycles before capacity falls below 80% of original capacity, as cells typically do at some point after sufficient usage), particularly where charge and discharge rates are similar, or where the charge rate is higher than the discharge rate. For example, many users of cells in batteries have desired the batteries to have nearly identical charge and discharge rates (e.g., 4 hours to charge and 4 hours to discharge), and battery manufacturers have provided batteries and battery management systems that provide such nearly identical rates. Many users have also desired batteries to charge at higher rates than they discharge (e.g., 30 minutes to charge and 4 hours to discharge) for various reasons, such as to reduce inconvenience of waiting for charging to use the batteries and extended runtimes.

The term “charging step” is used herein to generally refer to a continuous period of time during which charging is performed without discharging, and the term “discharging step” is used herein to generally refer to a continuous period during which discharging is performed without charging. A charging step coupled with a discharging step may form a cycle, but the cycle may not necessarily be a complete cycle. The term “capacity” is used to generally refer to an amount of electrical charge a cell or cells can deliver at a given or rated voltage and is often measured in amp-hours (such as milliamp-hours or mAh). In some embodiments, capacity may be the mAh a cell or cells can hold at a given point in time (which may change over multiple cycles), it may be the mAh remaining in a cell or cells at a given point in time, or it may be the mAh a cell or cells need to fully re-charge.

The term “state of charge” (SOC) is used herein to refer to a level of charge of the cell relative to its capacity and is measured as a percentage. As examples, a state of charge of 100% refers to a fully charged cell, a state of charge of 40% refers to a cell that retains 40% of its capacity, and a state of charge of 0% refers to a fully discharged cell.

The term “state of charge range” (SOC range) is used herein to refer to a range of states of charge. For example, a state of charge range of 10% to 50% would include the states of charge of 10%, 50%, and all states of charge between 10% and 50%.

The “breadth” of the state of charge range is used herein to refer to the absolute value of the difference between the end points of a state of charge range. To illustrate, a state of charge range of 10% to 50% would have a breadth of 40% (because 50% minus 10% is 40%). As another example, a state of charge range of at least 2% and at most 5% would have a breadth of 3% (because 5% minus 2% is 3%).

It has been recognized and appreciated that the cycle life of a cell (and a battery including the cell), and consequently the longevity and performance of the cell (and battery), may be greatly improved by employing higher ratios of discharge rate to charge rate, higher ratios of charge rate to other charge rate(s) (such as a preceding or proceeding rate(s)), and/or higher ratios of discharge rate to other discharge rate(s). Furthermore, it has been recognized and appreciated that these ratios may be employed by providing a cell and/or battery management system that controls the cell or cells to provide such ratios.

It has been recognized and appreciated that such improvements and others described herein, such as improved cell cycle life, can be had even if not every charging step and/or every discharging step satisfies a target ratio, and/or even if the ratios are employed over only a portion of a charging step and/or a discharging step, and/or even if the ratios are employed over a state of charge range that constitutes only a portion of the full SOC range.

For example, some embodiments are directed to a cell management system that controls a cell such that the cell is discharged or charged over a SOC range (e.g., a range having breadth of at least 2% and at most 60%) to satisfy a rate ratio (such as by discharging at a rate at least 2 times an average charging rate of any of the last 5 cycles, or by charging to establish a similar ratio with discharging rate(s)) if the ratio has not been satisfied within the last 5 cycles. As another example, in some embodiments the cell is discharged over a SOC range to satisfy another rate ratio (such as by discharging at a rate at least 2 times an average discharging rate of any of the last 5 cycles, but discharging at most 4 times a maximum recommended continuous discharging rate) if the ratio has not been satisfied within the last 5 cycles.

As an additional example, in some embodiments, once a threshold SOC (e.g., 60% or less) is reached while discharging, the discharging rate is increased to at least 2 times an average charging rate of at least one cycle in the cycle history. In some embodiments, a charging step is terminated (e.g., at 60% SOC) and a discharge is initiated, whereupon the cell is discharged, over a SOC range having breadth of at least 1%, at a rate at least 2 times an average charging rate of the terminated charging step or of at least one cycle in the cycle history. In additional embodiments, the cell is discharged over a SOC range (e.g., a range having breadth of at least 2% and at most 60%), and then charged such that the discharging rate is at least 2 times the average charging rate.

In further embodiments, if a fast charging request has not been received, the cell is charged over a first SOC range (e.g., a range having breadth of at least 2% and at most 60%), and then charged over a second SOC range such that the rate over the first SOC range is at most 0.5 times the average rate over the second SOC range. In some embodiments, the cell is discharged, and then immediately charged over a first SOC range (e.g., a range having breadth of at least 2% and at most 60%), and a future charging schedule is set and executed such that by an end of the next 4 cycles, the cell is charged over a second SOC range such that the rate over the first SOC range is at most 0.5 times the average rate over the second SOC range.

Furthermore, it has been recognized and appreciated that analysis and control as described herein may be performed by a cell and/or battery management system (e.g., of a battery pack described herein).

Some embodiments, such as embodiments having multiple cells, are directed to a battery management system that multiplexes cells such that the cells can be charged all at once (or with multiple cells discharged at the same time) and discharged individually or in smaller sets. This may result in actual ratios of discharge rate to charge rate (or discharge rate to other discharge rate(s), or charge rate to other charge rate(s)) for the cells that improve their cycle life, while providing whatever output rates that are desired or required for particular loads and applications. Furthermore, the inventors have recognized and appreciated that discharging some but not all of the cells at once with homogeneous current distribution may also improve their cycle life.

For example, with a battery having 4 cells, 1 cell could be discharged at a time at 0.5 amps for 3 hours each, and then all 4 cells could be charged at 0.5 amps for 12 hours—such a configuration would provide an actual ratio of discharge rate to charge rate of 4:1, while the ratio from the user's perspective would be 1:1 because the cells are discharged individually for 3 hours each (totaling 12 hours of discharge time). The inventors have recognized and appreciated that such a battery management system may actually improve the cycle life of batteries while still providing users what they desire or need from the batteries. In some embodiments, the functionality providing this duo of benefits may be hidden from users and may be integrated into the cell blocks and/or batteries themselves.

It has been recognized and appreciated that the cycle life of batteries may be further improved by monitoring the cycles of the cells and various properties (such as the duration of a connection between a load and a cell or cells currently connected to the load, or a more complex function considering multiple parameters) and selecting which cells to discharge when based on this monitoring, especially compared to conventional techniques, which relied on much simpler selection processes like “round robin” or considering a number of prior cycles.

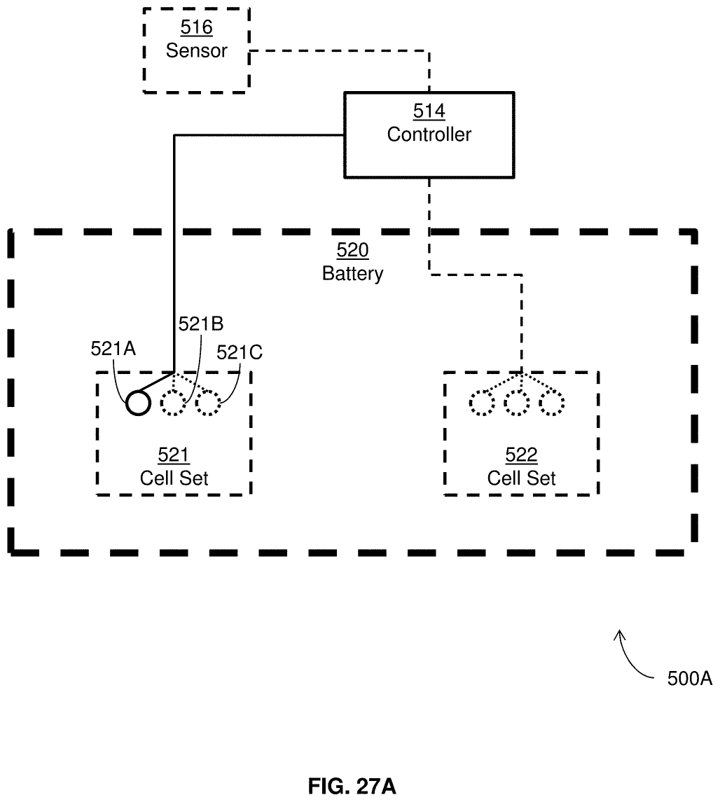

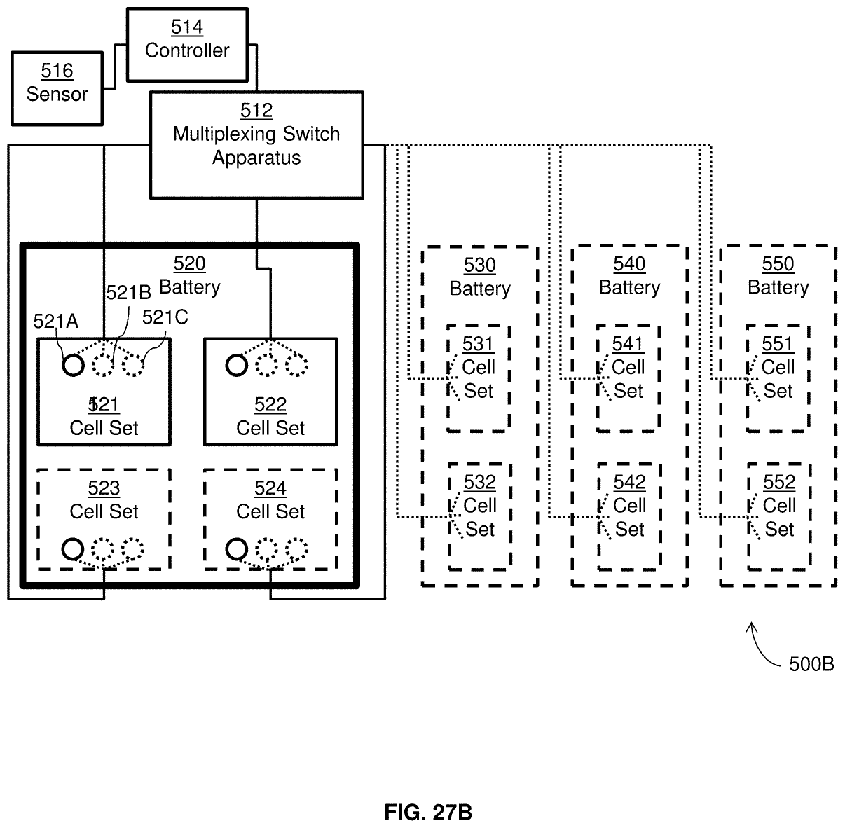

FIG. 27A depicts a representative cell management system 500A. In some embodiments, representative system 500A may include a controller (e.g., 514) and an electrochemical cell (e.g., 521A). In some embodiments, cell 521A may be present alone. In other embodiments, additional cells (e.g., optional cells 521B and 521C in FIG. 27A) and/or additional cell sets (e.g., optional cell set 522 in FIG. 27A) may be present (e.g., to form battery 520). Optionally, system 500A may include one or more sensors (e.g., 516). It should be appreciated that although only a single controller 514 and a single sensor 516 are shown in FIG. 27A, any suitable number of these components may be used. Any of numerous different modes of implementation may be employed.

In some embodiments, such as embodiments having multiple cells, a multiplexing switch apparatus (not shown in FIG. 27A) may be included, such as described in relation to FIG. 27B below, and may include an array of switches. Additionally, the multiplexing switch apparatus may be connected to each set of cells and/or to each cell individually. In some embodiments, the controller, such as 514, may use the multiplexing switch apparatus to selectively discharge the cells or sets of cells.

In some embodiments, the controller may control the cell such that, for at least a portion of a charging step of the cell, the cell is charged at a charging rate or current that is lower than a discharging rate or current of at least a portion of a previous discharging step. For example, the controller may cause the cell to be charged for some state of charge range (e.g., over a range having breadth of anywhere from 1% to 100%) at a charging rate or current that is on average at least 2 times lower than the discharging rate or current that has been used on average discharging for some state of charge range (e.g., over a range having breadth of anywhere from 1% to 100%) (i.e., the charging rate or current may be half as fast as the discharging rate or current). Alternatively or additionally, the controller may cause the cell to be charged at a charging rate or current that is at least 4 times lower than the discharging rate (e.g., as a result of this controlling, over the last cycle, the cell is charged for some range one-fourth as fast as the cell has been discharged for some range). The inventors have recognized and appreciated that such ratios of charge rate to discharge rate may improve the performance and cycle life of a cell.

In some embodiments, controlling the cell may include controlling when and how to start and stop charging and discharging, induce discharging, increase or decrease the rate or current of charging or discharging, and so on. For example, controlling charging or discharging of the cell may include, respectively, starting charging or discharging, stopping charging or discharging, increasing or decreasing the rate or current of charging or discharging, and so on.

In some embodiments, the cell is charged such that, over a period of time during which at least 5% (or at least 1%, or at least 10%, or at least 15%, or at least 25%, or anywhere between) of the capacity of the cell is charged, the average charge rate or current is lower than the average discharge rate or current used to discharge at least 5% (or at least 10%, or at least 15%, or at least 25%, or anywhere between) of the cell's capacity during a previous discharging step, which may be, for example, the immediately preceding discharging step or an earlier discharging step.

In some embodiments, a charging step is performed such that, for at least 5% (or at least 10%, at least 25%, at least 50%, or at least 75%) of the cell's or battery's capacity, the average of the charging rate and/or current is less than 50% (or less than 35%, or less than 25%) of an average discharging rate and/or current at which at least 5% (or at least 10%, at least 25%, at least 50%, or at least 75%) of the cell's or battery's capacity was discharged during a previous discharging step.

In certain embodiments, a charging step is performed such that, for at least 5% (or at least 10%, at least 25%, at least 50%, or at least 75%) of the cell's or battery's capacity, the average of the charging rate and/or current is less than 50% (or less than 35%, or less than 25%) of an average discharging rate and/or current at which at least 5% (or at least 10%, at least 25%, at least 50%, or at least 75%) of the cell's or battery's capacity was discharged during the immediately preceding discharging step.

In some embodiments, an average discharging rate or current during the previous discharging step may be equal to or less than an average charging rate or current during the charging step, and an average discharging rate or current during discharge of a state of charge range have breadth of at least 5% during the previous discharging step may be at least 2 times higher (or may be 4 times higher) than the average charging rate or current during the charging step. The inventors have recognized and appreciated that improvements described herein, such as improved cell cycle life, can still be had even if the average discharge rate for the cell is the same or even slower than the charge rate, so long as during discharge of at least a portion (such as state of charge range having breadth of 5%) during the previous discharging step, an average discharging rate or current is sufficiently higher than (such as at least double, triple, or quadruple) the average charging rate or current during that time.

As used herein, when a cell is charged at multiple different rates over a given period of time (e.g., over a portion of a charging step, over an entire charging step, or over a series of charging steps), the average charging rate over that given period of time is calculated as follows:

$$C {R}_{A v g} = {\sum }_{i = 1}^{n} \frac{C C a {p}_{i}}{C C a {p}_{T o t a l}} C {R}_{i}$$

where CR_{Avg} is the average charging rate over the given period of time, n is the number of different rates at which the cell is charged, CRi is the charging rate, CCapᵢ is the portion of the cell's capacity that is charged at charging rate CRᵢ during the given period of time, and CCap_{Total} is the total of the cell's capacity that is charged over the entire period of time. To illustrate, if, during a charging step, a cell is charged from 0% to 50% of its capacity at a rate of 20 mAh/minute and then from 50% to 80% of its capacity at a rate of 10 mAh/minute, then the average charging rate during the charging step would be calculated as:

$$C {R}_{A v g} = \frac{50 \%}{80 \%} ( 20 mAh / min ) + \frac{30 \%}{80 \%} ( 10 mAh / min ) = 16.25 mAh / min .$$

As used herein, when a cell is discharged at multiple different rates over a given period of time (e.g., over a given charging step or series of charging steps), the average discharging rate over that given period of time is calculated as follows:

$$D {R}_{A v g} = {\sum }_{i = 1}^{n} \frac{D C a {p}_{i}}{D C a {p}_{Total}} D {R}_{i}$$

where DR_{Avg} is the average discharging rate over the given period of time, n is the number of different rates at which the cell is discharged, DRi is the discharging rate, DCapᵢ is the portion of the cell's capacity that is discharged at discharging rate DRᵢ during the given period of time, and DCap_{Total} is the total of the cell's capacity that is discharged over the entire period of time. To illustrate, if, during a discharging step, a cell is discharged from 90% to 50% of its capacity at a rate of 25 mAh/minute and then from 50% to 20% of its capacity at a rate of 15 mAh/minute, then the average discharging rate during the discharging step would be calculated as:

$$D {R}_{A v g} = \frac{40 \%}{70 \%} ( 25 mAh / min ) + \frac{30 \%}{70 \%} ( 15 mAh / min ) = 20.71 mAh / min .$$

It has been recognized and appreciated that a number of factors may go into determining charge rates that may improve the performance and cycle life of a cell such as a lithium metal cell, which may include rate of discharge, cell impedance, and/or cell State of Health (SOH). In some embodiments, the controller may be aware of these factors because it may measure parameters or characteristics (such as via sensor 116) that can be used to determine each of them. The controller may directly or indirectly measure charge and discharge current, Coulombs added or removed, cell impedance (capacitive and resistive), and/or cell pressure, size, and/or thickness.

In some embodiments, the controller may monitor such characteristic(s) of the cell. For example, the characteristic(s) may include at least a portion of a discharge history of the cell. Alternatively or additionally, the characteristic(s) may include at least one morphological characteristic of the cell. The controller may monitor any of these using sensor 116, such as a pressure sensor, a gauge to measure thickness, a sensor to measure or determine surface roughness and/or pits (such as pits in an anode), and/or a memory for storing cell charge/discharge history. For example, a pressure sensor may be included to measure uniaxial pressure and/or gas pressure (such as to determine if the cell generates an excessive amount of gas). Alternatively or additionally, a gauge may be included to measure a thickness of the cell, and the controller may determine and monitor at least one rate of increase of the thickness.

In some embodiments, the controller may use this information, such as the characteristic(s), to determine the charge method and/or rate to be used, which may include controlling rates or other parameters as described herein.

In some embodiments, the controller may consider any of several factors when determining the cell state of charge and State of Health (SOH). An impedance measurement may have two components: real and imaginary. The real component may be simply the DC resistance R=RS+RP. The imaginary (or reactive) component in this case may be XC, which may be affected inversely by frequency:

$$XC = \frac{1}{2 π f c}$$

where f is frequency and c is capacitance. Impedance (Z) may be found at any particular frequency, and the phase angle may be known or determined as follows: Z=\sqrt{R²+XC²}. Impedance may change both with SOC and SOH. The inventors have recognized and appreciated that these relationships may allow the controller to determine how to charge the cell in order to provide improvements described herein.

It has also been recognized and appreciated that, in certain instances, pulses of cycles and/or charging/discharging steps should not be applied faster than a rate equal to about double or triple RC time constants, because at a faster rate, most of the energy may not be effective in charging or discharging the cell. Rather, it may be mostly reactive in nature and most of the energy may be returned by the capacitance or dissipated in the resistance.

It has been further recognized and appreciated that a cell may grow and shrink in thickness with every cycle and that a portion of the growth is retained each cycle. This growth and shrinkage can be measured by monitoring the pressure and/or size change of the cell directly. These are additional inputs that may be used when determining SOC and SOH, and they can also be used in determining how to charge the cell.

In some embodiments, the controller may control charging of the cell based on the characteristic(s) of the cell. For example, if the cell has had a discharging step or history of discharging at a certain discharge rate or current (such as 300 mA) at least for a portion of the previous discharging step, the cell may be controlled to charge at a lower rate or current (such as at 150 mA or 75 mA) for at least a portion of the charging step.

In some embodiments including an induced discharge, the controller may control the cell such that, for at least a portion of the charging step (such as 5% of the cycle), the cell is charged at a charging rate or current that is lower than a discharging rate or current of at least a portion of a previous discharging step other than (i.e., not including) the induced discharge.

As another example, the controller may terminate usage of the cell if an applied anisotropic pressure falls below a threshold, which may indicate that the pressure applying system (examples of which are described in more detail below) is damaged. For example, in some embodiments such a threshold may be 1% to 50% of nominal applied anisotropic pressure. Alternatively or additionally, the controller may terminate usage of the cell if pressure is too high or the thickness has been increasing faster than a threshold rate. For example, in some embodiments such a threshold rate may be 1% to 3% of thickness increase or more per cycle.

FIG. 27B depicts a representative battery management system 500B. In some embodiments, such as embodiments having multiple cells, representative system 500B may include a multiplexing switch apparatus (e.g., 512), a controller (e.g., 514), one or more sensors (e.g., 516), and one or more batteries (e.g., 520, 530, 540, 550, and so on). It should be appreciated that although only a single multiplexing switch apparatus 512, controller 514, sensor 516, and only four batteries 520-550 are shown in FIG. 27B, any suitable number of these components may be used. Any of numerous different modes of implementation may be employed. Furthermore, although a label in the singular is used herein to reference a multiplexing switch apparatus, it should be appreciated that the components used for the multiplexing and switching described herein may be distributed across any suitable number of devices (e.g., switches).

In some embodiments, a multiplexing switch apparatus (e.g., 512) may include an array of switches. Additionally, the multiplexing switch apparatus may be connected to each set of cells and/or to each cell individually. In some embodiments, the controller, such as 514, may use the multiplexing switch apparatus to selectively discharge the cells or sets of cells based on at least one criterion.

For example, the criterion may include a sequence in which to discharge the cells or sets of cells, such as a predefined numbering or order associated with the sets of cells (e.g., starting with a first set, switching through each set to the last set, and then starting over with the first set), and/or an order based on the cell(s) or set(s) of cells with the next highest voltage or some other measure indicating the next strongest. The inventors have recognized and appreciated that using a sequence, especially a predefined numbering, may reduce the complexity of the operations performed by the system (e.g., a controller that is not a microprocessor) and may be usable by a wider array of systems.

Alternatively or additionally, the criterion may be context-sensitive, such as by considering any one or more of the following: a duration of a connection between a load and a set of cells currently connected to the load (which may be at least 0.01 seconds in some embodiments), a delivered capacity at the connection, and the value of a function having one or more parameters. In certain embodiments, the criterion may not include a number of prior discharging steps of the set of cells.

In some embodiments, the function may have parameters such as any one or more of the following: a capacity accumulated over several connections between the load and the set of cells, the delivered capacity at the connection, a current of the set of cells, a voltage of the set of cells and/or of at least one other set of cells, a cutoff discharge voltage of the set of cells, a power of the set of cells, an energy of the set of cells, a number of charging or discharging steps of the set of cells, an impedance of the set of cells, a rate of voltage fading of the set of cells during the connection, a temperature of the set of cells, and a pressure of the set of cells (e.g., the pressure on the cell(s) from their physical enclosure, which may indicate cell capacity and is discussed further below). According to some embodiments, the delivered capacity at a single connection may be in the range from 0.01% of nominal capacity to 100% (e.g., 95%) of set nominal capacity.

In some embodiments, a sensor (e.g., 516) may measure the criterion and/or any of the parameters of the function. For example, the sensor may include a current sensor that measures the current in amperes of a given set of cells. It should be appreciated that the criterion may be plural or singular and may relate to the currently discharging set of cells and/or may determine the next set of cells.

In some embodiments, the controller (e.g., 514) may include one or more processors, which may be of whatever complexity is suitable for the application. For example, evaluating the function of the criterion in some embodiments may rely on a microprocessor forming part or all of the controller.

In some embodiments, the controller may use the multiplexing switch apparatus to selectively discharge and charge the cells or sets of cells at different, programmable rates. For example, the controller may use the multiplexing switch apparatus to selectively discharge the cells or sets of cells at a first rate at least 2 times higher than a second rate of charging the sets of cells (i.e., discharging twice as fast as charging). Alternatively or additionally, the first rate of discharging may be at least 4 times higher than the second rate of charging the sets of cells (i.e., discharging four times as fast as charging). The inventors have recognized and appreciated that such ratios of discharge rate to charge rate may improve the performance and cycle life of the cells. According to some embodiments, the controller may temporally overlap the discharge of the sets of cells. For example, before a given cell or set of cells ceases discharging, another cell or set of cells may begin discharging. In some embodiments, the controller may continue to provide power from the sets of cells during switching between different sets. The inventors have recognized and appreciated that this temporal overlap of discharging and continuation of power may maintain the power requirements of the load even during transition between different cells of sets of cells, which may further improve the cycle life of the cell(s) compared to conventional techniques. Accordingly, multiple cells may discharge simultaneously during such an overlap. Additionally, such an overlap may provide smoother transition of voltage than has been possible with conventional techniques.

Alternatively or additionally, the controller may use the multiplexing switch apparatus (e.g., 512) to connect the sets of cells to a load in a topology employed or required by the load.

In some embodiments, the controller may use the multiplexing switch apparatus (e.g., 512) to isolate a single set of cells for discharging while other sets of cells are not discharging. Alternatively or additionally, a single cell may be isolated at a time. For example, the controller may use the multiplexing switch apparatus to isolate a single set of cells or a single cell for discharging while the other cells or sets of cells are not discharging. For a given cycle, each cell may be discharged once before any cell is discharged twice, according to some embodiments (e.g., where sequential discharging is used, but not limited to such embodiments).

As for charging, in some embodiments the controller may use the multiplexing switch apparatus to charge the sets of cells, and/or cells within a set, in parallel. For example, all the cells in the cell block, battery, or batteries may be charged in parallel at a rate one-fourth of the rate of discharge.

A variety of anode active materials are suitable for use with the anodes of the electrochemical cells described herein, according to certain embodiments. In some embodiments, the anode active material comprises lithium (e.g., lithium metal), such as lithium foil, lithium deposited onto a conductive substrate or onto a non-conductive substrate (e.g., a release layer), and lithium alloys (e.g., lithium-aluminum alloys and lithium-tin alloys). Lithium can be contained as one film or as several films, optionally separated. Suitable lithium alloys for use in the aspects described herein can include alloys of lithium and aluminum, magnesium, silicium (silicon), indium, and/or tin. In some embodiments, the anode active material comprises lithium (e.g., lithium metal and/or a lithium metal alloy) during at least a portion of or during all of a charging and/or discharging process of the electrochemical cell. In some embodiments, the anode active material comprises lithium (e.g., lithium metal and/or a lithium metal alloy) during a portion of a charging and/or discharging process of the electrochemical cell, but is free of lithium metal and/or a lithium metal alloy at a completion of a discharging process.

In some embodiments, the anode active material contains at least 50 wt % lithium. In some cases, the anode active material contains at least 75 wt %, at least 90 wt %, at least 95 wt %, or at least 99 wt % lithium.

In some embodiments, the anode is an electrode from which lithium ions are liberated during discharge and into which the lithium ions are integrated (e.g., intercalated) during charge. In some embodiments, the anode active material is a lithium intercalation compound (e.g., a compound that is capable of reversibly inserting lithium ions at lattice sites and/or interstitial sites). In some embodiments, the anode active material comprises carbon. In certain cases, the anode active material is or comprises a graphitic material (e.g., graphite). A graphitic material generally refers to a material that comprises a plurality of layers of graphene (i.e., layers comprising carbon atoms covalently bonded in a hexagonal lattice). Adjacent graphene layers are typically attracted to each other via van der Waals forces, although covalent bonds may be present between one or more sheets in some cases. In some cases, the carbon-comprising anode active material is or comprises coke (e.g., petroleum coke). In certain embodiments, the anode active material comprises silicon, lithium, and/or any alloys of combinations thereof. In certain embodiments, the anode active material comprises lithium titanate (Li₄Ti₅O₁₂, also referred to as “LTO”), tin-cobalt oxide, or any combinations thereof.

A variety of cathode active materials are suitable for use with cathodes of the electrochemical cells described herein, according to certain embodiments. In some embodiments, the cathode active material comprises a lithium intercalation compound (e.g., a compound that is capable of reversibly inserting lithium ions at lattice sites and/or interstitial sites). In certain cases, the cathode active material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}Co_{0.15}Mn_{0.55}O₂)_{0.75}. In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂. In certain embodiments, the cathode active material is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the cathode active material is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓM₂₋ₓO₄, also referred to as “LMNO”). A non-limiting example of a suitable LMNO compound is LiNi_{0.5}Mn_{1.5}O₄. In certain cases, the electrode active material of the second electrode comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄Cs), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the cathode active material comprises a conversion compound. For instance, the cathode may be a lithium conversion cathode. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs).

In some cases, the cathode active material may be doped with one or more dopants to alter the electrical properties (e.g., electrical conductivity) of the cathode active material. Non-limiting examples of suitable dopants include aluminum, niobium, silver, and zirconium.

In some embodiments, the cathode active material may be modified by a surface coating comprising an oxide. Non-limiting examples of surface oxide coating materials include: MgO, Al₂O₃, SiO₂, TiO₂, ZnO₂, SnO₂, and ZrO₂. In some embodiments, such coatings may prevent direct contact between the cathode active material and one or more components of the electrolyte, thereby suppressing side reactions.

In certain embodiments, the cathode active material comprises sulfur. In some embodiments, the cathode active material comprises electrode active sulfur-containing materials. “Electrode active sulfur-containing materials,” as used herein, refers to electrode active materials which comprise the element sulfur in any form, wherein the electrochemical activity involves the oxidation or reduction of sulfur atoms or moieties. As an example, the electrode active sulfur-containing material may comprise elemental sulfur (e.g., S₈). In some embodiments, the electrode active sulfur-containing material comprises a mixture of elemental sulfur and a sulfur-containing polymer. Thus, suitable electrode active sulfur-containing materials may include, but are not limited to, elemental sulfur, sulfides or polysulfides (e.g., of alkali metals) which may be organic or inorganic, and organic materials comprising sulfur atoms and carbon atoms, which may or may not be polymeric. Suitable organic materials include, but are not limited to, those further comprising heteroatoms, conductive polymer segments, composites, and conductive polymers. In some embodiments, an electrode active sulfur-containing material within an electrode (e.g., a cathode) comprises at least 40 wt % sulfur. In some cases, the electrode active sulfur-containing material comprises at least 50 wt %, at least 75 wt %, or at least 90 wt % sulfur.

Examples of sulfur-containing polymers include those described in: U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al., and PCT Publication No. WO 99/33130, each of which is incorporated herein by reference in its entirety for all purposes. Other suitable electrode active sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al., each of which is incorporated herein by reference in its entirety for all purposes. Still further examples of electrode active sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al., each of which is incorporated herein by reference in its entirety for all purposes.

One or more electrodes may further comprise additional additives, such as conductive additives, binders, etc., as described in U.S. Pat. No. 9,034,421 to Mikhaylik et al.; and U.S. Patent Application Publication No. 2013/0316072, each of which is incorporated herein by reference in its entirety for all purposes.

Any of a variety of materials can be used as an electrolyte, in embodiments in which an electrolyte is present. The electrolyte can comprise, for example, a solution of ions, a solid electrolyte, a gel electrolyte, and/or a combination of these.

In some embodiments, the electrochemical cells of the battery pack further comprise a separator between two electrode portions (e.g., an anode portion and a cathode portion). The separator may be a solid non-conductive or insulative material, which separates or insulates the anode and the cathode from each other preventing short circuiting, and which permits the transport of ions between the anode and the cathode. In some embodiments, the porous separator may be permeable to the electrolyte.

The pores of the separator may be partially or substantially filled with electrolyte. Separators may be supplied as porous free standing films which are interleaved with the anodes and the cathodes during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al.

A variety of separator materials are known in the art. Examples of suitable solid porous separator materials include, but are not limited to, polyolefins, such as, for example, polyethylenes (e.g., SETELA™ made by Tonen Chemical Corp) and polypropylenes, glass fiber filter papers, and ceramic materials. For example, in some embodiments, the separator comprises a microporous polyethylene film. Further examples of separators and separator materials suitable for use in this invention are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545 by Carlson et al. of the common assignee. Solid electrolytes and gel electrolytes may also function as a separator in addition to their electrolyte function.

As described above, in some embodiments, a force, or forces, is applied to portions of an electrochemical cell. Such application of force may reduce irregularity or roughening of an electrode surface of the cell (e.g., when lithium metal or lithium alloy anodes are employed), thereby improving performance. Electrochemical devices in which anisotropic forces are applied and methods for applying such forces are described, for example, in U.S. Pat. No. 9,105,938, issued Aug. 11, 2015, published as U.S. Patent Publication No. 2010/0035128 on Feb. 11, 2010, and entitled “Application of Force in Electrochemical Cells,” which is incorporated herein by reference in its entirety for all purposes.

In the embodiments described herein, battery packs may undergo a charge/discharge cycle involving deposition of metal (e.g., lithium metal or other active material) on a surface of an anode upon charging and reaction of the metal on the anode surface, wherein the metal diffuses from the anode surface, upon discharging. The uniformity with which the metal is deposited on the anode may affect cell performance. For example, when lithium metal is removed from and/or redeposited on an anode, it may, in some cases, result in an uneven surface. For example, upon redeposition it may deposit unevenly forming a rough surface. The roughened surface may increase the amount of lithium metal available for undesired chemical reactions which may result in decreased cycling lifetime and/or poor cell performance. The application of force to the electrochemical device has been found, in accordance with certain embodiments described herein, to reduce such behavior and to improve the cycling lifetime and/or performance of the cell.

In some embodiments, the battery pack (e.g., a housing of the battery pack) is configured to apply, during at least one period of time during charge and/or discharge of the device, an anisotropic force with a component normal to an electrode active surface of one of the electrochemical cells (e.g., first electrochemical cell, second electrochemical cell).

In some embodiments, an anisotropic force with a component normal to an electrode active surface of one of the electrochemical cells (e.g., first electrochemical cell, second electrochemical cell) is applied during at least one period of time during charge and/or discharge of the battery pack. In some embodiments, the force may be applied continuously, over one period of time, or over multiple periods of time that may vary in duration and/or frequency. The anisotropic force may be applied, in some cases, at one or more pre-determined locations, optionally distributed over an active surface of the one or more of the electrochemical cells of the battery pack. In some embodiments, the anisotropic force is applied uniformly over one or more active surfaces of the anode.

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes certain forces applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

A force with a “component normal” to a surface, for example an active surface of an electrode such as an anode, is given its ordinary meaning as would be understood by those of ordinary skill in the art and includes, for example, a force which, at least in part, exerts itself in a direction substantially perpendicular to the surface. Those of ordinary skill can understand other examples of these terms, especially as applied within the description of this document.

In some embodiments, the anisotropic force can be applied such that the magnitude of the force is substantially equal in all directions within a plane defining a cross-section of the battery pack, but the magnitude of the forces in out-of-plane directions is substantially unequal to the magnitudes of the in-plane forces.

In one set of embodiments, battery packs (e.g., housings) described herein are configured to apply, during at least one period of time during charge and/or discharge of the cell, an anisotropic force with a component normal to an electrode active surface of one of the electrochemical cells (e.g., first electrochemical cell, second electrochemical cell). Those of ordinary skill in the art will understand the meaning of this. In such an arrangement, the electrochemical cell may be formed as part of a container which applies such a force by virtue of a “load” applied during or after assembly of the cell, or applied during use of the battery pack as a result of expansion and/or contraction of one or more components of the battery pack itself.

The magnitude of the applied force is, in some embodiments, large enough to enhance the performance of the battery pack. An electrode active surface (e.g., anode active surface) and the anisotropic force may be, in some instances, together selected such that the anisotropic force affects surface morphology of the electrode active surface to inhibit increase in electrode active surface area through charge and discharge and wherein, in the absence of the anisotropic force but under otherwise essentially identical conditions, the electrode active surface area is increased to a greater extent through charge and discharge cycles. “Essentially identical conditions,” in this context, means conditions that are similar or identical other than the application and/or magnitude of the force. For example, otherwise identical conditions may mean a battery pack that is identical, but where it is not constructed (e.g., by couplings such as brackets or other connections) to apply the anisotropic force on the subject battery pack.

As described herein, in some embodiments, the surface of an anode can be enhanced during cycling (e.g., for lithium, the development of mossy or a rough surface of lithium may be reduced or eliminated) by application of an externally-applied (in some embodiments, uniaxial) pressure. The externally-applied pressure may, in some embodiments, be chosen to be greater than the yield stress of a material forming the anode. For example, for an anode comprising lithium, the cell may be under an externally-applied anisotropic force with a component defining a pressure of at least 3 kg_{f}/cm², at least 5 kg_{f}/cm², at least 8 kg_{f}/cm², at least 10 kg_{f}/cm², at least 20 kg_{f}/cm², or more. In some instances, this is because the yield stress of lithium is around 7-8 kg_{f}/cm². Thus, at pressures (e.g., uniaxial pressures) greater than this value, mossy Li, or any surface roughness at all, may be reduced or suppressed. The lithium surface roughness may mimic the surface that is pressing against it. Accordingly, when cycling such that at least a portion of the cycle the surface of the anode is under at least about 10 kg_{f}/cm², at least about 20 kg_{f}/cm², and/or up 30 kg_{f}/cm², up to 40 kg_{f}/cm² of externally-applied pressure, the lithium surface may become smoother with cycling when the pressing surface is smooth.

In some cases, one or more forces applied to the cell have a component that is not normal to an active surface of an anode. For example, in FIG. 1A force 184 is not normal to electrode active surfaces of the first electrochemical cell 110 and second electrochemical cell 120. In one set of embodiments, the sum of the components of all applied anisotropic forces in a direction normal to any electrode active surface of the battery is larger than any sum of components in a direction that is non-normal to the electrode active surface. In some embodiments, the sum of the components of all applied anisotropic forces in a direction normal to any electrode active surface of the battery is at least about 5%, at least about 10%, at least about 20%, at least about 35%, at least about 50%, at least about 75%, at least about 90%, at least about 95%, at least about 99%, or at least about 99.9% larger than any sum of components in a direction that is parallel to the electrode active surface.

In some cases, electrochemical cells may be pre-compressed before they are inserted into housings, and, upon being inserted to the housing, they may expand to produce a net force on the electrochemical cells. Such an arrangement may be advantageous, for example, if the electrochemical cells are capable of withstanding relatively high variations in pressure.

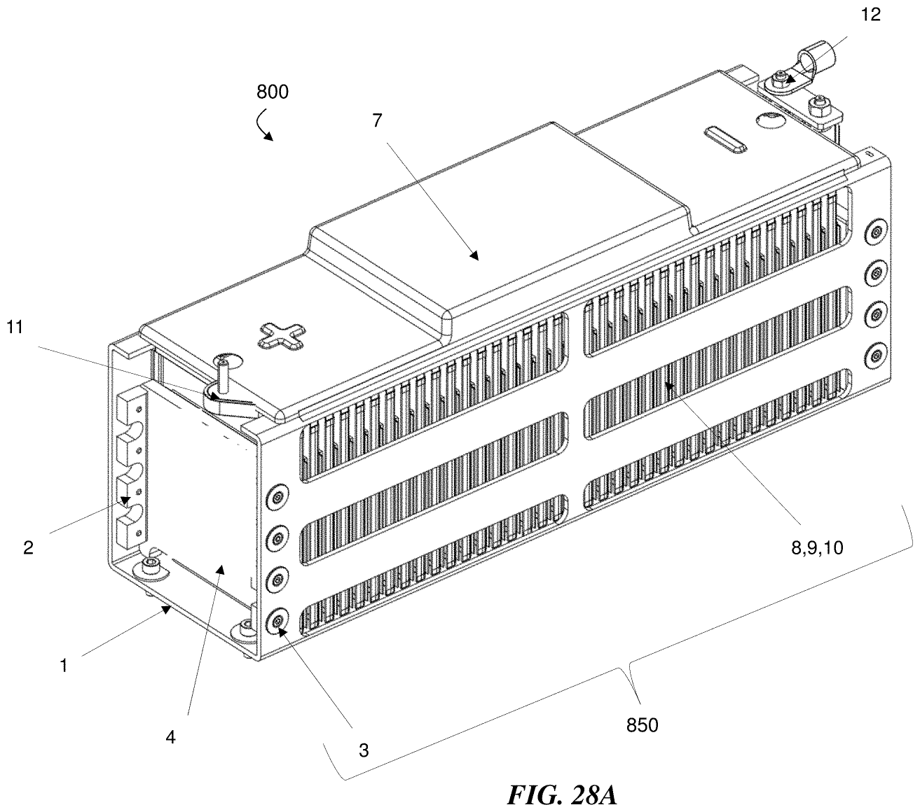

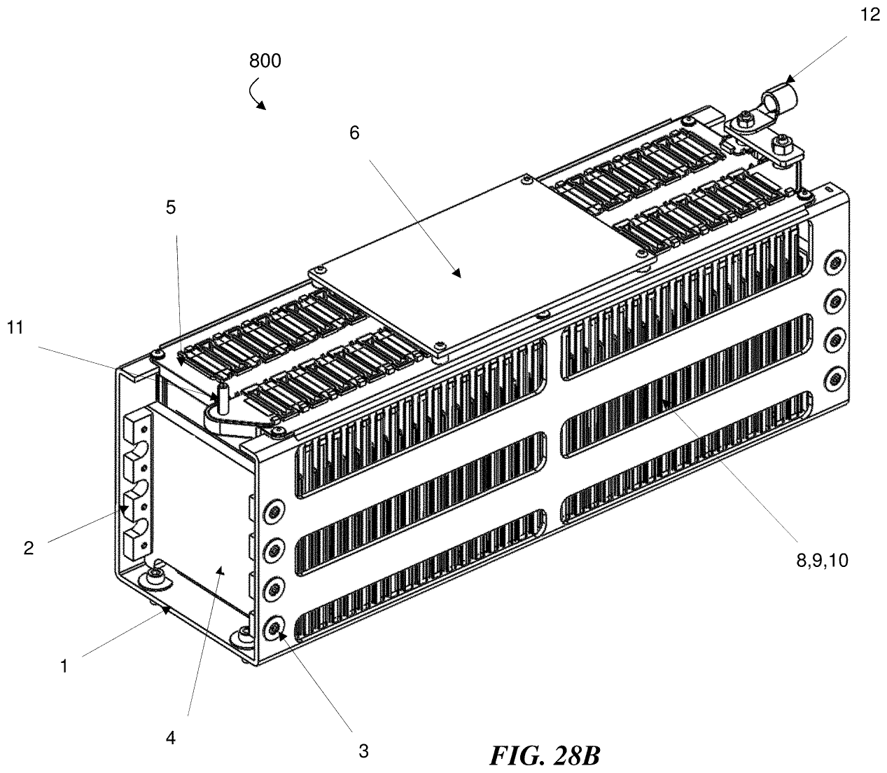

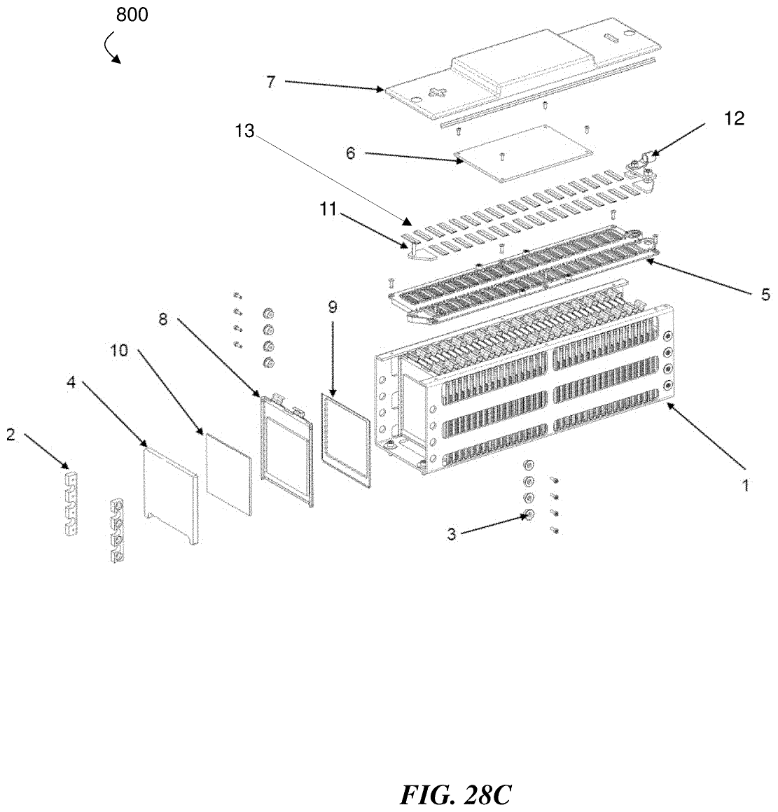

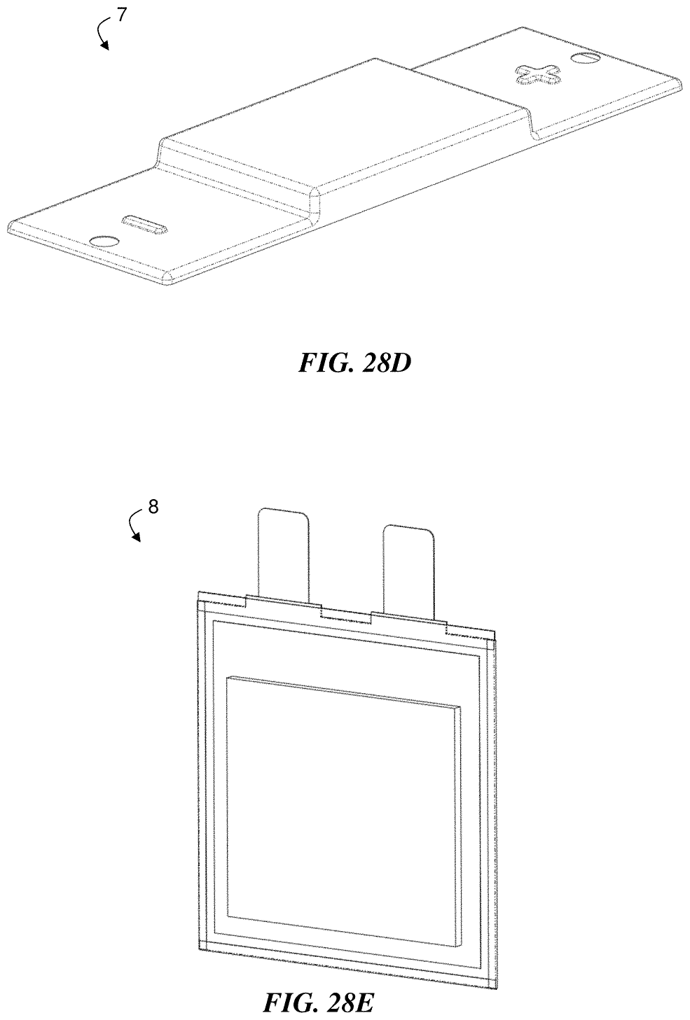

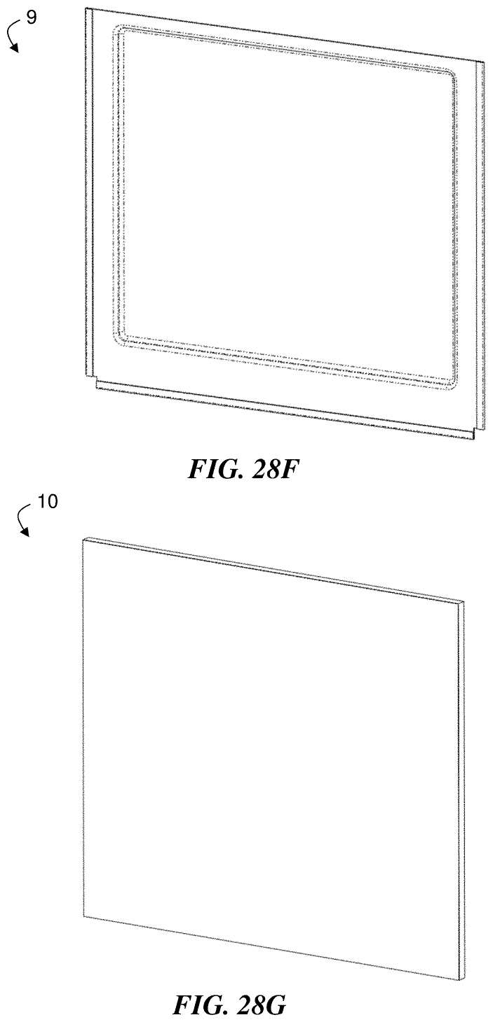

FIGS. 28A-28G show perspective view schematic illustrations of battery pack 800, according to some embodiments. Battery pack 800 shown in FIGS. 28A-28C comprises a plurality of electrochemical cells arranged in stack 850. FIG. 28A shows battery pack 800 with cover 7 present, while FIG. 28B shows battery pack 800 without cover 7 to show other components of battery pack 800 more clearly. As can be seen in FIG. 28B and in FIG. 28C (an exploded perspective view schematic illustration of battery pack 800), battery pack 800 comprises a housing comprising a solid housing component in the form of carbon fiber composite frame 1 (of the same design as frame 490 above in FIG. 4B above), titanium alloy stop portions 2 (of the same design as stop portion 364 shown in FIG. 7A above), titanium alloy inserts 3 (of the same design as insert 369 shown in FIG. 7B above), carbon fiber composite solid plate 4 (of the same design as solid plate 201 shown in FIG. 3H above), polymeric substrate 5 (of the same design as substrate 380 shown in FIG. 26A above), circuit board 6, electrochemical cells 8 (in the form of lithium metal anode cells), thermally conductive solid article portions 9 (in the form of aluminum cooling fins), thermally insulating compressible solid article portions 10 (in the form of microcellular polyurethane foam sheets), positive terminal 11, and negative terminal 12. Tabs of electrochemical cells 8 are electronically coupled to positive terminal 11 and negative terminal 12 via metallic electronically conductive interconnects 13 (of the same design as interconnect 384 shown in FIG. 26C above) attached to substrate 5. Stop portions 2 are coupled to frame 1 via inserts 3 (which pass through holes in frame 1) via fasteners. In some embodiments, frame 1 has a length of 490 mm and a width of 130.5 mm. FIGS. 28D-28G show perspective view schematic illustrations of cover 7 (FIG. 28D), electrochemical cell 8 (FIG. 28E), cooling fin 9 (FIG. 28F), and polyurethane microcellular foam 10 (FIG. 28G), respectively.

In some instances, frame 1, stop portions 2, inserts 3, and/or solid plate 4 are configured to apply an anisotropic force with a component normal to an active surface of electrochemical cells 8 of stack 850 during at least a portion of a charging or discharging process of battery pack 800. Such an anisotropic force may define a pressure of at least 3 kg_{f}/cm² at state of charge of 0% for at least some or all of the cells and of at least 12 kg_{f}/cm² (such as up to 15 kg_{f}/cm², up to 25 kg_{f}/cm², or higher) at a stage of charge of 100% for at least some or all of the cells in stack 850. In some embodiments, a first subset of electrochemical cells 8 are part of a first battery module within battery pack 800 (e.g., where the electrochemical cells are coupled in series to a first pair of terminals comprising a positive terminal and a negative terminal), and a second subset of electrochemical cells 8 are part of a second battery module within battery pack 800 (e.g., where the electrochemical cells are coupled in series to a second pair of terminals comprising a positive terminal and a negative terminal, not shown). The first battery module and second battery module within battery pack 800 may be charged and/or discharged independently (e.g., with or without multiplexing), in some instances at different rates.

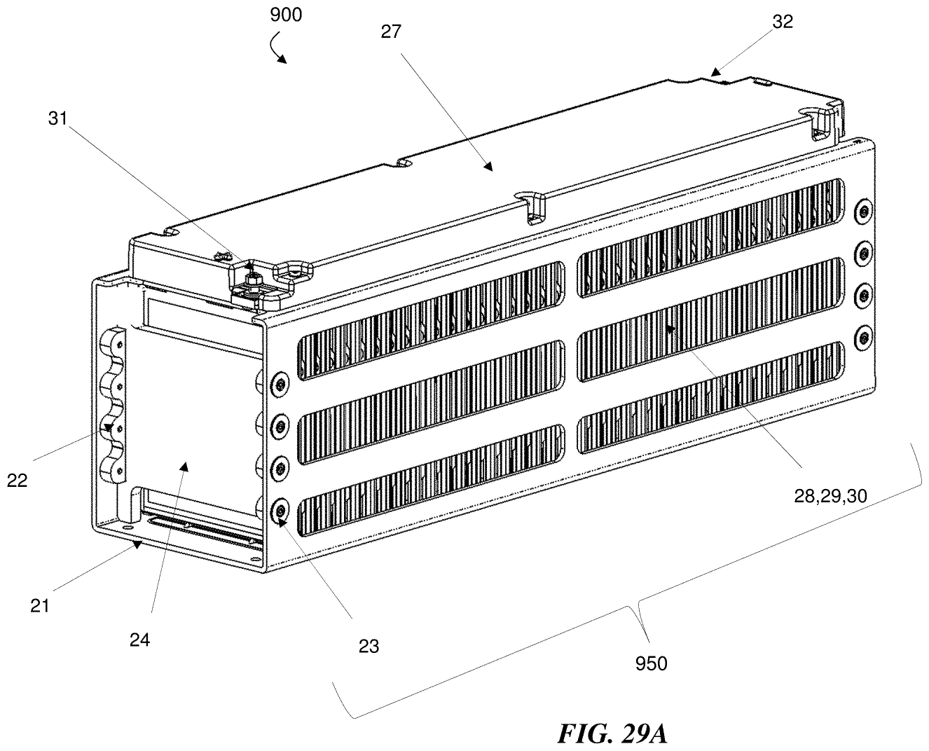

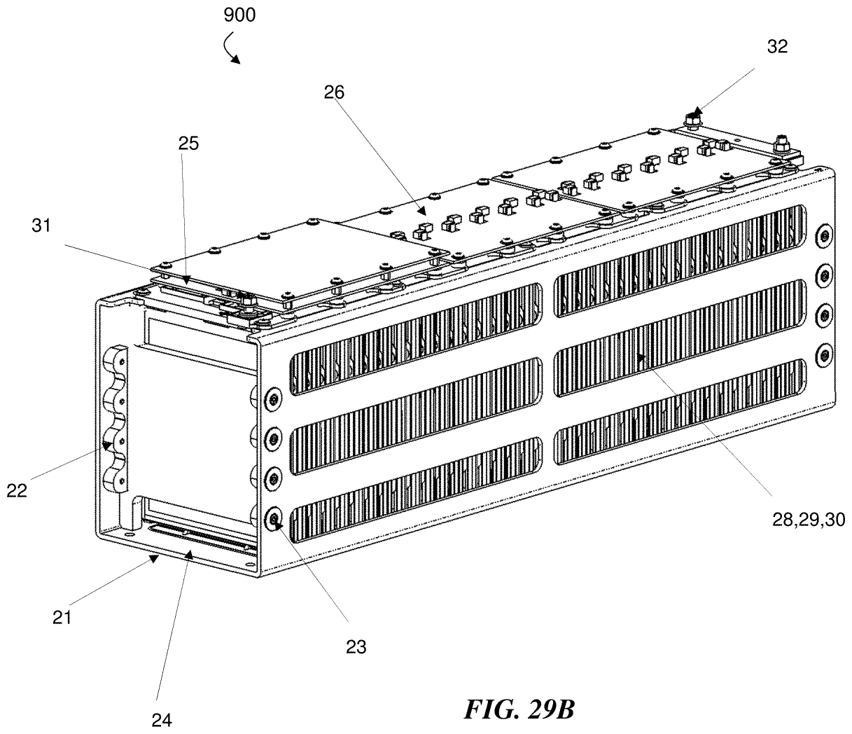

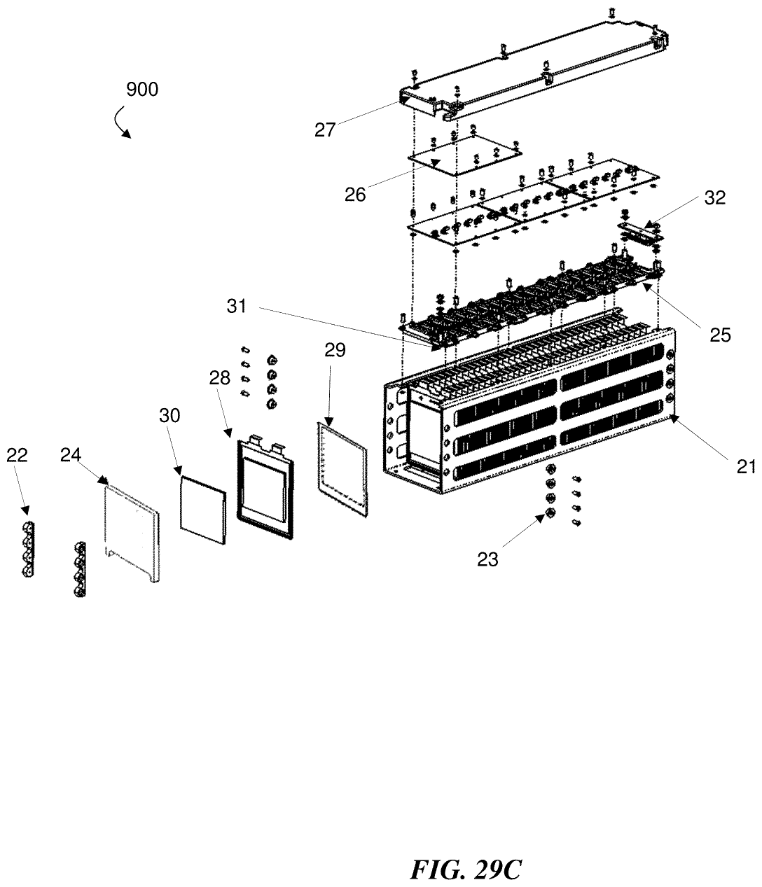

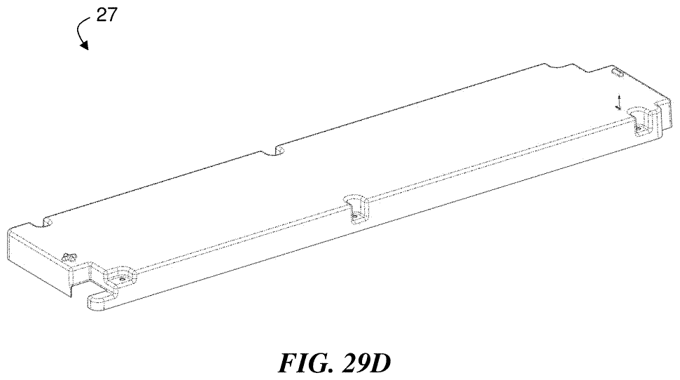

FIGS. 29A-29D show perspective view schematic illustrations of battery pack 900, according to some embodiments. Battery pack 900 shown in FIGS. 29A-28C comprises a plurality of electrochemical cells arranged in stack 950. FIG. 29A shows battery pack 900 with cover 27 present, while FIG. 29B shows battery pack 900 without cover 27 to show other components of battery pack 900 more clearly. As can be seen in FIG. 29B and in FIG. 29C (an exploded perspective view schematic illustration of battery pack 900), battery pack 900 comprises a housing comprising a solid housing component in the form of carbon fiber composite frame 21 (of the same design as frame 470 above in FIG. 4C above), titanium alloy stop portions 22 (of the same design as housing stop portion 464 shown in FIG. 7I above), titanium alloy inserts 23 (of the same design as insert 369 shown in FIG. 7B above), carbon fiber composite solid plate 24 (of the same design as solid plate 201 shown in FIG. 3H above), polymeric substrate 25 (of the same design as substrate 430 shown in FIG. 26E above), circuit board 26, electrochemical cells 28 (in the form of lithium metal anode cells), thermally conductive solid article portions 29 (in the form of aluminum cooling fins), thermally insulating compressible solid article portions 30 (in the form of microcellular polyurethane foam sheets), positive terminal 31, and negative terminal 32. Tabs of electrochemical cells 28 are electronically coupled to positive terminal 31 and negative terminal 32 via metallic electronically conductive interconnects such as interconnect 434 shown in FIG. 26F above) attached to substrate 25. Stop portions 22 are coupled to frame 21 via inserts 23 (which pass through holes in frame 21) via fasteners. In some embodiments, frame 21 has a length of from 485 mm to 495 mm and/or a width of from 125 mm to 135 mm. In some embodiments, frame 21 has a length of 490 mm and a width of 130.5 mm. In some embodiments, frame 21 has a length of about 493 mm and a width of about 130 mm. FIG. 29D shows a perspective view schematic illustration of cover 27.

In some instances, frame 21, stop portions 22, inserts 23, and/or solid plate 24 are configured to apply an anisotropic force with a component normal to an active surface of electrochemical cells 28 of stack 950 during at least a portion of a charging or discharging process of battery pack 900. Such an anisotropic force may define a pressure of at least 3 kg_{f}/cm² at state of charge of 0% for at least some or all of the cells and of at least 12 kg_{f}/cm² (such as up to 15 kg_{f}/cm², up to 25 kg_{f}/cm², or higher) at a stage of charge of 100% for at least some or all of the cells in stack 950. In some embodiments, a first subset of electrochemical cells 28 are part of a first battery module within battery pack 900 (e.g., where the electrochemical cells are coupled in series to a first pair of terminals comprising a positive terminal and a negative terminal), and a second subset of electrochemical cells 28 are part of a second battery module within battery pack 900 (e.g., where the electrochemical cells are coupled in series to a second pair of terminals comprising a positive terminal and a negative terminal, not shown). The first battery module and second battery module within battery pack 900 may be charged and/or discharged independently (e.g., with or without multiplexing), in some instances at different rates.

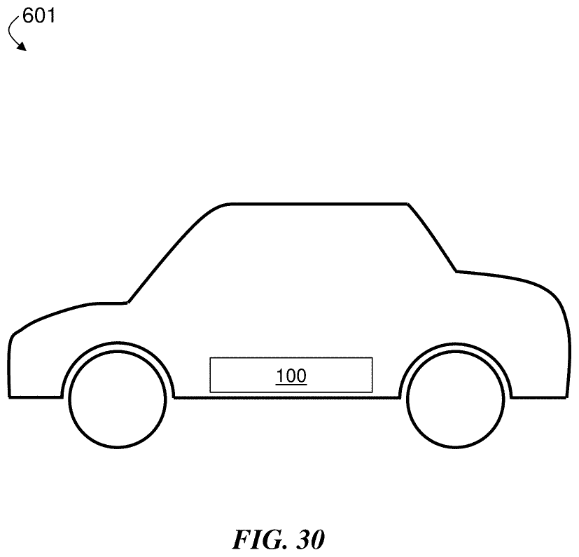

In some embodiments, the battery packs (e.g., comprising rechargeable batteries) described in this disclosure can be used to provide power to an electric vehicle or otherwise be incorporated into an electric vehicle. As a non-limiting example, battery packs described in this disclosure can, in certain embodiments, be used to provide power to a drive train of an electric vehicle. The vehicle may be any suitable vehicle, adapted for travel on land, sea, air, and/or space. For example, the vehicle may be an automobile, truck, motorcycle, boat, helicopter, airplane, spacecraft and/or any other suitable type of vehicle. FIG. 30 shows a cross-sectional schematic diagram of electric vehicle 601 in the form of an automobile comprising battery pack 100, in accordance with some embodiments. Battery pack 100 can, in some instances, provide power to a drive train of electric vehicle 601.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, patented as U.S. Pat. No. 10,862,105 on Dec. 8, 2020 and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. application Ser. No. 14/624,641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. application Ser. No. 14/848,659 on Sep. 9, 2015, and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567,534 on Oct. 18, 2017, patented as U.S. Pat. No. 10,847,833 on Nov. 24, 2020 and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. patent Ser. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, patented as U.S. Pat. No. 10,868,306 on Dec. 15, 2020 and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, patented as U.S. Pat. No. 10,991,925 on Apr. 27, 2021 and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, patented as U.S. Pat. No. 10,944,094 on Mar. 9, 2021 and entitled “PASSIVATING AGENTS FOR ELECTROCHEMICAL CELLS”; U.S. Publication No. US-2018-0277850-A1, published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1, published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1, published on Nov. 23, 2017, filed as U.S. application Ser. No. 15/599,595 on May 19, 2017, patented as U.S. Pat. No. 10,879,527 on Dec. 29, 2020 and entitled “PROTECTIVE LAYERS FOR ELECTRODES AND ELECTROCHEMICAL CELLS”; U.S. Publication No. US-2019-0088958-A1, published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1, published on Nov. 14, 2019, filed as U.S. application Ser. No. 16/470,708 on Jun. 18, 2019, and entitled “PROTECTIVE LAYERS COMPRISING METALS FOR ELECTROCHEMICAL CELLS”; U.S. Publication No. US-2017-0200975-A1, published Jul. 13, 2017, filed as U.S. application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1, published Dec. 6, 2018, filed as U.S. application Ser. No. 15/988,182 on May 24, 2018, and entitled “IONICALLY CONDUCTIVE COMPOUNDS AND RELATED USES”; U.S. Publication No. US-2018-0254516-A1, published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1, published Feb. 6, 2020, filed as U.S. Application No. 16,527,903 on Jul. 31, 2019, and entitled “MULTIPLEXED CHARGE DISCHARGE BATTERY MANAGEMENT SYSTEM”; U.S. Publication No. US-2020-0220146-A1, published Jul. 9, 2020, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1, published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1, published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”; U.S. Publication No. US-2020-0373578-A1 published Nov. 26, 2020, filed as U.S. application Ser. No. 16/879,861 on May 21, 2020, and entitled “ELECTROCHEMICAL DEVICES INCLUDING POROUS LAYERS”, International Patent Application Publication No. WO2020/237014, filed as International Application No. PCT/US2020/033938 on May 21, 2020, and entitled “ELECTRICALLY COUPLED ELECTRODES, AND ASSOCIATED ARTICLES AND METHODS”; U.S. Publication No. US-2020-0373551-A1 published Nov. 26, 2020, filed as U.S. application Ser. No. 16/879,839 on May 21, 2020, and entitled “ELECTRICALLY COUPLED ELECTRODES, AND ASSOCIATED ARTICLES AND METHODS”, International Patent Application Publication No. WO2020/257414, filed as International Patent Application No. PCT/US2020/038375 on Jun. 18, 2020, and entitled “METHODS, SYSTEMS, AND DEVICES FOR APPLYING FORCES TO ELECTROCHEMICAL DEVICES,” U.S. Publication No. US-2020-0395585-A1 published Dec. 17, 2020, filed as U.S. application Ser. No. 16/057,050 on Aug. 7, 2018, and entitled “LITHIUM-COATED SEPARATORS AND ELECTROCHEMICAL CELLS COMPRISING THE SAME”, U.S. Publication No. US-2021-0057753-A1 published Feb. 25, 2021, filed as U.S. application Ser. No. 16/994,006 on Aug. 14, 2020, and entitled “ELECTROCHEMICAL CELLS AND COMPONENTS COMPRISING THIOL GROUP-CONTAINING SPECIES”, U.S. Publication No. US-2021-0135297-A1 published on May 6, 2021, filed as U.S. application Ser. No. 16/670,905 on Oct. 31, 2019, and entitled SYSTEM AND METHOD FOR OPERATING A RECHARGEABLE ELECTROCHEMICAL CELL OR BATTERY″, U.S. Publication No. US-2021-0138673-A1 published on May 13, 2021, filed as U.S. application Ser. No. 17/089,092 on Nov. 4, 2020, and entitled “ELECTRODE CUTTING INSTRUMENT”, U.S. Publication No. US-2021-0135294-A1 published on May 6, 2021, filed as U.S. application Ser. No. 16/670,933 on Oct. 31, 2019, and entitled “SYSTEM AND METHOD FOR OPERATING A RECHARGEABLE ELECTROCHEMICAL CELL OR BATTERY”; U.S. Publication No. US-2021-0151839-A1 published on May 20, 2021, filed as U.S. application Ser. No. 16/952,177 on Nov. 19, 2020, and entitled “BATTERIES, AND ASSOCIATED SYSTEMS AND METHODS”; U.S. Publication No. US-2021-0151830-A1 published on May 20, 2021, filed as U.S. application Ser. No. 16/952,235 on Nov. 19, 2020, and entitled “BATTERIES WITH COMPONENTS INCLUDING CARBON FIBER, AND ASSOCIATED SYSTEMS AND METHODS”; U.S. Publication No. US-2021-0151817-A1 published on May 20, 2021, filed as U.S. application Ser. No. 16/952,228 on Nov. 19, 2020, and entitled “BATTERY ALIGNMENT, AND ASSOCIATED SYSTEMS AND METHODS”; U.S. Publication No. US-2021-0151841-A1 published on May 20, 2021, filed as U.S. application Ser. No. 16/952,240 on Nov. 19, 2020, and entitled “SYSTEMS AND METHODS FOR APPLYING AND MAINTAINING COMPRESSION PRESSURE ON ELECTROCHEMICAL CELLS”; U.S. Publication No. US-2021-0151816-A1 published on May 20, 2021, filed as U.S. application Ser. No. 16/952,223 on Nov. 19, 2020, and entitled “THERMALLY INSULATING COMPRESSIBLE COMPONENTS FOR BATTERY PACKS”; U.S. Publication No. US-2021-0151840-A1 published on May 20, 2021, filed as U.S. application Ser. No. 16/952,187 on Nov. 19, 2020, and entitled “COMPRESSION SYSTEMS FOR BATTERIES”; U.S. Publication No. US-2021-0193984-A1 published on Jun. 24, 2021, filed as U.S. application Ser. No. 17/125,124 on Dec. 17, 2020, and entitled “SYSTEMS AND METHODS FOR FABRICATING LITHIUM METAL ELECTRODES”; U.S. Publication No. US-2021-0193985-A1 published on Jun. 24, 2021, filed as U.S. application Ser. No. 17/125,110 on Dec. 17, 2020, and entitled “LITHIUM METAL ELECTRODES AND METHODS”; U.S. Publication No. US-2021-0193996-A1 published on Jun. 24, 2021, filed as U.S. application Ser. No. 17/125,070 on Dec. 17, 2020, and entitled “LITHIUM METAL ELECTRODES”; U.S. Publication No. US-2021-0194069-A1 published on Jun. 24, 2021, filed as U.S. application Ser. No. 17/126,390 on Dec. 18, 2020, and entitled “SYSTEMS AND METHODS FOR PROVIDING, ASSEMBLING, AND MANAGING INTEGRATED POWER BUS FOR RECHARGEABLE ELECTROCHEMICAL CELL OR BATTERY”; U.S. Publication No. US-2021-0218243 published on Jul. 15, 2021, filed as U.S. application Ser. No. 17/126,424 on Dec. 18, 2020, and entitled “SYSTEMS AND METHODS FOR PROTECTING A CIRCUIT, RECHARGEABLE ELECTROCHEMICAL CELL, OR BATTERY”.

U.S. Provisional Patent Application No. 63/166,549, filed Mar. 26, 2021, and entitled, “Battery Pack and Related Components and Methods” is incorporated herein by reference in its entirety for all purposes. U.S. Provisional Patent Application No. 63/223,663, filed Jul. 20, 2021, and entitled, “Battery Pack and Related Components and Methods” is incorporated herein by reference in its entirety for all purposes.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) also may be present. Similarly, when a portion is “below” or “underneath” another portion, it can be directly below the portion, or an intervening portion (e.g., layer, structure, region) also may be present. A portion that is “directly on”, “directly adjacent”, “immediately adjacent”, “in direct contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.0

1. A battery pack, comprising:
a first battery comprising a first electrochemical cell and a first pair of terminals electronically coupled to the first electrochemical cell;
a second battery comprising a second electrochemical cell and a second pair of terminals electronically coupled to the second electrochemical cell; and
a housing at least partially enclosing the first battery and the second battery;
wherein the housing is configured to apply, during at least one period of time during charge and/or discharge of the first electrochemical cell and/or the second electrochemical cell, an anisotropic force with a component normal to a first electrode surface of the first electrochemical cell and/or a second electrode surface of the second electrochemical cell defining a pressure of at least 3 kg_{f}/cm².

2. A battery pack, comprising:
a stack comprising a first electrochemical cell and a second electrochemical cell; and
a housing at least partially enclosing the stack, the housing comprising a solid plate covering at least a portion of an end of the stack;
wherein:
the housing is configured to apply, via the solid plate and tension in a solid housing component coupled to the solid plate, during at least one period of time during charge and/or discharge of the first electrochemical cell and/or the second electrochemical cell, an anisotropic force with a component normal to a first electrode surface of the first electrochemical cell and/or a second electrode surface of the second electrochemical cell defining a pressure of at least 3 kg_{f}/cm², and
the solid housing component is coupled to the solid plate at least partially via coupling of an insert to a housing stop portion adjacent to an exterior surface of the solid plate, the insert comprising:
a body that passes through the solid housing component and enters a complementary recess of the housing stop portion adjacent to a first side of the solid housing component, and
a head adjacent to a second side of the solid housing component opposite the first side.

3. A battery pack, comprising:
a stack of electrochemical cells comprising a first electrochemical cell and a second electrochemical cell;
a first battery comprising a first battery module comprising:
a first subset of the electrochemical cells, the first subset including the first electrochemical cell, and
a first pair of terminals electronically coupled to the first electrochemical cell;
a second battery comprising a second battery module comprising:
a second, different, subset of the electrochemical cells, the second subset including the second electrochemical cell, and
a second pair of terminals electronically coupled to the second electrochemical cell;
a housing at least partially enclosing the stack, the housing comprising a solid plate comprising carbon fiber covering at least a portion of an end of the stack;
a substrate to which a tab of the first electrochemical cell and/or the second electrochemical cell can be connected; and
an electrically conductive interconnect on the substrate connected to at least one tab of the first electrochemical cell and/or the second electrochemical cell;
wherein:
the first battery and the second battery can be charged and/or discharged independently;
the first battery is configured to be part of a circuit having a first voltage, and the second battery is configured to be part of a circuit having a second, different voltage;
the housing is configured to apply, via the solid plate and tension in a solid housing component coupled to the solid plate, during at least one period of time during charge and/or discharge of the first electrochemical cell and/or the second electrochemical cell, an anisotropic force with a component normal to a first electrode surface of the first electrochemical cell and/or a second electrode surface of the second electrochemical cell defining a pressure of at least 3 kg_{f}/cm²;
the solid housing component comprises carbon fiber and is coupled to the solid plate at least partially via coupling of an insert to a housing stop portion adjacent to an exterior surface of the solid plate, the insert comprising:
a body that passes through the solid housing component and enters a complementary recess of the housing stop portion adjacent to a first side of the solid housing component, and
a head adjacent to a second side of the solid housing component opposite the first side; and
at least one electrochemical cell of the battery pack comprises lithium metal and/or a lithium alloy as an electrode active material during at least a portion of a charging and/or discharging process of the at least one electrochemical cell.

4. The battery pack of claim 1, wherein, the first electrode surface of the first electrochemical cell is a first electrode active surface and/or the second electrode surface of the second electrochemical cell is a second electrode active surface.

5. The battery pack of claim 2, wherein the first electrochemical cell is part of a first battery comprising a first pair of terminals electronically coupled to the first electrochemical cell and the second electrochemical cell is part of a second battery comprising a second pair of terminals electronically coupled to the second electrochemical cell.

6. The battery pack of claim 1, wherein the battery pack comprises a stack of electrochemical cells at least partially enclosed by the housing, and wherein:
the first battery comprises a first battery module comprising a first subset of the electrochemical cells, the first subset including the first electrochemical cell, and
the second battery comprises a second battery module comprising a second, different subset of the electrochemical cells, the second subset including the second electrochemical cell.

7. The battery pack of claim 1, wherein the housing comprises a solid plate covering at least a portion of an end of the stack.

8. The battery pack of claim 7, wherein the housing is configured to apply, via the solid plate and tension in a solid housing component coupled to the solid plate, during at least one period of time during charge and/or discharge of the first electrochemical cell and/or the second electrochemical cell, an anisotropic force with a component normal to a first electrode surface of the first electrochemical cell and/or a second electrode surface of the second electrochemical cell defining a pressure of at least 3 kg_{f}/cm².

9. The battery pack of claim 8, wherein the solid housing component is coupled to the solid plate via coupling to a housing stop portion adjacent to an exterior surface of the solid plate.

10. The battery pack of claim 2, wherein the housing stop portion is also adjacent to a lateral edge surface of the solid plate and/or an interior surface of the solid plate.

11. The battery pack of claim 8, wherein the solid housing component is coupled to the solid plate at least partially via coupling of an insert to a housing stop portion adjacent to an exterior surface of the solid plate, the insert comprising:
a body that passes through the solid housing component and enters a complementary recess of the housing stop portion adjacent to a first side of the solid housing component, and
a head adjacent to a second side of the solid housing component opposite the first side.

12. The battery pack of claim 1, wherein the first battery and the second battery can be charged and/or discharged independently.

13. The battery pack of claim 1, wherein the first battery is configured to be part of a circuit having a first voltage, and the second battery is configured to be part of a circuit having a second, different voltage.

14. The battery pack of claim 3, wherein the first battery module comprises a different total number of electrochemical cells than does the second battery module.

15. The battery pack of claim 1, wherein the first electrochemical cell has a different capacity than the second electrochemical cell.

16. The battery pack of claim 2, wherein the insert is coupled to the housing stop portion via a fastener.

17. The battery pack of claim 16, wherein a ratio of the largest cross-sectional dimension of the body of the insert perpendicular to the through-axis of the body to the largest cross-sectional dimension of the fastener perpendicular to the through-axis of the fastener is greater than or equal to 1.5.

18. The battery pack of claim 2, wherein the solid plate comprises carbon fiber.

19. The battery pack of claim 2, wherein the solid housing component comprises carbon fiber.

20. The battery pack of claim 1, wherein the battery pack comprises a substrate to which a tab of the first electrochemical cell and/or the second electrochemical cell can be connected.

21. The battery pack of claim 20, further comprising an electronically conductive interconnect on the substrate connected to at least one tab of the first electrochemical cell and/or the second electrochemical cell.

22. The battery pack of claim 3, wherein the electronically conductive interconnect comprises a first material portion connected to a first tab of the first electrochemical cell and a second material portion connected to a second tab of the second electrochemical cell.

23. The battery pack of claim 3, wherein the first material portion and the second material portion are made of different metals and/or metal alloys.

24. The battery pack of claim 3, wherein the first material portion and the second material portion are made of a same metal and/or metal alloy.

25. The battery pack of claim 1, wherein at least one electrochemical cell of the battery pack comprises lithium metal and/or a lithium alloy as an electrode active material during at least a portion of a charging and/or discharging process of the at least one electrochemical cell.

26. The battery pack of claim 3, wherein the at least one electrochemical cell comprises lithium metal and/or a lithium alloy as an electrode active material during all of a charging and/or discharging process of the at least one electrochemical cell.

27. An electric vehicle, comprising the battery pack of claim 1.

28. A method, comprising independently charging and/or discharging the first battery and the second battery of the battery pack of claim 1.

29. The method of claim 28, wherein the first battery is charged at a different rate than is the second battery.

30. The method of claim 28, wherein the first battery is charged at a same rate as the second battery.

31. The method of claim 28, wherein the first battery is discharged at a different rate than is the second battery.

32. The method of claim 28, the first battery is discharged at a same rate as the second battery.
